(19) United States
(12) Patent Application Publication
(10) Pub. No.: US 2014/0168130 A1
(43) Pub. Date: Jun. 19, 2014

(54) USER INTERFACE DEVICE AND INFORMATION PROCESSING METHOD

(71) Applicant: Masato Hirai, Tokyo (JP)

(72) Inventor: Masato Hirai, Tokyo (JP)

(73) Assignee: MITSUBISHI ELECTRIC CORPORATION, Tokyo (JP)

(21) Appl. No.: 14/235,015

(22) PCT Filed: Jul. 26, 2012
(86) PCT No.: PCT/JP2012/068982

§ 371 Date: Jan. 24, 2014

(30) Foreign Application Priority Data
Jul. 27, 2011 (JP) PCT/JP2011/004242

(51) Int. Cl. G06F 3/041; G10L 21/16; G06F 3/02

(52) U.S. Cl. CPC G06F 3/0416; G06F 3/041; G06F 3/02; G10L 21/16
USPC 345/173

(57) ABSTRACT

An input method determining unit determines whether a hard button is short or long pressed, and an input switching control unit switches between modes. The input switching control unit determines that an operation mode is a touch operation one when the hard button is short pressed, and a touch-to-command converting unit converts an item corresponding to the short-pressed hard button into a command. The input switching control unit determines that the operation mode is a voice operation one when the hard button is long pressed, and a voice-to-command converting unit converts a voice recognition keyword which is voice-recognized into a command (item value). A state transition control unit generates an application execution command corresponding to the command, and an application executing unit executes an application.

### FIELD OF THE INVENTION

The present invention relates to a user interface device, a vehicle-mounted information device, an information processing method of, and an information processing program that perform a process according to a touch display operation or a voice operation done by the user.

### BACKGROUND OF THE INVENTION

In vehicle-mounted information devices, such as a navigation device, an audio device, and a hands-free phone, an operation method using a touch display, a joystick, a rotating dial, a sound, etc. is used.

When performing a touch display operation in a vehicle-mounted information device, the user touches a button displayed on a display screen integral with a touch panel to cause the vehicle-mounted information device to repeatedly make a screen transition to perform a desired function. Because this method enables the user to directly touch a button displayed on a display, he or she can perform the operation intuitively. When performing an operation by using other devices, such as a joystick, a rotating dial, and a remote controller, the user operates these devices to put a cursor on a button displayed on the display screen, and then selects or determines the button to cause the vehicle-mounted information device to repeatedly make a screen transition to perform a desired function. This method requires the user to put the cursor on a target button, and therefore it cannot be said that such an operation by using other devices is an intuitive operation as compared with a touch display operation. Further, although these operation methods are easy to understand because the user is enabled to perform an operation by simply selecting buttons displayed on the screen, many operation steps are needed and it takes much time for the user to perform the operation.

On the other hand, when performing a voice operation, the user utters a word called a voice recognition keyword once or multiple times to cause the vehicle-mounted information device to perform a desired function. Because the user is enabled to operate any item which is not displayed on the screen, the operation steps and the operation time can be reduced while it is difficult for the user to use this operation because the user cannot operate any item unless the user properly utters a predetermined voice recognition keyword correctly according to a predetermined specific voice operation method after memorizing the voice operation method and the voice recognition keyword. Further, while the user starts a voice operation by typically using a method of pressing either a single utterance button (hard button) disposed in the vicinity of a steering wheel or a single utterance button disposed on the screen, the user has to perform interaction with the vehicle-mounted information device multiple times in many cases until causing the vehicle-mounted information device to perform a desired function, and a large number of operation steps are needed and it takes much time for the user to perform the operation in such a case.

In addition, an operation method using a combination of a touch display operation and a voice operation has been also proposed. For example, in a voice recognition device in accordance with patent reference 1, when the user presses a button associated with each data input field currently being displayed on a touch display and then utters a word, the result of voice recognition is inputted to the data input field and is displayed on a screen. Further, for example, in a navigation device in accordance with patent reference 2, when searching for a place name or a road name through voice recognition, the user is allowed to input the first character or the character string of the place name or the road name by using a keyboard displayed on a touch display and decide the place name or the road name, and utter this name after that.

### RELATED ART DOCUMENT

### Patent Reference

Patent reference 1: Japanese Unexamined Patent Application Publication No. 2001-42890
Patent reference 2: Japanese Unexamined Patent Application Publication No. 2010-38751

### SUMMARY OF THE INVENTION

### Problems to be Solved by the Invention

A problem is that a touch display operation requires a large number of layered screens which the user has to operate, and therefore the number of operation steps and the operation time cannot be reduced, as mentioned above. On the other hand, a problem with a voice operation is that it is difficult for the user to perform this operation because the user needs to utter a predetermined voice recognition keyword correctly according to a predetermined specific operation method after memorizing the operation method and the voice recognition keyword. A further problem is that even when pressing an utterance button, the user “does not know what he or she should say” in many cases, and hence cannot perform any operation.

Further, the voice recognition device disclosed in above-mentioned patent reference 1 simply relates to a technology of inputting data to a data input field through voice recognition, and does not make it possible to carry out an operation and a function followed by screen transitions. A further problem is that because neither a method of listing predetermined items each of which can be inputted to each data input field nor a method of selecting a target item from a list is provided, the user cannot perform any operation unless memorizing voice recognition keywords for items which can be inputted.

Further, above-mentioned patent reference 2 relates to a technology of allowing the user to input a first character or a character string and then utter the first character or the character string before carrying out voice recognition, thereby improving the reliability of voice recognition, and this technology requires an input of characters and a deciding operation. Therefore, a problem is that as compared with a conventional voice operation of searching for an uttered place name or road name, the number of operation steps and the operation time cannot be reduced.

The present invention is made in order to solve the above-mentioned problems, and it is therefore an object of the present invention to provide a technology of implementing an intuitive and intelligible voice operation which eliminates the necessity to memorize a specific voice operation method and voice recognition keywords while ensuring the intelligibility of a touch display operation, thereby reducing the number of operation steps and the operation time.

### Means for Solving the Problem

In accordance with the present invention, there is provided a user interface device including: a touch-to-command converter for generating a first command for performing a process corresponding to a button which is displayed on a touch display and on which a touch operation is performed according to an output signal of the touch display; a voice-to-command converter for carrying out voice recognition on a user's utterance which is made at substantially same time when or after the touch operation is performed by using a voice recognition dictionary comprised of voice recognition keywords each brought into correspondence with a process to convert the user's utterance into a second command for performing a process corresponding to the result of the voice recognition, and included in a process group associated with the process corresponding to the first command and categorized into a layer lower than that of the process corresponding to the first command; and an input switching controller for switching between a touch operation mode of performing the process corresponding to the first command generated by the touch-to-command converter and a voice operation mode of performing the process corresponding to the second command generated by the voice-to-command converter according to the state of the touch operation which is based on the output signal of the touch display.

In accordance with the present invention, there is provided a vehicle-mounted information device including: a touch display and a microphone which are mounted in a vehicle; a touch-to-command converter for generating a first command for performing a process corresponding to a button which is displayed on the touch display and on which a touch operation is performed according to an output signal of the touch display; a voice-to-command converter for carrying out voice recognition on a user's utterance which is collected by the microphone and which is made at substantially same time when or after the touch operation is performed by using a voice recognition dictionary comprised of voice recognition keywords each brought into correspondence with a process to convert the user's utterance into a second command for performing a process corresponding to the result of the voice recognition, and included in a process group associated with the process corresponding to the first command and categorized into a layer lower than that of the process corresponding to the first command; and an input switching controller for switching between a touch operation mode of performing the process corresponding to the first command generated by the touch-to-command converter and a voice operation mode of performing the process corresponding to the second command generated by the voice-to-command converter according to the state of the touch operation which is based on the output signal of the touch display.

In accordance with the present invention, there is provided an information processing method including: a touch input detecting step of detecting a touch operation on a button displayed on a touch display on the basis of an output signal of the touch display; an input method determining step of determining either a touch operation mode or a voice operation mode according to the state of the touch operation which is based on the result of the detection in the touch input detecting step; a touch command converting step of, when the touch operation mode is determined in the input method determining step, generating a first command for performing a process corresponding to the button on which the touch operation is performed on the basis of the result of the detection in the touch input detecting step; a voice-to-command converting step of, when the voice operation mode is determined in the input method determining step, carrying out voice recognition on a user's utterance which is made at substantially same time when or after the touch operation is performed by using a voice recognition dictionary comprised of voice recognition keywords each brought into correspondence with a process to convert the user's utterance into a second command for performing a process corresponding to the result of the voice recognition, and included in a process group associated with the process corresponding to the first command and categorized into a layer lower than that of the process corresponding to the first command; and a process performing step of performing the process corresponding to either the first command generated in the touch-to-command converting step or the second command generated in the voice-to-command converting step.

In accordance with the present invention, there is provided an information processing program for causing a computer to perform: a touch input detecting process of detecting a touch operation on a button displayed on a touch display on the basis of an output signal of the touch display; an input method determining process of determining either a touch operation mode or a voice operation mode according to the state of the touch operation which is based on the result of the detection in the touch input detecting process; a touch command converting process of, when the touch operation mode is determined in the input method determining process, generating a first command for performing a process corresponding to the button on which the touch operation is performed on the basis of the result of the detection in the touch input detecting process; a voice-to-command converting process of, when the voice operation mode is determined in the input method determining process, carrying out voice recognition on a user's utterance which is made at substantially same time when or after the touch operation is performed by using a voice recognition dictionary comprised of voice recognition keywords each brought into correspondence with a process to convert the user's utterance into a second command for performing a process corresponding to the result of the voice recognition, and included in a process group associated with the process corresponding to the first command and categorized into a layer lower than that of the process corresponding to the first command; and a process performing process of performing the process corresponding to either the first command generated in the touch-to-command converting process or the second command generated in the voice-to-command converting process.

In accordance with the present invention, there is provided a user interface device including: a touch-to-command converter that generates a first command for performing either a process associated with an input device on which a user performs a touch operation or a process currently being selected by the input device on the basis of an output signal of the input device; a voice-to-command converter that carries out voice recognition on a user's utterance which is made at substantially same time when or after the touch operation is performed on the input device by using a voice recognition dictionary comprised of a voice recognition keyword brought into correspondence with the process to convert the user's utterance into a second command for performing a process corresponding to the result of the voice recognition, and included in a process group associated with the process corresponding to the first command and categorized into a layer lower than that of the process corresponding to the first command; and an input switching controller for switching between a touch operation mode of performing the process corresponding to the first command generated by the touch-to-command converter and a voice operation mode of performing the process corresponding to the second command generated by the voice-to-command converter according to the state of the touch operation which is based on the output signal of the input device.

### Advantages of the Invention

Because according to the present invention, it is determined whether the operation mode is the touch operation one or the voice operation one according to the state of a touch operation on a button displayed on the touch display, an input can be performed while switching, with one button, between a general touch operation and a voice operation associated with the button is performed, and the intelligibility of the touch operation can be ensured. Further, because the second command is the one for performing a process included in a process group associated with the process corresponding to the first command and categorized into a layer lower than that of the process corresponding to the first command, and the user is enabled to, by uttering while performing a touch operation on one button, cause the device to perform the process associated with this button and existing in a lower layer, an intuitive and intelligible voice operation which eliminates the necessity to memorize a specific voice operation method and voice recognition keywords can be implemented, and the number of operation steps and the operation time can be reduced.

Further, according to the present invention, whether the operation mode is the touch operation one or the voice operation one can be determined according to the state of a touch operation on an input device, such as a hard button, instead of a button displayed on the touch display, so that an input can be performed while switching, with one input device, between a general touch operation and a voice operation associated with the input device is performed.

### BRIEF DESCRIPTION OF THE FIGURES

FIG. 1 is a block diagram showing the structure of a vehicle-mounted information device according to Embodiment 1 of the present invention;

FIG. 2 is a flow chart showing the operation of the vehicle-mounted information device in accordance with Embodiment 1;

FIG. 3 is a diagram explaining an example of screen transitions in a vehicle-mounted information device in accordance with Embodiment 1, and shows an example of screens associated with an AV function;

FIG. 4 is a flow chart showing an input method determining process of the vehicle-mounted information device in accordance with Embodiment 1;

FIG. 5 is a diagram explaining a relationship between touch operations and input methods in the vehicle-mounted information device in accordance with Embodiment 1;

FIG. 6 is a flow chart showing an application execution command generating process according to a touch operated input in the vehicle-mounted information device in accordance with Embodiment 1;

FIG. 7A is a diagram explaining an example of a state transition table which the vehicle-mounted information device in accordance with Embodiment 1 has;

FIG. 7B is a diagram showing a continued part of the state transition table which the vehicle-mounted information device in accordance with Embodiment 1 has;

FIG. 7C is a diagram showing a continued part of the state transition table which the vehicle-mounted information device in accordance with Embodiment 1 has;

FIG. 7D is a diagram showing a continued part of the state transition table which the vehicle-mounted information device in accordance with Embodiment 1 has;

FIG. 7E is a diagram showing a continued part of the state transition table which the vehicle-mounted information device in accordance with Embodiment 1 has;

FIG. 8 is a diagram explaining an example of screen transitions in the vehicle-mounted information device in accordance with Embodiment 1, and shows an example of screens regarding a phone function;

FIG. 9 is a flow chart showing an application execution command generating process according to a voice operated input in the vehicle-mounted information device in accordance with Embodiment 1;

FIG. 10 is a diagram explaining voice recognition dictionaries of the vehicle-mounted information device in accordance with Embodiment 1;

FIG. 11A is a diagram explaining an example of screen transitions in the vehicle-mounted information device in accordance with Embodiment 1, and shows an example of screens regarding a navi function;

FIG. 11B is a diagram explaining an example of screen transitions in the vehicle-mounted information device in accordance with Embodiment 1, and shows an example of screens regarding the navi function;

FIG. 12 is a block diagram showing the structure of a vehicle-mounted information device according to Embodiment 2 of the present invention;

FIG. 13 is a flow chart showing the operation of the vehicle-mounted information device in accordance with Embodiment 2;

FIG. 14 is a diagram explaining an example of screen transitions in the vehicle-mounted information device in accordance with Embodiment 2, and shows an example of screens regarding a phone function;

FIG. 15 is a diagram explaining an example of a state transition table which the vehicle-mounted information device in accordance with Embodiment 2 has;

FIG. 16 is a flow chart showing an application execution command generating process according to a voice operated input in the vehicle-mounted information device in accordance with Embodiment 2;

FIG. 17 is a diagram explaining a voice recognition target word dictionary of the vehicle-mounted information device in accordance with Embodiment 1;

FIG. 18 is a diagram explaining an example of screen transitions in the vehicle-mounted information device in accordance with Embodiment 2, and shows an example of screens regarding a navi function;

FIG. 19 is a diagram explaining an example of screen transitions in the vehicle-mounted information device in accordance with Embodiment 2, and shows an example of screens regarding the navi function;

FIG. 20 is a block diagram showing the structure of a vehicle-mounted information device according to Embodiment 3 of the present invention;

FIG. 21 is a flow chart showing an output method determination process carried out by the vehicle-mounted information device in accordance with Embodiment 3;

FIG. 22 is a diagram showing a phone screen at the time of a voice operated input of the vehicle-mounted information device in accordance with Embodiment 3;

FIG. 23 is a diagram showing a list screen at the time of a voice operated input of the vehicle-mounted information device in accordance with Embodiment 3;

FIG. 24 is a diagram showing an example of the structure of hard buttons and a touch display which a vehicle-mounted information device in accordance with Embodiment 4 of the present invention includes;

FIG. 25 is a diagram explaining an example of screen transitions in the vehicle-mounted information device in accordance with Embodiment 4, and shows an example of a screen at the time of a touch operation mode;

FIG. 26 is a diagram explaining an example of screen transitions in the vehicle-mounted information device in accordance with Embodiment 4, and shows an example of a screen at the time of a touch operation mode;

FIG. 27 is a diagram showing an example of the structure of hard buttons and a touch display which a vehicle-mounted information device in accordance with Embodiment 5 of the present invention includes;

FIG. 28 is a diagram explaining an example of screen transitions in the vehicle-mounted information device in accordance with Embodiment 5, and shows an example of a screen at the time of a voice operation mode;

FIG. 29 is a diagram showing an example of the structure of hard buttons and a touch display which a vehicle-mounted information device in accordance with Embodiment 6 of the present invention includes;

FIG. 30 is a diagram explaining an example of screen transitions in the vehicle-mounted information device in accordance with Embodiment 6, and shows an example of a screen at the time of a touch operation mode;

FIG. 31 is a diagram explaining an example of screen transitions in the vehicle-mounted information device in accordance with Embodiment 6, and shows an example of a screen at the time of a voice operation mode;

FIG. 32 is a diagram showing an example of the structure of a display and a joystick which a vehicle-mounted information device in accordance with Embodiment 7 of the present invention includes;

FIG. 33 is a diagram showing an example of the structure of a display and a touchpad which a vehicle-mounted information device in accordance with Embodiment 8 of the present invention includes;

FIG. 34 is a diagram showing an example of the structure of a TV with a recording function to which a user interface device in accordance with Embodiment 9 of the present invention is applied, and the structure of a remote control;

FIG. 35 is a diagram showing an example of the structure of a rice cooker to which the user interface device in accordance with Embodiment 9 is applied;

FIG. 36 is a diagram showing an example of the structure of a microwave oven to which it applies the user interface device in accordance with Embodiment 9 is applied;

FIG. 37 is a diagram explaining a relationship between a touch operation and an input method of a vehicle-mounted information device in accordance with Embodiment 10 of the present invention;

FIG. 38A is a diagram showing an example of the structure of hard buttons and a touch display which the vehicle-mounted information device in accordance with Embodiment 10 of the present invention includes; and

FIG. 38B is a diagram explaining an example of screen transitions in the vehicle-mounted information device in accordance with Embodiment 10.

### EMBODIMENTS OF THE INVENTION

Hereafter, in order to explain this invention in greater detail, the preferred embodiments of the present invention will be described with reference to the accompanying drawings. Embodiment 1.

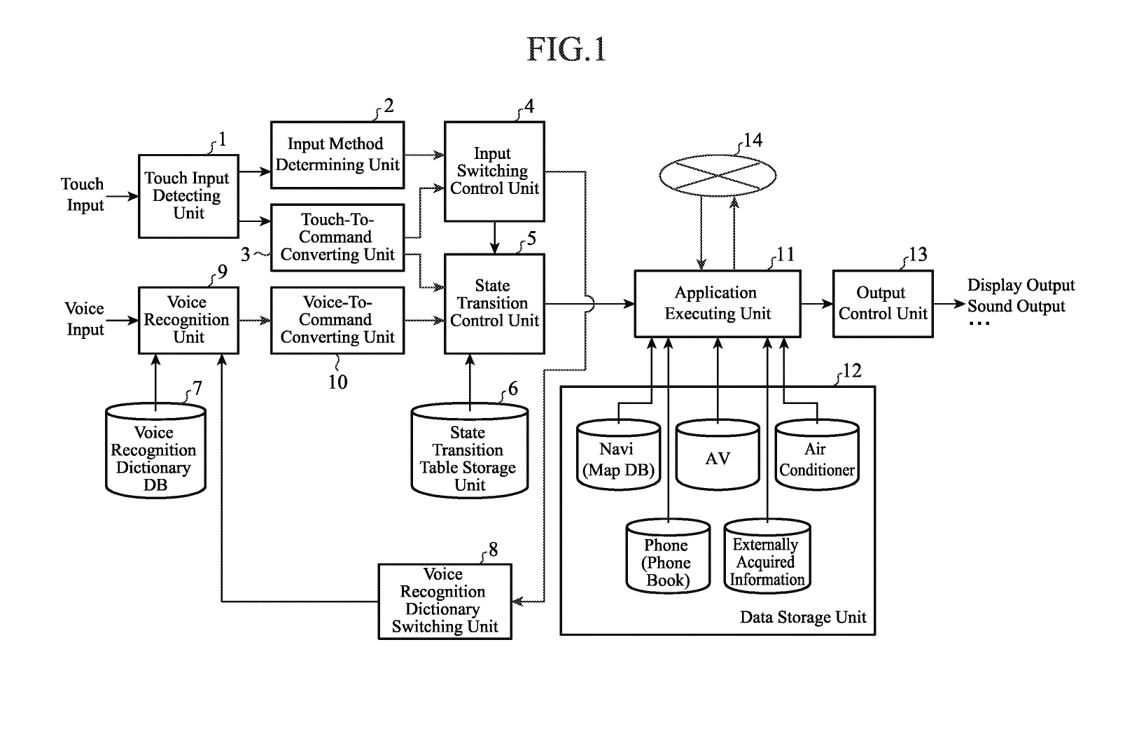

As shown in FIG. 1, a vehicle-mounted information device is comprised of a touch input detecting unit 1, an input method determining unit 2, a touch-to-command converting unit 3, an input switching control unit 4, a state transition control unit 5, a state transition table storage unit 6, a voice recognition dictionary DB 7, a voice recognition dictionary switching unit 8, a voice recognition unit 9, a voice-to-command converting unit 10, an application executing unit 11, a data storage unit 12, and an output control unit 13. This vehicle-mounted information device provides a user interface connected to I/O devices (not shown), such as a touch display in which a touch panel and a display are disposed integrally, a microphone, and a speaker, for inputting and outputting information, and for producing a desired screen display and performing a function according to a user's operation.

The touch input detecting unit 1 detects whether a user has touched a button (or a specific touch area) displayed on this touch display on the basis of an input signal from the touch display. The input method determining unit 2 determines whether the user is trying to perform an input by performing either a touch operation (touch operation mode) or a voice operation (voice operation mode) on the basis of the result of the detection by the touch input detecting unit 1. The touch-to-command converting unit 3 converts the button which the user has touched and which is detected by the touch input detecting unit 1 into a command. Although the details of this conversion will be mentioned below, an item name and an item value are included in this command, and the touch-to-command converting unit sends the command (the item name, the item value) to the state transition control unit 5 while sending the item name to the input switching control unit 4. This item name constructs a first command. The input switching control unit 4 notifies whether the user desires either the touch operation mode or the voice operation mode to the state transition control unit 5 according to the result (touch operation or voice operation) of the determination of an input method by the input method determining unit 2, and switches the process of the state transition control unit 5 to either the touch operation mode or the voice operation mode. In addition, the input switching control unit 4 sends the item name inputted thereto from the touch-to-command converting unit 3 (i.e., information indicating the button which the user has touched) to the state transition control unit 5 and the voice recognition dictionary switching unit 8 in the case of the voice operation mode.

When the state transition control unit 5 is notified by the input switching control unit 4 that the user desires the touch operation mode, the state transition control unit converts the command (the item name, the item value) inputted thereto from the touch-to-command converting unit 3 into an application execution command on the basis of a state transition table stored in the state transition table storage unit 6, and sends the application execution command to the application executing unit 11. Although the details of this conversion will be mentioned below, both or either of information specifying a transition destination screen and information specifying an application execution function is included in this application execution command. In contrast, when the state transition control unit 5 is notified by the input switching control unit 4 that the user desires the voice operation mode and of the command (the item name), the state transition control unit stands by until the command (the item value) is inputted thereto from the sound-command transforming unit 10, and, when the command (the item value) is inputted thereto, converts the command which is the combination of these item name and item value into an application execution command on the basis of the state transition table stored in the state transition table storage unit 6, and sends the application execution command to the application executing unit 11.

The state transition table storage unit 6 stores the information transition table in which a correspondence between each command (an item name, an item value) and an application execution command (a transition destination screen, an application execution function) is defined. The details of this information transition table will be mentioned below.

The voice recognition dictionary DB 7 is a database of voice recognition dictionaries used for a voice recognition process at the time of the voice operation mode, and voice recognition keywords are stored in the voice recognition dictionary DB. A corresponding command (an item name) is linked to each voice recognition keyword. The voice recognition dictionary switching unit 8 notifies the command (the item name) inputted thereto from the input switching control unit 4 to the voice recognition unit 9 to cause this voice recognition unit to switch to a voice recognition dictionary including the voice recognition keywords linked to this item name. The voice recognition unit 9 refers to the voice recognition dictionary comprised of the voice recognition keyword group to which the command (the item name) notified from the voice recognition dictionary switching unit 8 is linked, among the voice recognition dictionaries stored in the voice recognition dictionary DB 7, and carries out a voice recognition process on the sound signal from the microphone to convert the sound signal into a character string or the like and outputs this character string or the like to the voice-to-command converting unit 10. The voice-to-command converting unit 10 converts the voice recognition result of the voice recognition unit 9 into a command (an item value), and delivers this command to the state transition control unit 5. This item value constructs a second command.

The application executing unit 11 carries out either a screen transition or an application function according to the application execution command notified thereto from the state transition control unit 5 by using various data stored in the data storage unit 12. Further, the application executing unit 11 can connect with a network 14 to carry out communications with an outside of the vehicle-mounted information device. Although the details of the communications will be mentioned below, depending upon the type of the application function, the application executing unit can carry out communications with an outside of the vehicle-mounted information device and make a phone call, and can also store acquired data in the data storage unit 12 as needed. This application executing unit 11 and the state transition control unit 5 construct a process performer. The data storage unit 12 stores various data which are required when the application executing unit 11 carries out either a screen transition or an application function. The various data include data (including a map database) for a navigation (referred to as navi from here on) function, data (including music data and video data) for an audio visual (referred to as AV from here on) function, data for control of vehicle apparatus mounted in a vehicle, such as an air conditioner, data (including phone books) for a phone function, such as a handsfree phone call, and information (including congestion information and the URLs of specific websites) which the application executing unit 11 acquires from an outside of the vehicle-mounted information device via the network 14 and which is provided for the user at the time of execution of an application function. The output control unit 13 produces a screen display of the result of the execution by the application executing unit 11 on the touch display, or outputs a voice message indicating the result from the speaker.

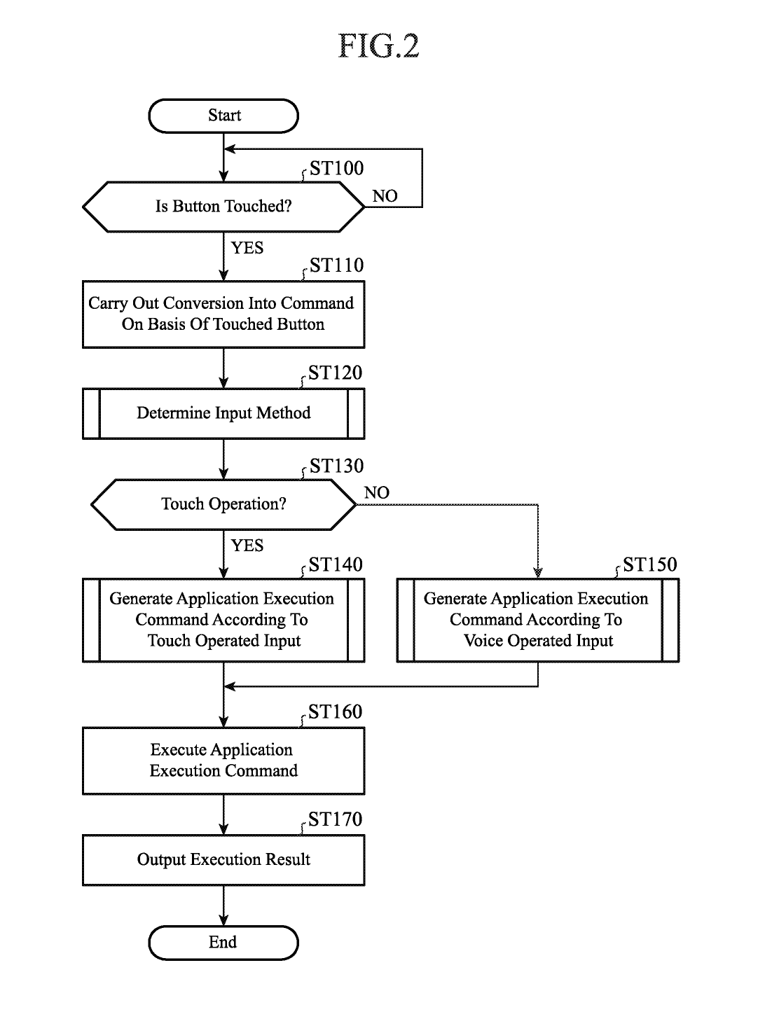

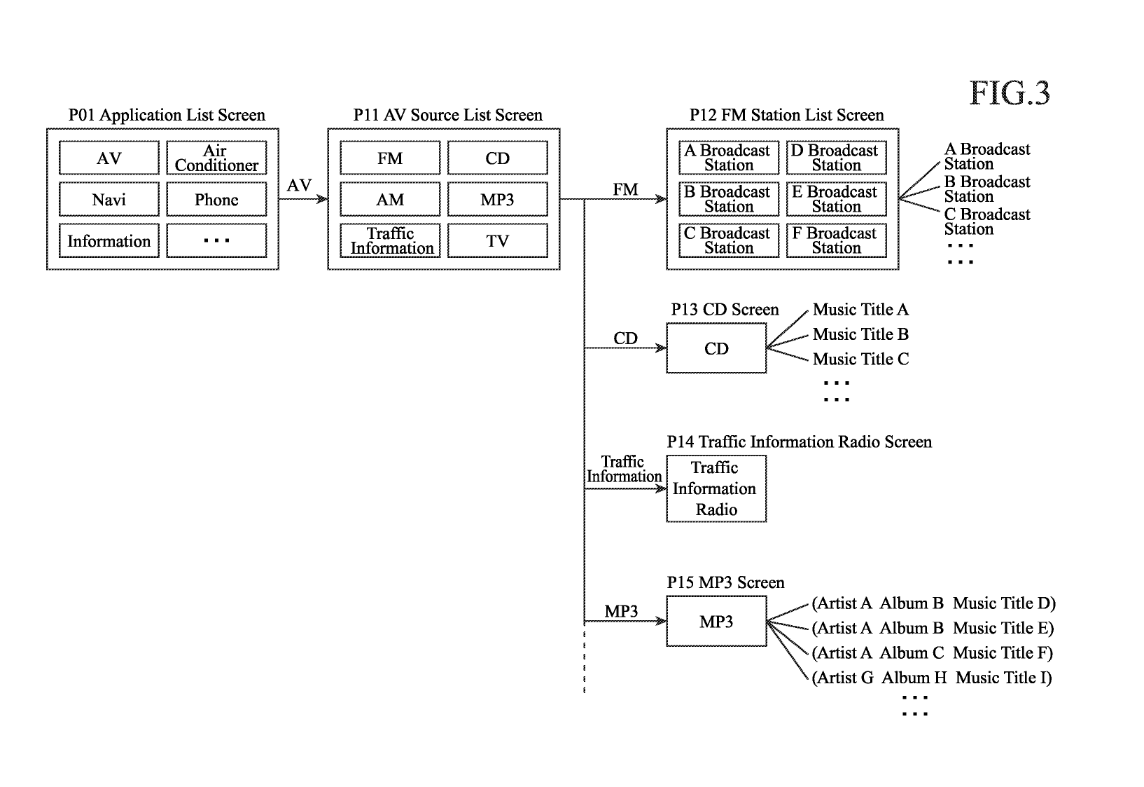

Next, the operation of the vehicle-mounted information device will be explained. FIG. 2 is a flow chart showing the operation of the vehicle-mounted information device in accordance with Embodiment 1. FIG. 3 shows an example of screen transitions which are made by the vehicle-mounted information device. In this example, it is assumed that the vehicle-mounted information device displays a list of functions executable by the application executing unit 11 (an application list screen P01) on the touch display as buttons in its initial state. This FIG. 3 shows an example of screen transitions for the AV function in which buttons are developed in the screen with an “AV” button in the application list screen P01 being set as a starting point. The application list screen P01 is the one in the highest layer (including the functions respectively associated with buttons). There is an AV source list screen P11 associated with the “AV” button (including functions respectively associated with buttons) in a layer one level lower than that of the application list screen P01. In addition, in a layer one level lower than that of the AV source list screen P11, there are an FM station list screen P12, a CD screen P13, a traffic information radio screen P14, and an MP3 screen P15, which are respectively associated with the buttons of the AV source list screen P11, and functions which are respectively associated with the buttons in the screens. Hereafter, a case in which a screen transition to a screen in a layer one level lower than before is simply referred to as a “transition.” For example, a case in which the screen is changed from the application list screen P01 to the AV source list screen P11 is a transition. On the other hand, a case in which a screen transition to a screen in a layer two or more levels lower than before or a screen for different functions is referred to as a “jump transition.” For example, a case in which the screen is changed from the application list screen P01 to the FM station list screen P12 or a case in which the screen is changed from the AV source list screen P11 to the screen for the navi function is referred to as a jump transition.

The touch input detecting unit 1, in step ST100, detects whether a user has touched a button displayed on the touch display. When detecting a touch (when “YES” in step ST100), the touch input detecting unit 1 further outputs a touch signal indicating which button has been touched and how the button has been touched (a pressing operation, an operation of touching the button for a fixed time period, or the like) on the basis of an output signal from the touch display.

The touch-to-command converting unit 3, in step ST110, converts the button which has been touched on the basis of the touch signal inputted thereto from the touch input detecting unit 1 into a command (an item name, an item value), and outputs the command. A button name is assigned to the button, and the touch-to-command converting unit 3 converts the button name into an item name and an item value of a command. For example, the command (the item name, the item value) associated with the “AV” button displayed on the touch display is (AV, AV).

The input method determining unit 2, in step ST120, determines the input method by determining whether the user is trying to perform either a touch operation or a voice operation on the basis of the touch signal inputted thereto from the touch input detecting unit 1, and outputs the input method.

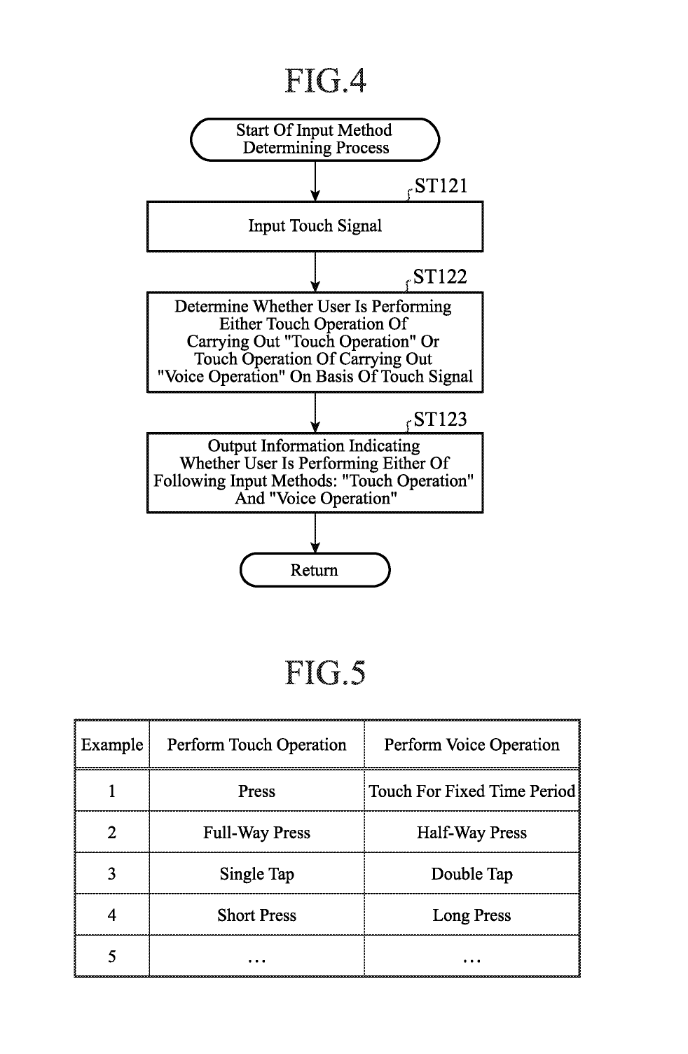

Hereafter, the process of determining the input method will be explained by using a flow chart shown in FIG. 4. The input method determining unit 2, in step ST121, receives an input of the touch signal from the touch input detecting unit 1 and, in next step ST122, determines the input method on the basis of the touch signal. It is assumed as shown in FIG. 5 that touching operations are predetermined for a touch operation and a voice operation respectively. In the case of example 1, when desiring to cause the vehicle-mounted information device to perform an application function in the touch operation mode, the user performs an operation of pressing the button for the application function on the touch display, whereas when desiring to cause the vehicle-mounted information device to perform an application function in the voice operation mode, the user performs an operation of touching the button for a fixed time period. Because the output signal of the touch display differs according to the user's touching operation, the input method determining unit 2 should just determine which touching operation has been performed according to the touch signal. As an alternative, by, for example, determining whether the button has been pressed full way or half way, like in the case of example 2, whether the button has been single or double tapped, like in the case of example 3, or whether the button has been short or long pressed, like in the case of example 4, the input method determining unit can determine whether the user desires either a touch operation or a voice operation as the input method. In a case in which the touch display is constructed in such a way as to be unable to physically make a distinction whether the button has been pressed full way or half way, the input method determining unit can carry out a process of assuming that the button has been pressed full way when the pressure for pressing the button is equal to or greater than a threshold; otherwise, assuming that the button has been pressed half way. By enabling the user to use two types of touching operations properly for each button in this way, the input method determining unit can determine whether the user is trying to perform an input by performing either a touch operation or a voice operation on each button.

The input method determining unit 2, in next step ST123, outputs the determination result showing the input method which is a touch operation or a voice operation to the input switching control unit 4.

Going back to the explanation of the flow chart of FIG. 2, when the state transition control unit 5, in step ST130, determines that the determination result inputted thereto from the input switching control unit 4 shows the touch operation mode (when “YES” in step ST130), the state transition control unit advances to step ST140 and generates an application execution command according to an input using a touch operation (touch operated input). In contrast, when the state transition control unit determines that the determination result inputted thereto from the input switching control unit 4 shows the voice operation mode (when “NO” in step ST130), the state transition control unit advances to step ST150 and generates an application execution command according to an input using a voice operation (voice operated input).

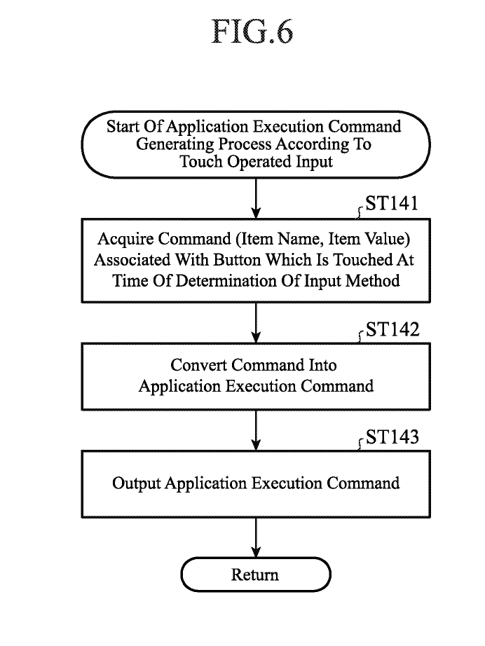

Hereafter, a method of generating an application execution command according to a touch operated input will be explained by using a flow chart shown in FIG. 6. The state transition control unit 5, in step ST141, acquires a command (an item name, an item value) associated with a button which has been touched at the time of the process of determining the input method from the touch-to-command converting unit 3, and, in next step ST142, converts the acquired command (the item name, the item value) into an application execution command on the basis of the state transition table stored in the state transition table storage unit 6.

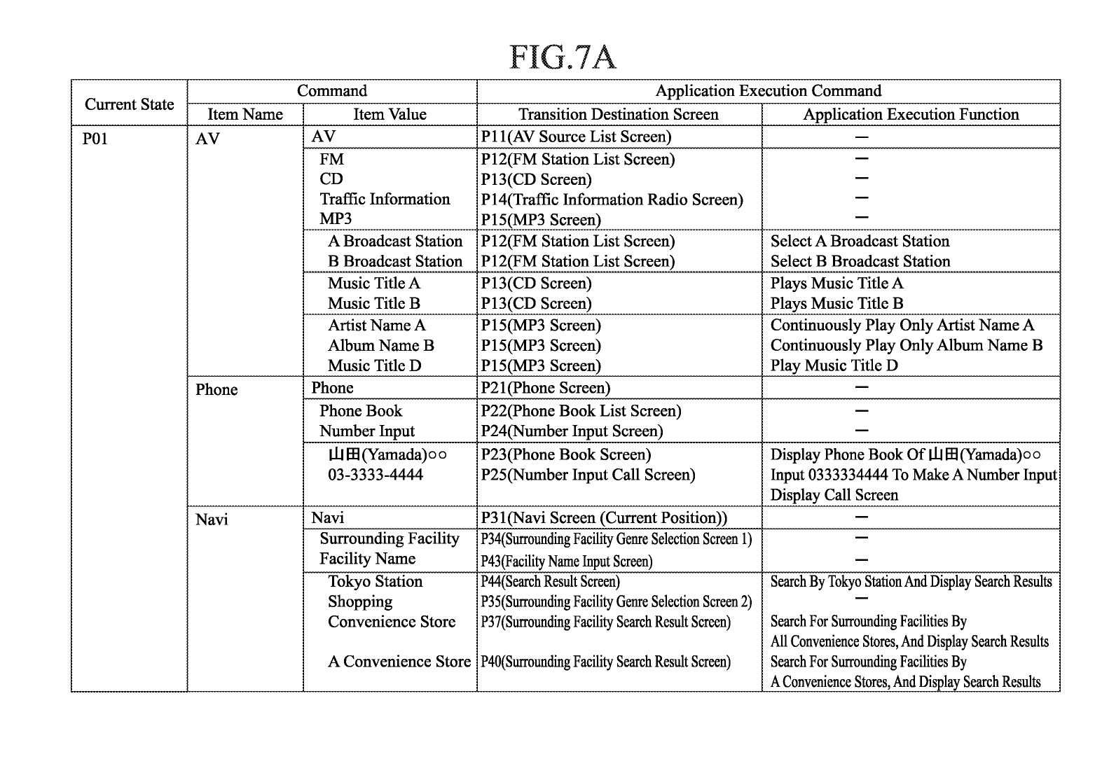

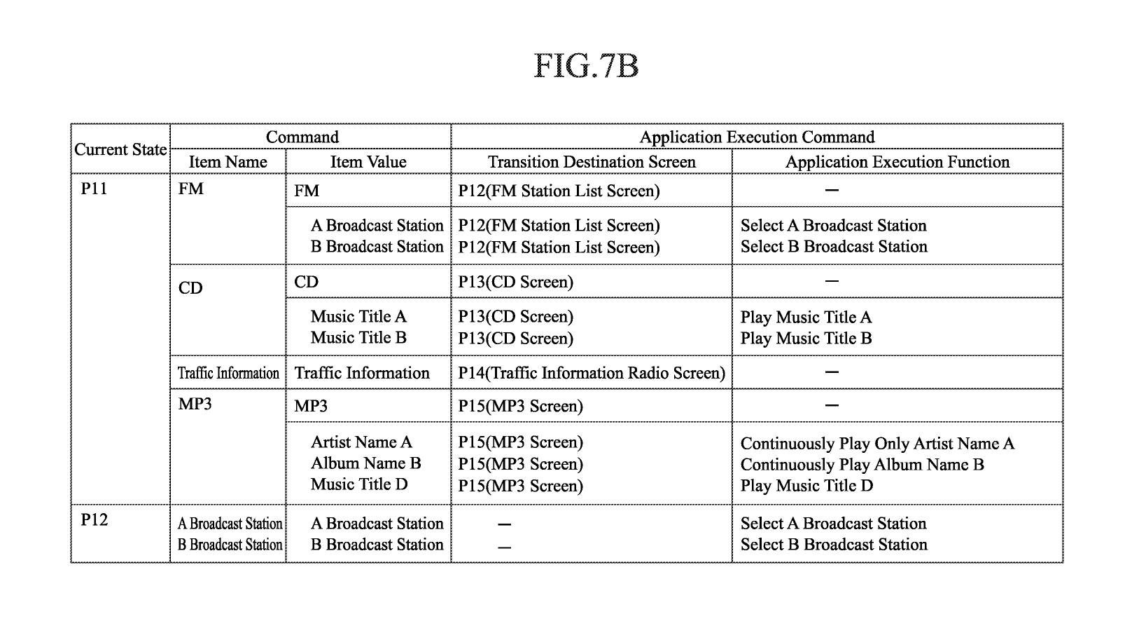

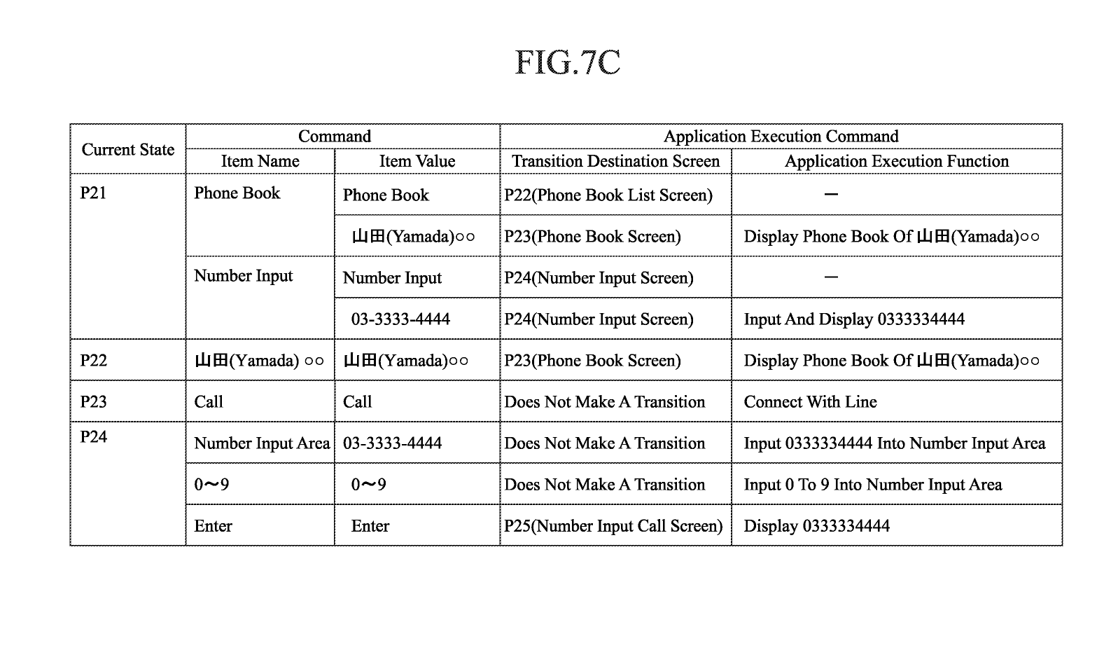

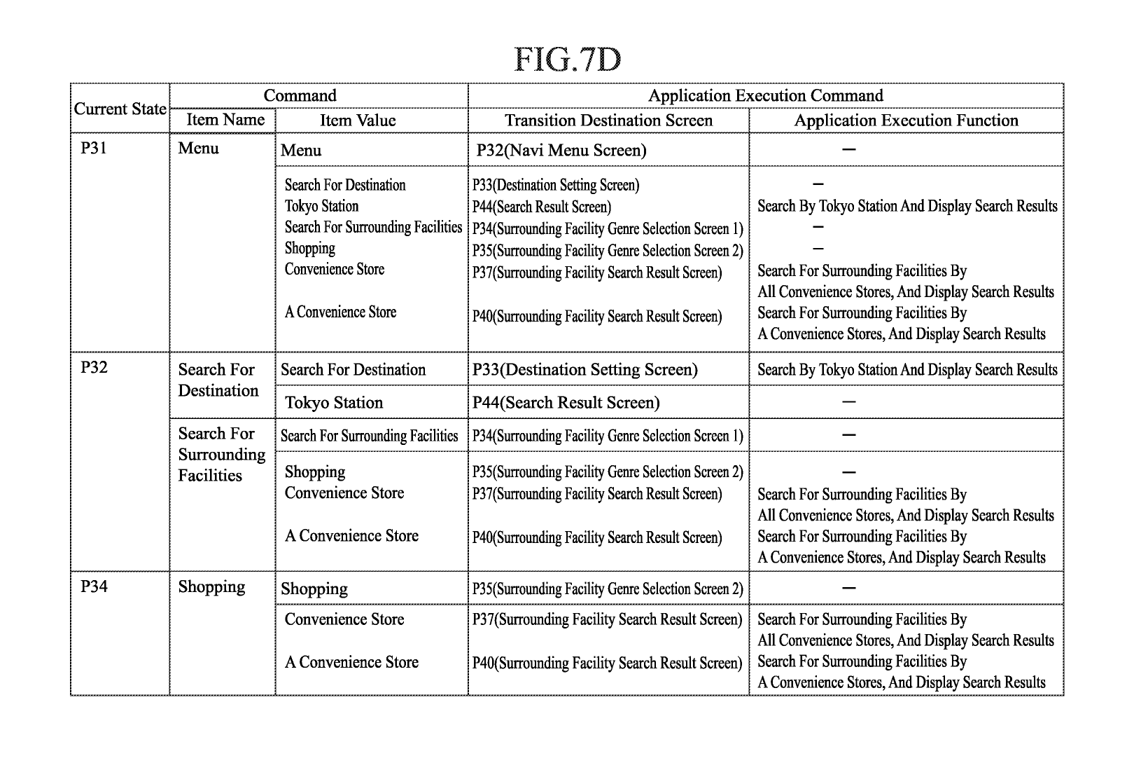

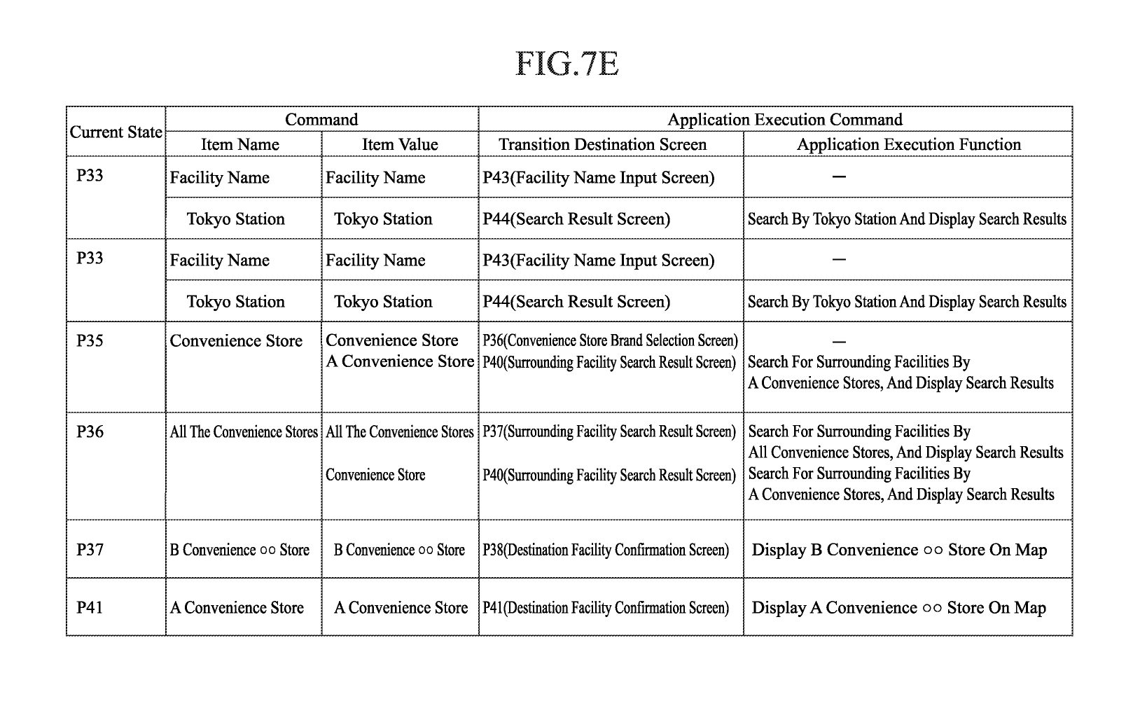

FIG. 7A is a diagram explaining an example of the state transition table, and shows commands and application execution commands which are set for each of the “AV”, “Phone”, and “NAVI” buttons included in the buttons in the application list screen P01 of FIG. 3. The state transition table is comprised of three types of information including “current state”, “command”, and “application execution command.” The current state is the screen currently being displayed on the touch display at the time of the detection of a touch in step ST100. As mentioned above, each command has an item name to which the same name as the corresponding button name currently being displayed on the screen is assigned. For example, the item name of the “AV” button in the application list screen P01 is “AV.”

Each command has an item value to which the same name as the button name is assigned or an item value to which a different name is assigned. As mentioned above, in the touch operation mode, the item value of each command is the same as the item name, i.e., the button name. In contrast, in the voice operation mode, the item value of each command is the voice recognition result and is a voice recognition keyword showing a function which the user desires to cause the vehicle-mounted information device to perform. When the user touches the “AV” button and utters the button name “AV,” the command is (AV, AV) in which the item value and the item name are the same as each other. When the user touches the button “AV” and utters a different voice recognition keyword “FM,” the command is (AV, FM) in which the item name and the item value differ from each other.

Each application execution command includes either or both of a “transition destination screen” and an “application execution function.” A transition destination screen is information indicating a destination screen which a screen is made to transition according to a corresponding command. An application execution function is information indicating a function which is performed according to a corresponding command.

In the case of the state transition table of FIG. 7A, the application list screen P01 is set as the top layer, AV is set as a layer just lower than the top layer, and FM, CD, traffic information, and MP3 are set as a layer lower than AV. Further, A broadcast station and B broadcast station are set as a layer lower than FM. Further, phone and navi in the same layer as AV are different application functions.

Hereafter, an example of converting a command into an application execution command when a touch operated input is performed will be explained. The current state is the application list screen P01 shown in FIG. 3. According to the state transition table of FIG. 7A, the command (AV, AV) is linked to the “AV” button shown in this screen, and a transition destination screen “P11 (AV source list screen)” and an application execution function “−(null)” are set as the corresponding application execution command. Therefore, the state transition control unit 5 converts the command (AV, AV) inputted thereto from the touch-to-command converting unit 3 into the application execution command for “making a screen transition to the AV source list screen P11.”

As an alternative, for example, it is assumed that the current state is the FM station list screen P12 shown in FIG. 3. In this case, according to the state transition table of FIG. 7B, a command (A broadcast station, A broadcast station) is linked to the “A Broadcast Station” button in this screen, and a transition destination screen “−” and an application execution function of “selecting A broadcast station” are set as the corresponding application execution command. Therefore, the state transition control unit 5 converts the command (A broadcast station, A broadcast station) inputted thereto from the touch-to-command converting unit 3 into the application execution command for “selecting A broadcast station.”

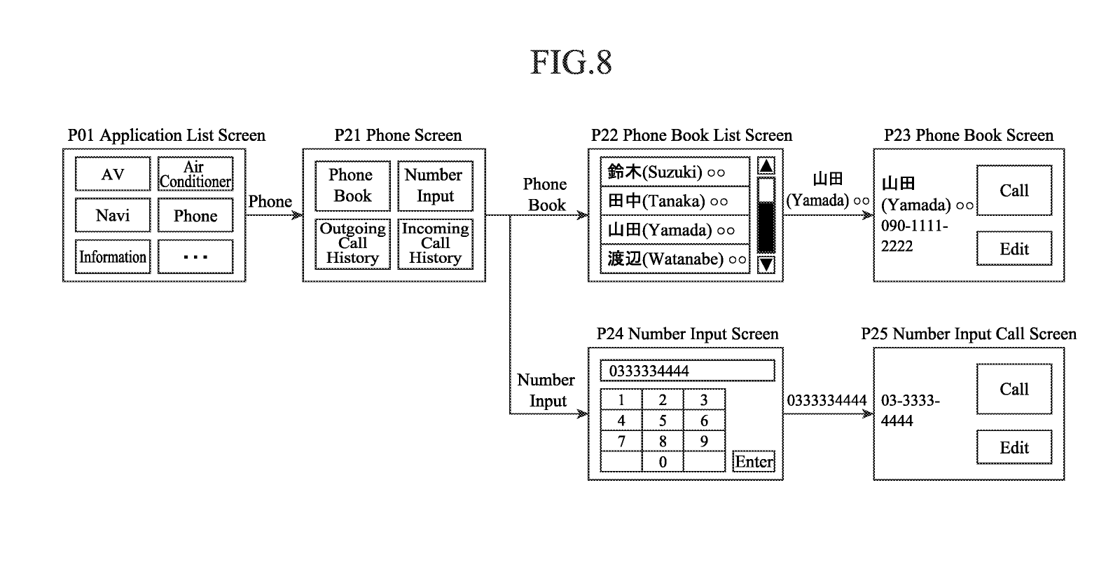

As an alternative, for example, it is assumed that the current state is a phone book list screen P22. This FIG. 8 is an example of screen transitions for phone function in which buttons are developed with the “Phone” button in the application list screen P01 being set as a starting point. In this case, according to the state transition table of FIG. 7C, the command ( [symbol] (Yamada)◯◯, [symbol] (Yamada)◯◯) is linked to a “ [symbol] (Yamada)◯◯” button of the phone book list in this screen, and a transition destination screen “P23 (phone book screen)” and an application execution function of “displaying the phone book of [symbol] (Yamada)◯◯” are set as the corresponding application execution command. Therefore, the state transition control unit 5 converts the command ( [symbol] (Yamada)◯◯, [symbol] (Yamada)◯◯) inputted thereto from the touch-to-command converting unit 3 into an application execution command for “making a screen transition to a phone book screen P23 and displaying the phone book of [symbol] [symbol] (Yamada)◯◯.”

The state transition control unit 5, in next step ST143, outputs the application execution command into which the command is converted to the application executing unit 11.

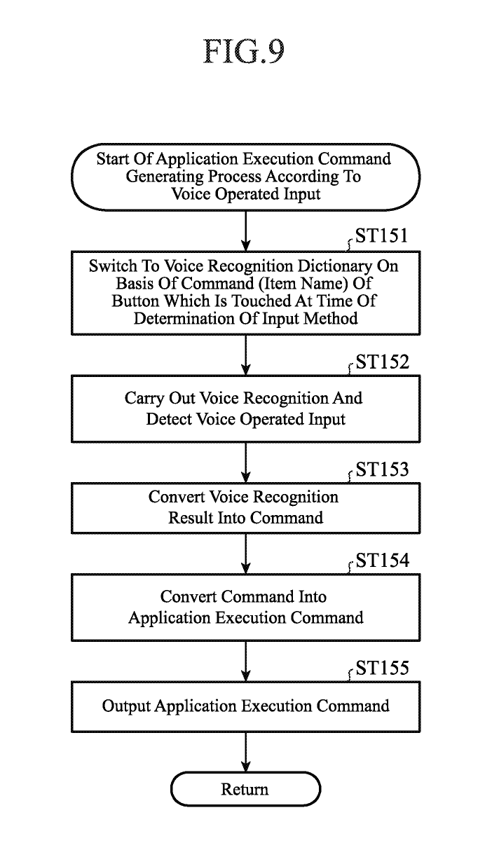

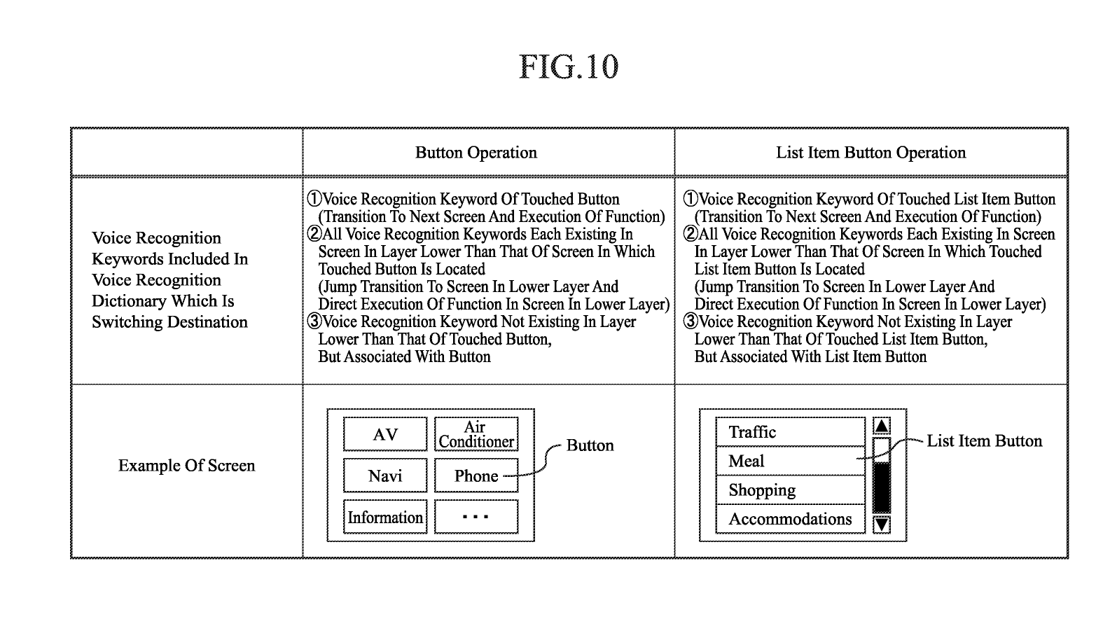

Next, a method of generating an application execution command according to a voice operated input will be explained by using a flow chart shown in FIG. 9. The voice recognition dictionary switching unit 8, in step ST151, outputs a command for switching to the voice recognition dictionary associated with the item name (i.e., the button which the user has touched) inputted thereto from the input switching control unit 4 to the voice recognition unit 9. FIG. 10 is a diagram explaining the voice recognition dictionary. For example, when the user operates a button in a state in which buttons are displayed on the touch display, the voice recognition dictionary to which a current voice recognition dictionary is to be switched includes (1) the voice recognition keyword of the touched button, (2) all voice recognition keywords each existing in a screen in a layer lower than that of the touched button, and (3) a voice recognition keyword not existing in any layer lower than that of the touched button, but being associated with this button.

(1) is the voice recognition keyword that includes the button name and so on of the touched button and that enables the vehicle-mounted information device to make a transition to the next screen and perform a function, like in the case in which the user presses a button according to a touch operated input.

(2) is the voice recognition keywords that enable the vehicle-mounted information device to make a jump transition to a screen existing in a layer lower than that of the touched button and perform a function in the screen to which a previous screen has been jumped.

(3) is the voice recognition keyword that enables the vehicle-mounted information device to make a jump transition to a screen not existing in any layer lower than that of the touched button, but having a function associated with the button, and perform a function in the screen to which a previous screen has been jumped.

For example, when the user operates a list item in a list screen in which list item buttons are displayed on the touch display, the voice recognition dictionary to which the current voice recognition dictionary is to be switched includes (1) the voice recognition keyword of the touched list item button, (2) all voice recognition keywords each existing in a screen in a layer lower than that of the touched list item button, and (3) a voice recognition keyword not existing in any layer lower than that of the touched list item button, but being associated with this button. In the case in which the user performs a button operation and in the case in which the user performs a list item button operation, (3) a voice recognition keyword is not indispensable in the voice recognition dictionary, and the voice recognition dictionary does not have to include (3) a voice recognition keyword if there is no voice recognition keyword associated with the button.

Hereafter, switching between voice recognition dictionaries will be explained concretely. The current state is the application list screen P01 shown in FIG. 3. The item name (AV) of the command (AV, AV) associated with the “AV” button which has been touched and detected in the process of determining the input method is inputted to the voice recognition dictionary switching unit 8. As a result, the voice recognition dictionary switching unit 8 issues a command for switching to the voice recognition dictionary associated with “AV” in the voice recognition dictionary DB 7. The voice recognition dictionary associated with “AV” includes the following voice recognition keywords:

(1) “AV” as the voice recognition keyword of the touched button,

(2) “FM”, “AM”, “traffic information”, “CD”, “MP3”, and “TV” as all voice recognition keywords each existing in a screen in a layer lower than that of the touched button,

“A broadcast station”, “B broadcast station”, “C broadcast station”, and so on as the voice recognition keywords in the screen (P12) existing in a layer lower than that of the “FM” button,

voice recognition keywords existing in each screen (P13, P14, P15, or . . . ) in a layer lower than that of each of the other buttons other than the “FM” button, and

(3) a voice recognition keyword existing in a screen in a layer lower than that of an “Information” button as an example of a voice recognition keyword not existing in any layer lower than that of the touched button, but being associated with this button.

By including a voice recognition keyword “program guide” associated with information in the voice recognition dictionary, the vehicle-mounted information device can display a program guide of radio programs which can be listened currently or TV programs which can be watched currently, for example.

As an alternative, for example, it is assumed that the current state is the AV source list screen P11 shown in FIG. 3. Then, the item name (FM) of a command (FM, FM) associated with the “FM” button which has been touched and detected in the process of determining the input method is inputted from the input switching control unit 4 to the voice recognition dictionary switching unit 8. As a result, the voice recognition dictionary switching unit 8 issues a command for switching to the voice recognition dictionary associated with “FM” in the voice recognition dictionary DB 7. The voice recognition dictionary associated with “FM” includes the following voice recognition keywords:

(1) “FM” as the voice recognition keyword of the touched button,

(2) “A broadcast station”, “B broadcast station”, “C broadcast station”, and so on as all voice recognition keywords each existing in a screen in a layer lower than that of the touched button, and

(3) a voice recognition keyword existing in a screen in a layer lower than that of the “Information” button as an example of a voice recognition keyword not existing in any layer lower than that of the touched button, but being associated with this button.

By including a voice recognition keyword “homepage” associated with information in the voice recognition dictionary, the vehicle-mounted information device can display the homepage of the broadcast station currently being selected to enable the user to watch the details of the program currently being broadcast, and the music name, the artist name, etc. of a musical piece currently being played in the program, for example.

In addition, as an example of (3), there is a voice recognition keyword included in a category of “convenience store” in a layer lower than that of a “shopping” list item button shown in, for example, FIG. 10. By also including a voice recognition keyword included in the “convenience store” category in an associated “meal” list item button, the vehicle-mounted information device can not only make a transition from “shopping” to “convenience store”, but also make a jump transition from “meal” to “convenience store.”

The voice recognition unit 9, in next step ST152, carries out a voice recognition process on the sound signal inputted thereto from the microphone by using the voice recognition dictionary, in the voice recognition dictionary DB 7, which the voice recognition dictionary switching unit 8 has specified, to detect a voice operated input, and outputs this input. For example, when the user touches the “AV” button in the application list screen P01 shown in FIG. 3 for a fixed time period (or when the user presses the button half way, double taps the button, or long presses the button, for example), the vehicle-mounted information device switches to a voice recognition dictionary mainly comprised of voice recognition keywords associated with “AV.” When further making a transition to a screen in a lower layer, for example, when the user touches the “FM” button of the AV source list screen P11 for a fixed time period, the vehicle-mounted information device switches to a voice recognition dictionary mainly comprised of voice recognition keywords associated with “FM.” More specifically, the voice recognition keywords of the voice recognition dictionary of AV are narrowed down. Therefore, it can be expected that the voice recognition rate is improved by switching to a narrowed-down voice recognition dictionary.

The voice-to-command converting unit 10, in next step ST153, converts the voice recognition result indicating the voice recognition keyword inputted from the voice recognition unit 9 into a corresponding command (item value), and outputs this command. The state transition control unit 5, in step ST154, converts the command which consists of the item name inputted from the input switching control unit 4 and the item value inputted from the voice-to-command converting unit 10 into an application execution command on the basis of the state transition table stored in the state transition table storage unit 6.

Hereafter, an example of converting a command into an application execution command in the case of a voice operated input will be explained. The current state is the application list screen P01 shown in FIG. 3. When the user then utters the voice recognition keyword “AV” while touching the “AV” button for a fixed time period, the command which the state transition control unit 5 acquires is (AV, AV). Therefore, the state transition control unit 5 converts the command (AV, AV) into an application execution command for “making a screen transition to the AV source list screen P11” on the basis of the state transition table of FIG. 7A, like in the case of a touch operated input.

As an alternative, for example, when the user utters the voice recognition keyword “A broadcast station” while touching the “AV” button in the application list screen P01 for a fixed time period, the command which the state transition control unit 5 acquires is (AV, A broadcast station). Therefore, the state transition control unit 5 converts the command (AV, A broadcast station) into an application execution command for “making a screen transition to the FM station list screen P12 and selecting A broadcast station” on the basis of the state transition table of FIG. 7A.

As an alternative, for example, when the user utters the voice recognition keyword “ [symbol] (Yamada)◯◯” while touching the “Phone” button in the application list screen P01 for a fixed time period, the command which the state transition control unit 5 acquires is (phone, [symbol] (Yamada)◯◯). Therefore, the state transition control unit 5 converts the command (phone, [symbol] (Yamada)◯◯) into an application execution command for “making a screen transition to the phone book screen P23 and displaying the phone book of [symbol] (Yamada)◯◯” on the basis of the state transition table of FIG. 7A.

The state transition control unit 5, in next step ST155, outputs the application execution command into which the command is converted to the application executing unit 11.

Going back to the explanation of the flow chart of FIG. 2, the application executing unit 11, in step ST160, acquires necessary data from the data storage unit 12 according to the application execution command inputted thereto from the state transition control unit 5, and carries out either or both of a screen transition and a function. The output control unit 13, in next step ST170, outputs the results of the screen transition and the function which are carried out by the application executing unit 11 by producing a display, a voice message, etc.

Hereafter, an example of the execution of an application by the application executing unit 11 and the output control unit 13 will be explained. When the user desires to select the A FM broadcast station and then uses a touch operated input for the selection, he or she presses the “AV” button of the application list screen P01 shown in FIG. 3 to cause the vehicle-mounted information device to make a transition to the AV source list screen P11. The user then presses the “FM” button of the AV source list screen P11 to cause the vehicle-mounted information device to make a transition to the FM station list screen P12. Next, the user presses the “A Broadcast Station” button of the FM station list screen P12 to select the A broadcast station.

At this time, the vehicle-mounted information device detects the press of the “AV” button in the application list screen P01 by using the touch input detecting unit 1 according to the flow chart shown in FIG. 2, and determines that the input operation is a touch operation by using the input method determining unit 2 and notifies the state transition control unit 5 that the input method is a touch operation input by using the input switching control unit 4. Further, the touch-to-command converting unit 3 converts the touch signal showing the press of the “AV” button into the command (AV, AV), and the state transition control unit 5 converts the command into an application execution command for “making a screen transition to the AV source list screen P11” on the basis of the state transition table of FIG. 7A. The application executing unit 11 then acquires data which constructs the AV source list screen P11 from the data group for the AV function stored in the data storage unit 12 according to the application execution command and generates a screen, and the output control unit 13 displays the screen on the touch display.

Because the user then performs a touch operation without a break, the touch input detecting unit 1 detects the press of the “FM” button in the AV source list screen P11, the input method determining unit 2 determines that the input operation is a touch operation, and the input switching control unit 4 notifies the state transition control unit 5 that the input method is a touch operation input. Further, the touch-to-command converting unit 3 converts the touch signal showing the press of the “FM” button into the command (FM, FM), and the state transition control unit 5 converts the command into an application execution command for “making a screen transition to the FM station list screen P12” on the basis of the state transition table of FIG. 7B. The application executing unit 11 then acquires data which constructs the FM station list screen P12 from the data group for the AV function stored in the data storage unit 12 and generates a screen, and the output control unit 13 displays the screen on the touch display.

Because the user then performs a touch operation without a break, the touch input detecting unit 1 detects the press of the “A Broadcast Station” button in the FM station list screen P12, the input method determining unit 2 determines that the input operation is a touch operation, and the input switching control unit 4 notifies the state transition control unit 5 that the input method is a touch operation input. Further, the touch-to-command converting unit 3 converts the touch signal showing the press of the “A Broadcast Station” button into the command (A broadcast station, A broadcast station), and the state transition control unit 5 converts the command into an application execution command for “selecting the A broadcast station” on the basis of the state transition table of FIG. 7A. The application executing unit 11 then acquires a command for controlling car audio equipment from the data group for the AV function stored in the data storage unit 12, and the output control unit 13 controls the car audio equipment to select the A broadcast station.

In contrast, when using a voice operated input, the user utters “A broadcast station” while touching the “AV” button in the application list screen P01 shown in FIG. 3 for a fixed time period, to select the A broadcast station. At this time, the vehicle-mounted information device detects a contact, for a fixed time period, with the “AV” button by using the touch input detecting unit 1 according to the flow chart shown in FIG. 2, and determines that the input operation is a voice operation by using the input method determining unit 2 and notifies the state transition control unit 5 that the input method is a voice operated input from the input switching control unit 4. Further, the touch-to-command converting unit 3 converts the touch signal showing the contact with the “AV” button into an item name (AV), and the input switching control unit 4 notifies the item name to both the state transition control unit 5 and the voice recognition dictionary switching unit 8. The voice recognition unit 9 then switches to the voice recognition dictionary specified by the voice recognition dictionary switching unit 8, and carries out voice recognition on the utterance of “A broadcast station,” and the voice-to-command converting unit 10 converts the voice recognition result into an item value (A broadcast station) and notifies this item value to the state transition control unit 5. The state transition control unit 5 converts the command (AV, A broadcast station) into an application execution command for “making a transition to the FM station list screen P12 and selecting the A broadcast station” on the basis of the state transition table of FIG. 7A. The application executing unit 11 then acquires data which constructs the FM station list screen P12 from the data group for the AV function stored in the data storage unit 12 and generates a screen while acquiring a command for controlling the car audio equipment, and so on from the data group, and the output control unit 13 displays the screen on the touch display while controlling the car audio equipment to tune this car audio equipment to the A broadcast station.

As mentioned above, while the user is enabled to select the A broadcast station in three steps when using a touch operated input, the user is enabled to select the A broadcast station in one step when using a voice operated input.

As an alternative, for example, when the user desires to make a phone call to [symbol] (Yamada)◯◯ and then uses a touch operated input, he or she presses the “Phone” button in the application list screen P01 shown in FIG. 8 to cause the vehicle-mounted information device to make a transition to a phone screen P21. The user then presses a “Phone Book” button of the phone screen P21 to cause the vehicle-mounted information device to make a transition to the phone book list screen P22. Next, the user repeatedly scrolls the list until “ [symbol] (Yamada)◯◯” in the phone book list screen P22 is displayed and then presses the “ [symbol] (Yamada)◯◯” button to cause the vehicle-mounted information device to make a transition to the phone book screen P23. As a result, the vehicle-mounted information device can display the screen that enables the user to make a phone call to [symbol] (Yamada)◯◯. When making a phone call, the user presses a “Call” button in the phone book screen P23 to cause the vehicle-mounted information device to connect with a line of contact.

At this time, the vehicle-mounted information device detects the press of the “Phone” button by using the touch input detecting unit 1 according to the flow chart shown in FIG. 2, and determines that the input operation is a touch operation by using the input method determining unit 2 and notifies the state transition control unit 5 that the input method is a touch operated input from the input switching control unit 4. Further, the touch-to-command converting unit 3 converts the touch signal showing the press of the “Phone” button into a command (phone, phone), and the state transition control unit 5 converts the command into an application execution command for “making a screen transition to the phone screen P21” on the basis of the state transition table of FIG. 7A. The application executing unit 11 then acquires data which constructs the phone screen P21 from the data group for the phone function stored in the data storage unit 12 and generates a screen, and the output control unit 13 displays the screen on the touch display.

Because the user then performs a touch operation without a break, the vehicle-mounted information device detects the press of the “Phone Book” button in the phone screen P21 by using the touch input detecting unit 1, and notifies the state transition control unit 5 that the input method is a touch operated input from the input switching control unit 4. Further, the touch-to-command converting unit 3 converts the touch signal showing the press of the “Phone Book” button into a command (phone book, phone book), and the state transition control unit 5 converts the command into an application execution command for “making a screen transition to the phone book list screen P22” on the basis of the state transition table of FIG. 7C. The application executing unit 11 then acquires data which constructs the phone book list screen P22 from the data group for the phone function stored in the data storage unit 12 and generates a screen, and the output control unit 13 displays the screen on the touch display.

Because the user then performs a touch operation without a break, the vehicle-mounted information device detects the press of the “ [symbol] (Yamada)◯◯” button in the phone book list screen P22 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “ [symbol] (Yamada)◯◯” button into a command ( [symbol] (Yamada)◯◯, [symbol] (Yamada)◯◯), and the state transition control unit 5 converts the command into an application execution command for “making a screen transition to the phone book screen P23, and displaying the phone book of [symbol] (Yamada)◯◯” on the basis of the state transition table of FIG. 7C. The application executing unit 11 then acquires data which constructs the phone book screen P23 from the data group for the phone function stored in the data storage unit 12 and phone number data about [symbol] (Yamada)◯◯ and generates a screen, and the output control unit 13 displays the screen on the touch display.

Because the user then performs a touch operation without a break, the vehicle-mounted information device detects the press of the “Call” button in the phone book screen P23 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “Call” button into a command (call, call), and the state transition control unit 5 converts the command into an application execution command for “connecting with a line of contact” on the basis of the state transition table of FIG. 7C. The application executing unit 11 then connects with a line of contact via the network 14, and the output control unit 13 outputs a voice signal.

In contrast, when using a voice operated input, the user utters “ [symbol] (Yamada)◯◯” while touching the “Phone” button in the application list screen P01 shown in FIG. 8 for a fixed time period, to cause the vehicle-mounted information device to display the phone book screen P23. As a result, the user is enabled to make a phone call by simply pressing the “Call” button. At this time, the vehicle-mounted information device detects a contact, for a fixed time period, with the “Phone” button by using the touch input detecting unit 1 according to the flow chart shown in FIG. 2, and determines that the input operation is a voice operation by using the input method determining unit 2, the touch-to-command converting unit 3 converts the touch signal showing the contact with the “Phone” button into an item name (phone), and the input switching control unit 4 notifies the item name to both the state transition control unit 5 and the voice recognition dictionary switching unit 8. The voice recognition unit 9 then switches to the voice recognition dictionary specified by the voice recognition dictionary switching unit 8 and carries out voice recognition on the utterance of “ [symbol] (Yamada)◯◯”, and the voice-to-command converting unit 10 converts the voice recognition result into an item value ( [symbol] (Yamada)◯◯) and notifies this item value to the state transition control unit 5. The state transition control unit 5 converts the command (phone, [symbol] (Yamada)◯◯) into an application execution command for “making a screen transition to the phone book screen P23, and displaying the phone book of [symbol] (Yamada)◯◯” on the basis of the state transition table of FIG. 7A. The application executing unit 11 then acquires data which constructs the phone book screen P23 from the data group for the phone function stored in the data storage unit 12 and the phone number data about [symbol] (Yamada)◯◯ and generates a screen, and the output control unit 13 displays the screen on the touch display.

As mentioned above, while the user is enabled to cause the vehicle-mounted information device to display the phone book screen P23 in three steps when using a touch operated input, the user is enabled to cause the vehicle-mounted information device to display the phone book screen P23 in one step which is the smallest number of steps when using a voice operated input.

For example, when the user inputs a phone number of 03-3333-4444 and desires to make a phone call to this number, and then uses a touch operated input, he or she presses the “Phone” button in the application list screen P01 shown in FIG. 8 to cause the vehicle-mounted information device to make a transition to the phone screen P21. Next, the user presses a “Number Input” button in the phone screen P21 to cause the vehicle-mounted information device to make a transition to a number input screen P24. The user presses number buttons in the number input screen P24 to input the ten digits and further presses an “Enter” button to cause the vehicle-mounted information device to make a transition from the current screen to a number input call screen P25. As a result, the vehicle-mounted information device can display the screen that enables the user to make a phone call to 03-3333-4444. In contrast, when using a voice operated input, the user utters “0333334444” while touching the “Phone” button in the application list screen P01 shown in FIG. 8 for a fixed time period, to cause the vehicle-mounted information device to display the number input call screen P25. As mentioned above, while the user is enabled to cause the vehicle-mounted information device to display the number input call screen P25 in thirteen steps when using a touch operated input, the user is enabled to cause the vehicle-mounted information device to display the number input call screen P25 in one step which is the smallest number of steps when using a voice operated input.

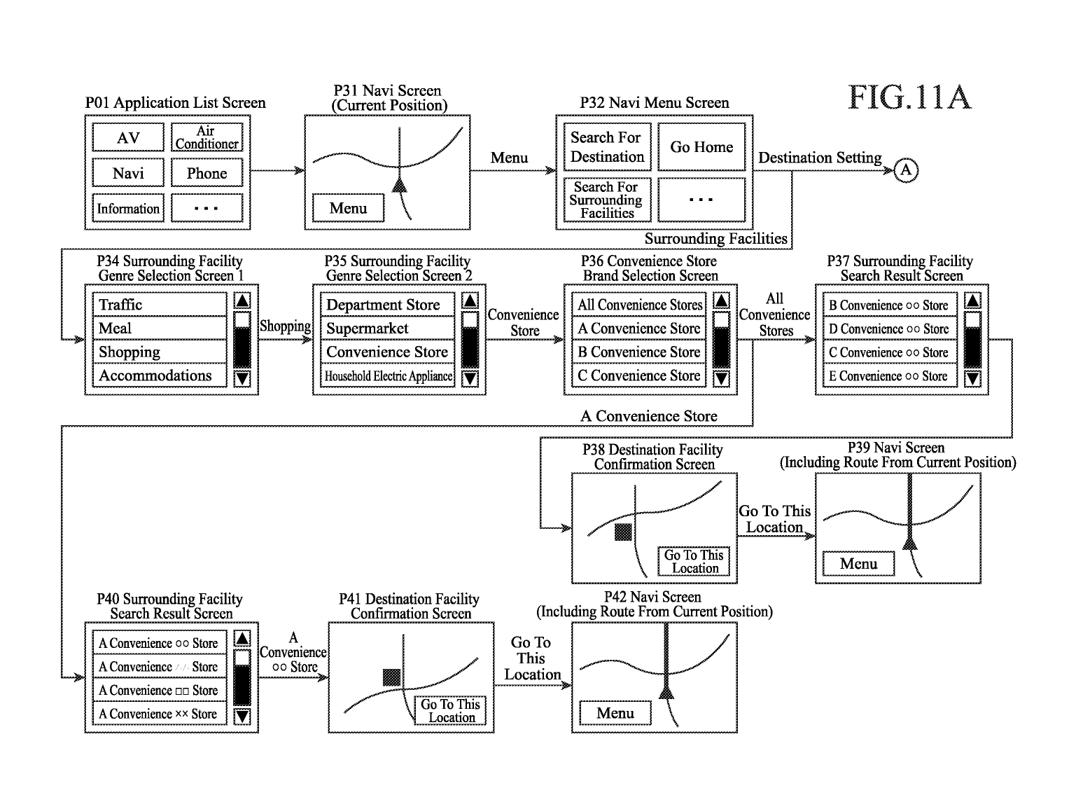

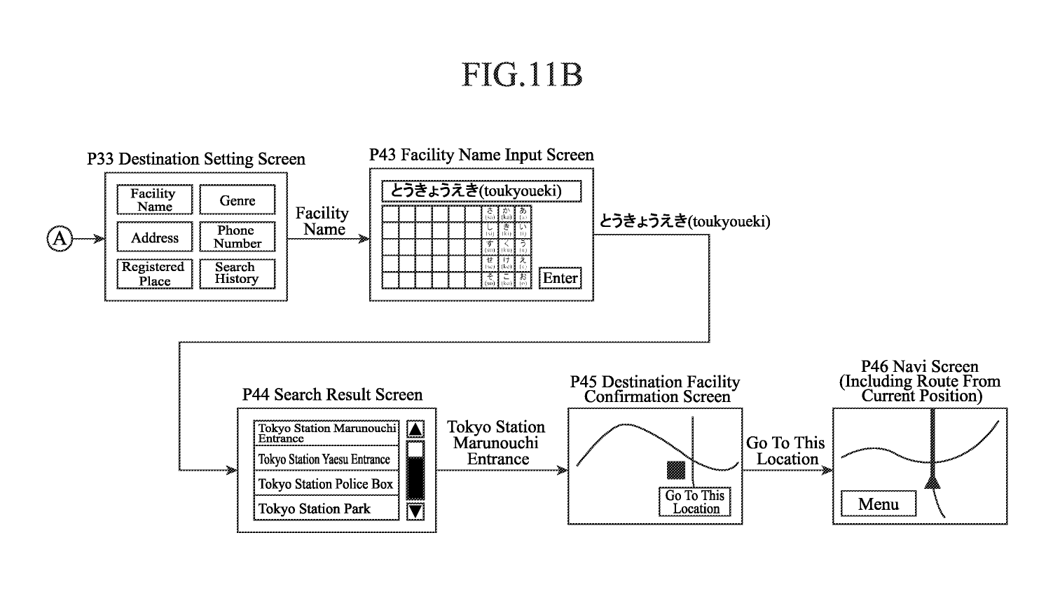

Hereafter, the navi function will be also explained. FIG. 11A is a diagram explaining an example of screen transitions in the vehicle-mounted information device in accordance with Embodiment 1, and shows an example of screens associated with the navi function. Further, FIG. 7D and FIG. 7E are state transition tables corresponding to the screens associated with the navi function. For example, when the user desires to search for convenience stores existing in an area surrounding the current position and then uses a touch operated input, he or she presses the “NAVI” button in the application list screen P01 shown in FIG. 11A to cause the vehicle-mounted information device to make a transition to a navi screen (current position) P31. Next, the user presses a “Menu” button in the navi screen (current position) P31 down to cause the vehicle-mounted information device to make a transition to a navi menu screen P32. The user then presses a “Search For Surrounding Facilities” button in the navigation menu screen P32 to cause the vehicle-mounted information device to make a transition to a surrounding facility genre selection screen 1 P34. Next, the user scrolls a list in the surrounding facility genre selection screen 1 P34 and then presses a “Shopping” button to cause the vehicle-mounted information device to make a transition to a surrounding facility genre selection screen 2 P35. The user then scrolls a list in the surrounding facility genre selection screen 2 P35 and presses a “Convenience Store” button to cause the vehicle-mounted information device to make a transition to a convenience store brand selection screen P36. Next, the user presses an “All Convenience Stores” button in the convenience store brand selection screen P36 to cause the vehicle-mounted information device to make a transition to a surrounding facility search result screen P37. As a result, the vehicle-mounted information device can display a list showing the results of the search for surrounding convenience stores.

At this time, the vehicle-mounted information device detects the press of “NAVI” button in the application list screen P01 by using the touch input detecting unit 1 according to the flow chart shown in FIG. 2, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “NAVI” button into a command (navi, navi), and the state transition control unit 5 converts the command into an application execution command for “making a screen transition to the navi screen (current position) P31” on the basis of the state transition table of FIG. 7A. The application executing unit 11 then acquires the current position from a not-shown GPS receiver or the like and also acquires map data about an area surrounding the current position and so on from a data group for the navi function stored in the data storage unit 12 and generates a screen, and the output control unit 13 displays the screen on the touch display.

Because the user then performs a touch operation without a break, the vehicle-mounted information device detects the press of the “Menu” button in the navi screen (current position) P31 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts a touch signal showing the press of the “Menu” button into a command (menu, menu), and the state transition control unit 5 converts the command into an application execution command for “making a screen transition to the navi menu screen P32” on the basis of the state transition table of FIG. 7D. The application executing unit 11 then acquires data which constructs the navi menu screen P32 from the data group for the navi function stored in the data storage unit 12 and generates a screen, and the output control unit 13 displays the screen on the touch display.

Because the user then performs a touch operation without a break, the vehicle-mounted information device detects the press of the “Search For Surrounding Facilities” button in the navi menu screen P32 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “Search For Surrounding Facilities” button into a command (search for surrounding facilities, search for surrounding facilities), and the state transition control unit 5 converts the command into an application execution command for “making a screen transition to the surrounding facility genre selection screen 1 P34” on the basis of the state transition table of FIG. 7D. The application executing unit 11 then acquires the list items for surrounding facilities from the data group for the navi function stored in the data storage unit 12, and the output control unit 13 displays a list screen (P34) in which the list items are arranged on the touch display.

In this embodiment, in the data storage unit 12, the list items which construct the list screen are divided into groups according to the descriptions of the list items, and are further arranged hierarchically in each of these groups. For example, list items “traffic”, “meal”, “shopping”, and “accommodations” in the surrounding facility genre selection screen 1 P34 are their group names, and are categorized into the highest layers of the groups. For example, in the “shopping” group, list items “department store”, “supermarket”, “convenience store”, and “household electric appliance” are stored in a layer one level lower than that of the list item “shopping.” In addition, in the “shopping” group, list items “all convenience stores”, “A convenience store”, “B convenience store”, and “C convenience store” are stored in a layer one level lower than that of the list item “convenience store.”

Because the user then performs a touch operation without a break, the vehicle-mounted information device detects the press of the “Shopping” button in the surrounding facility genre selection screen 1 P34 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “Shopping” button into a command (shopping, shopping), and the state transition control unit 5 converts the command into an application execution command for “making a screen transition to the surrounding facility genre selection screen 2 P35” on the basis of the state transition table of FIG. 7D. The application executing unit 11 then acquires the list items of the surrounding facilities which are included in the surrounding facilities and which are associated with the shopping from the data group for the navi function stored in the data storage unit 12, and the output control unit 13 displays the list screen (P35) on the touch display.

Because the user then performs a touch operation without a break, the vehicle-mounted information device detects the press of the “Convenience Store” button in the surrounding facility genre selection screen 2 P35 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “Convenience Store” button into a command (convenience store, convenience store), and the state transition control unit 5 converts the command into an application execution command for “making a screen transition to the convenience store brand selection screen P36” on the basis of the state transition table of FIG. 7E. The application executing unit 11 then acquires the list items of the convenience store brand types of the convenience stores which are included in the surrounding facilities from the data group for the navi function stored in the data storage unit 12, and the output control unit 13 displays the list screen (P36) on the touch display.

Because the user then performs a touch operation without a break, the vehicle-mounted information device detects the press of the “All Convenience Stores” button in the convenience store brand selection screen P36 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “All Convenience Stores” button into a command (all convenience stores, all convenience stores), and the state transition control unit 5 converts the command into an application execution command for “making a screen transition to the surrounding facility search result screen P37, searching for surrounding facilities by all convenience stores, and displaying the search results” on the basis of the state transition table of FIG. 7E. The application executing unit 11 then retrieves the convenience stores from the map data in the data group for the navi function stored in the data storage unit 12 by setting an area centered at the current position previously acquired as a search area, and generates list items, and the output control unit 13 displays the list screen (P37) on the touch display.

Because the user then performs a touch operation without a break, the vehicle-mounted information device detects the press of a “B ◯◯ Convenience Store” button in the surrounding facility search result screen P37 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “B ◯◯ Convenience Store” button into a command (B ◯◯ convenience store, B ◯◯ convenience store), and the state transition control unit 5 converts the command into an application execution command for “making a screen transition to a destination facility confirmation screen P38, and displaying a map of the B ◯◯ convenience store” on the basis of the state transition table of FIG. 7E. The application executing unit 11 then acquires map data about a map including the B ◯◯ convenience store from the data group for the navi function stored in the data storage unit 12 and generates a destination facility confirmation screen P38, and the output control unit 13 displays the screen on the touch display.

Because the user then performs a touch operation without a break, the vehicle-mounted information device detects the press of a “Go To This Location” button in the destination facility confirmation screen P38 by using the touch input detecting unit 1, determines that the input operation is a touch operation by using the input method determining unit 2, and notifies the state transition control unit 5 that the input method is a touch operated input from the input switching control unit 4. Further, the touch-to-command converting unit 3 converts the touch signal showing the press of the “Go To This Location” button into a command (go to this location, B ◯◯ convenience store), and the state transition control unit 5 converts the command into an application execution command on the basis of a not-shown state transition table. The application executing unit 11 uses the map data in the data group for the navi function stored in the data storage unit 12 to make a search for a route from the current position previously acquired with the B ◯◯ convenience store being set as a destination, and produces a navi screen (including the route from the current position) P39, and the output control unit 13 displays the screen on the touch display.

In contrast, when using a voice operated input, the user utters “convenience store” while touching the “NAVI” button in the application list screen P01 shown in FIG. 11A for a fixed time period, to cause the vehicle-mounted information device to display the surrounding facility search result screen P37. At this time, the vehicle-mounted information device detects a contact, for a fixed time period, with the “NAVI” button by using the touch input detecting unit 1 according to the flow chart shown in FIG. 2 and determines that the input operation is a voice operation by using the input method determining unit 2, and the touch-to-command converting unit 3 converts the touch signal showing the contact with the “NAVI” button into an item name (navi) and the input switching control unit 4 notifies the item name to both the state transition control unit 5 and the voice recognition dictionary switching unit 8. The voice recognition unit 9 then switches to the voice recognition dictionary specified by the voice recognition dictionary switching unit 8 and carries out voice recognition on the utterance of “convenience store”, and the voice-to-command converting unit 10 converts the voice recognition result into an item value (convenience store) and notifies this item value to the state transition control unit 5. The state transition control unit 5 converts the command (navi, convenience store) into an application execution command for “making a screen transition to the surrounding facility search result screen P37, searching for surrounding facilities by all convenience stores, and displaying the search results” on the basis of the state transition table of FIG. 7A. The application executing unit 11 retrieves the convenience stores from the map data in the data group for the navi function stored in the data storage unit 12 and generates list items, and the output control unit 13 displays the list screen (P37) on the touch display. Because the operation of enabling the user to set a specific convenience store as a destination in the surrounding facility search result screen P37 and then providing route guidance for the user (the destination facility confirmation screen P38 and the navi screen (including the route from the current position) P39) is substantially the same as the above-mentioned process, the explanation of the operation will be omitted hereafter.

As mentioned above, while the user is enabled to cause the vehicle-mounted information device to display the surrounding facility search result screen P37 in six steps when using a touch operated input, the user is enabled to cause the vehicle-mounted information device to display the surrounding facility search result screen P37 in one step which is the smallest number of steps when using a voice operated input.

Further, for example, when the user desires to search for facilities by a facility name, such as Tokyo station, and then uses a touch operated input, he or she presses the “NAVI” button in the application list screen P01 shown in FIG. 11A to cause the vehicle-mounted information device to make a transition to the navi screen (current position) P31. Next, the user presses the “Menu” button in the navi screen (current position) P31 to cause the vehicle-mounted information device to make a transition to the navi menu screen P32. The user then press a “Search For Destination” button in the navi menu screen P32 to cause the vehicle-mounted information device to make a transition to a destination setting screen P33 shown in FIG. 11B. Next, the user presses a “Facility Name” button in the destination setting screen P33 shown in FIG. 11B to cause the vehicle-mounted information device to make a transition to a facility name input screen P43. The user then presses character buttons associated with the seven characters of “ [symbol] [symbol] (toukyoueki)” in the facility name input screen P43 to input the seven characters and further presses an “Enter” button to cause the vehicle-mounted information device to make a transition from the current screen to a search result screen P44. As a result, the vehicle-mounted information device can display a list of the results of the search for facilities by Tokyo station. In contrast, when using a voice operated input, the user is enabled to cause the vehicle-mounted information device to display the search result screen P44 shown in FIG. 11B by simply uttering “ [symbol] (toukyoueki)” while touching the “NAVI” button in the application list screen P01 shown in FIG. 11A for a fixed time period. As mentioned above, while the user is enabled to cause the vehicle-mounted information device to display the search result screen P44 in twelve steps when using a touch operated input, the user is enabled to cause the vehicle-mounted information device to display the search result screen P44 in one step which is the smallest number of steps when using a voice operated input.

The user is enabled to cause the vehicle-mounted information device to switch to a voice operated input while making a touch operated input. For example, the user presses the “NAVI” button in the application list screen P01 shown in FIG. 11A to cause the vehicle-mounted information device to make a transition to the navi screen (current position) P31. The user then presses the “Menu” button in the navi screen (current position) P31 to cause the vehicle-mounted information device to make a transition to the navi menu screen P32. At this time, when causing the vehicle-mounted information device to switch to a voice operated input, the user is enabled to cause the vehicle-mounted information device to display the surrounding facility search result screen P37 by simply uttering “convenience store” while touching the “Search For Surrounding Facilities” button in the navi menu screen P32 for a fixed time period. In this case, the vehicle-mounted information device can transition from the application list screen P01 in three steps to display a list of the results of the search for convenience stores existing in an area surrounding the current position. As an alternative, the user is enabled to cause the vehicle-mounted information device to display the search result screen P44 shown in FIG. 11B by simply uttering “ [symbol] (toukyoueki)” while touching the “Search For Destination” button in the navi menu screen P32 for a fixed time period. In this case, the vehicle-mounted information device can transition from the application list screen P01 in three steps to display a list of the results of the search for facilities by Tokyo station. As an alternative, the user is enabled to cause the vehicle-mounted information device to display the search result screen P44 by simply uttering “ [symbol] (toukyoueki)” while touching the “Facility Name” button in the destination setting screen P33 shown in FIG. 11B for a fixed time period. In this case, the vehicle-mounted information device can transition from the application list screen P01 in four steps to display a list of the results of the search for facilities by Tokyo station. Thus, the vehicle-mounted information device makes it possible for the user to perform the same voice input “ [symbol] (toukyoueki)” on each of the different screens P32 and P33, and the number of steps in which the vehicle-mounted information device transitions from the application list screen varies dependently upon the screen on which the user has performed the voice input.

In contrast, the user is also enabled to cause the vehicle-mounted information device to display a screen which the user desires by performing a different voice input on the same button in the same screen. For example, although the user utters “convenience store” while touching the “NAVI” button in the application list screen P01 shown in FIG. 11A for a fixed time period to cause the vehicle-mounted information device to display the surrounding facility search result screen P37 in the above-mentioned example, the user is enabled to cause the vehicle-mounted information device to display the surrounding facility search result screen P40 (based on the state transition table of FIG. 7A) when uttering “A convenience store” while touching the same “NAVI” button for a fixed time period. In this example, a user who desires to search for convenience stores vaguely is enabled to cause the vehicle-mounted information device to provide the results of the search for convenience stores of all the brands by simply uttering “convenience store.” In contrast, a user who desires to search for only “A convenience stores” is enabled to cause the vehicle-mounted information device to provide the results of the search which are narrowed down to only A convenience stores by simply uttering “A convenience store.”

As mentioned above, the vehicle-mounted information device according to Embodiment 1 is constructed in such a way as to include: the touch input detecting unit 1 for detecting a touch operation on the basis of the output signal of the touch display; the touch-to-command converting unit 3 for generating a command (item name, item value) including an item name for performing a process corresponding to a button on which a touch operation is performed (either or both of a transition destination screen and an application execution function) on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the touch display and the speaker, for outputting the result of the execution by the application executing unit 11. Therefore, because the vehicle-mounted information device determines whether the operation mode is the touch operation one or the voice operation one according to the state of the touch operation on the button, the user is enabled to use one button to switch between a general touch operation and a voice operation associated with the button and perform an input, and the intelligibility of the touch operation can be ensured. Further, because the item value into which the voice recognition result is converted is information used for performing a process included in the same process group as the item name which is the button name and categorized into a lower layer, the user is enabled to cause the vehicle-mounted information device to perform the lower layer process associated with this button by simply uttering the description associated with the button which the user has touched with an objective. Therefore, the user does not have to memorize a predetermined specific voice operation method and predetermined voice recognition keywords, unlike in the case of conventional information devices. Further, because the user is enabled to press a button on which a name, such as “NAVI” or “AV”, is displayed and utter a voice recognition keyword associated with the button in this Embodiment 1, as compared with a conventional case in which the user presses a simple “utterance button” and then utters, the vehicle-mounted information device can implement an intuitive and intelligible voice operation and can solve a problem arising in the voice operation, such as “I don't know what I should say.” In addition, the vehicle-mounted information device can reduce the number of operation steps and the operation time.

Further, the vehicle-mounted information device according to Embodiment 1 is constructed in such a way as that the vehicle-mounted information device includes the voice recognition dictionary DB 7 for storing voice recognition dictionaries each of which is comprised of voice recognition keywords each brought into correspondence with a process, and the voice recognition dictionary switching unit 8 for switching to a voice recognition dictionary included in the voice recognition dictionary DB 7 and brought into correspondence with the process associated with a button (i.e., an item name) on which a touch operation is performed, and the voice-to-command converting unit 10 carries out voice recognition on a user's utterance which is made at substantially the same time when or after the touch operation is performed by using a voice recognition dictionary to which the voice recognition dictionary switching unit 8 switches. Therefore, the voice recognition keywords can be narrowed down to the ones associated with the button on which the touch operation is performed, and the voice recognition rate can be improved.

### Embodiment 2

Although the vehicle-mounted information device in accordance with above-mentioned Embodiment 1 carried out an identical operation on a list screen in which list items are displayed, like the phone book list screen P22 shown in, for example, FIG. 8, and a screen other than the list screen, a vehicle-mounted information device in accordance with this Embodiment 2 is constructed in such a way as to, when displaying a list screen, carry out an operation more suitable for this screen. Concretely, the vehicle-mounted information device dynamically generates a voice recognition dictionary associated with list items in a list screen, and detects a touch operation on a scroll bar and determines a voice operated input such as an input for selecting a list item.

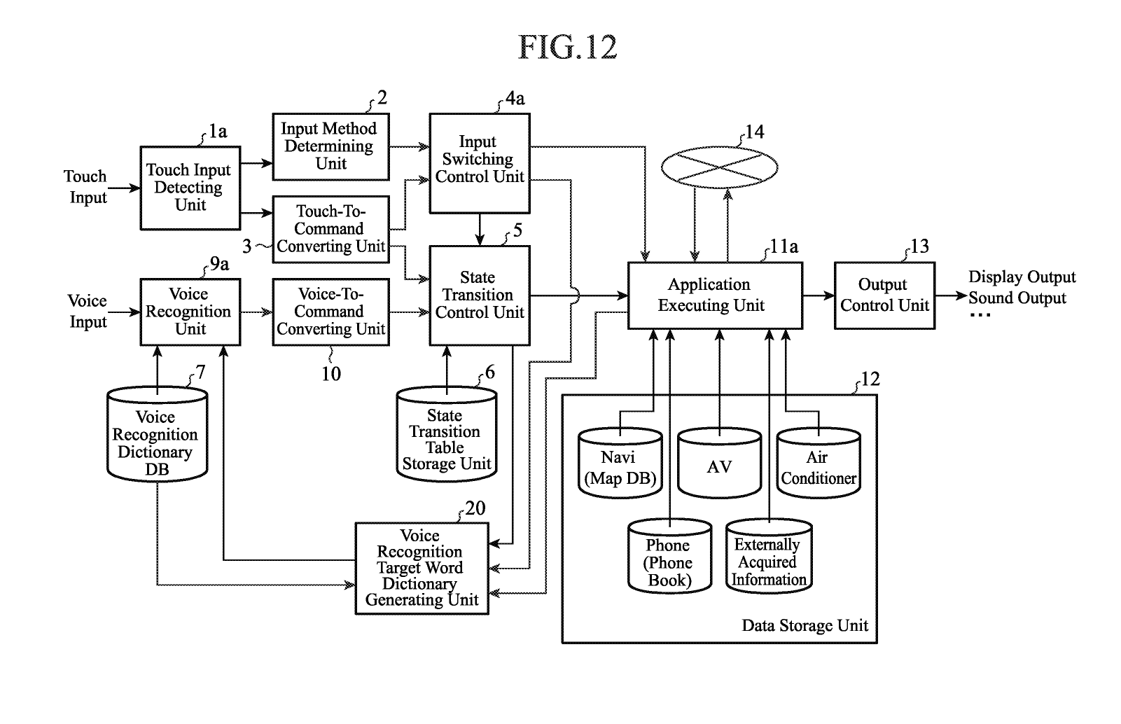

FIG. 12 is a block diagram showing the structure of the vehicle-mounted information device in accordance with this Embodiment 2. This vehicle-mounted information device is newly provided with a voice recognition target word dictionary generating unit 20. In addition, in FIG. 12, the same components as those shown in FIG. 1 or like components are designated by the same reference numerals as those shown in the figure, and the detailed explanation of the components will be omitted hereafter.

A touch input detecting unit 1a detects whether a user has touched the scroll bar (a display area of the scroll bar) on the basis of an input signal from a touch display when a list screen is displayed. An input switching control unit 4a notifies a state transition control unit 5 of whether the user is performing either one of input operations on the basis of the result (a touch operation or a voice operation) of determination by an input method determining unit 2, and also notifies an application executing unit 11a of whether the user is performing either one of the input operations. When the input switching control unit 4a notifies that the user is performing a touch operation thereto, the application executing unit 11a scrolls a list in the list screen. Further, the application executing unit 11a carries out either a screen transition or an application function according to an application execution command notified thereto from the state transition control unit 5 by using various data stored in a data storage unit 12 when notified that the user is performing a voice operation from the input switching control unit 4a, like that according to above-mentioned Embodiment 1.

The voice recognition target word dictionary generating unit 20 acquires data about a list of list items to be displayed on the screen from the application executing unit 11a, and generates a voice recognition target word dictionary associated with the list items acquired by using a voice recognition dictionary DB 7. When a list screen is displayed, a voice recognition unit 9a carries out a voice recognition process on a sound signal from a microphone by referring to the voice recognition target word dictionary generated by the voice recognition target word dictionary generating unit 20 to convert the sound signal into a character string or the like, and outputs this character string to a voice-to-command converting unit 10.

When a screen other than the list screen is displayed, the vehicle-mounted information device should just carry out the same process as that shown in above-mentioned Embodiment 1, and a not-shown voice recognition dictionary switching unit 8 commands the voice recognition unit 9a to switch to a voice recognition dictionary consisting of a group of voice recognition keywords respectively linked to item names.

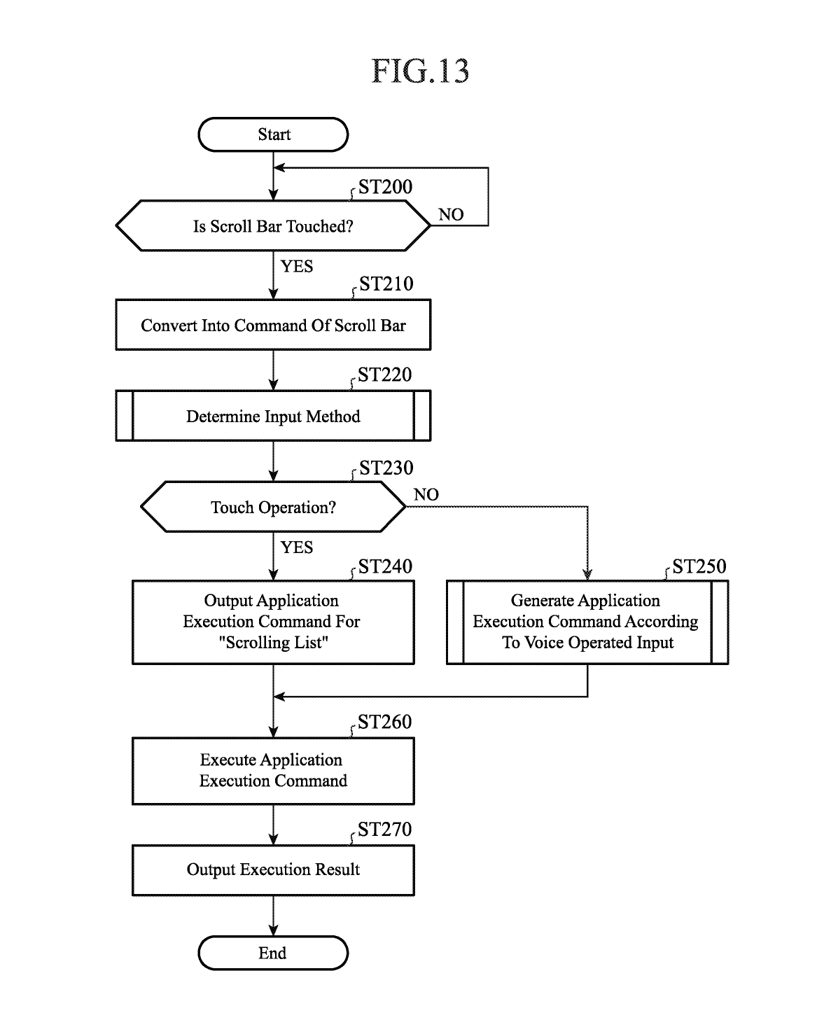

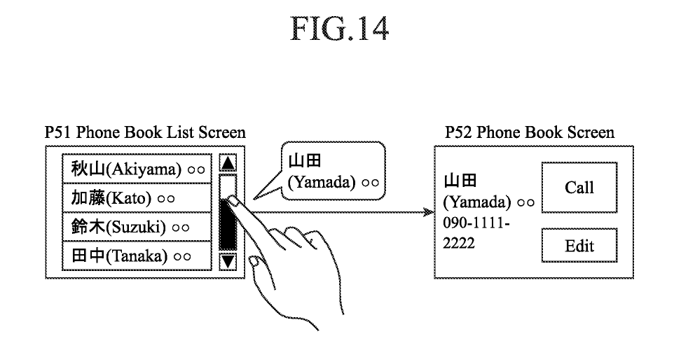

Next, the operation of the vehicle-mounted information device will be explained. FIG. 13 is a flow chart showing the operation of the vehicle-mounted information device in accordance with Embodiment 2. FIG. 14 shows an example of screen transitions made by the vehicle-mounted information device, and it is assumed in this example that the vehicle-mounted information device displays a phone book list screen P51 for a phone function which is one of the functions of the application executing unit 11 on the touch display.

The touch input detecting unit 1a, in step ST200, detects whether a user has touched a scroll bar displayed on the touch display. When detecting a touch on the scroll bar (when “YES” in step ST200), the touch input detecting unit 1a outputs a touch signal showing how the scroll bar is touched (whether the touch is an operation of trying to scroll a list, an operation of touching the scroll bar for a fixed time, or the like) on the basis of the output signal from the touch display.

The touch-to-command converting unit 3, in step ST210, converts the touch into (scroll bar, scroll bar) which is a command (item name, item value) for the scroll bar on the basis of the touch signal inputted thereto from the touch input detecting unit 1a, and outputs the command.

The input method determining unit 2, in step ST220, determines an input method by determining whether the user is trying to perform either a touch operation or a voice operation on the basis of the touch signal inputted thereto from the touch input detecting unit 1a, and outputs the input method. This process of determining the input method is as shown in the flow chart of FIG. 4. The input method determining unit in accordance with above-mentioned Embodiment 1 determines that the operation mode is the touch operation one when, for example, the touch signal shows that the user's operation is an operation of pressing a button, whereas the vehicle-mounted information device determines that the operation mode is the voice operation one when, for example, the touch signal shows that the user's operation is an operation of touching a button for a fixed time period according to the criteria shown in FIG. 5. In contrast, the input method determining unit in accordance with this Embodiment 2 should just properly set up criteria, such as a criterion by which to determine that the operation mode is the touch operation one when the touch signal shows that the user's operation is an operation of trying to scroll a list while pressing a scroll bar, and a criterion by which to determine that the operation mode is the voice operation one when the touch signal shows that the user's operation is an operation of simply touching a scroll bar for a fixed time period.

When, in step ST230, determining that the determination result inputted thereto from the input switching control unit 4a indicates the touch operation mode (when “YES” in step ST230), the state transition control unit 5, in next step ST240, converts the command inputted thereto from the touch-to-command converting unit 3 into an application execution command on the basis of a state transition table stored in a state transition table storage unit 6.

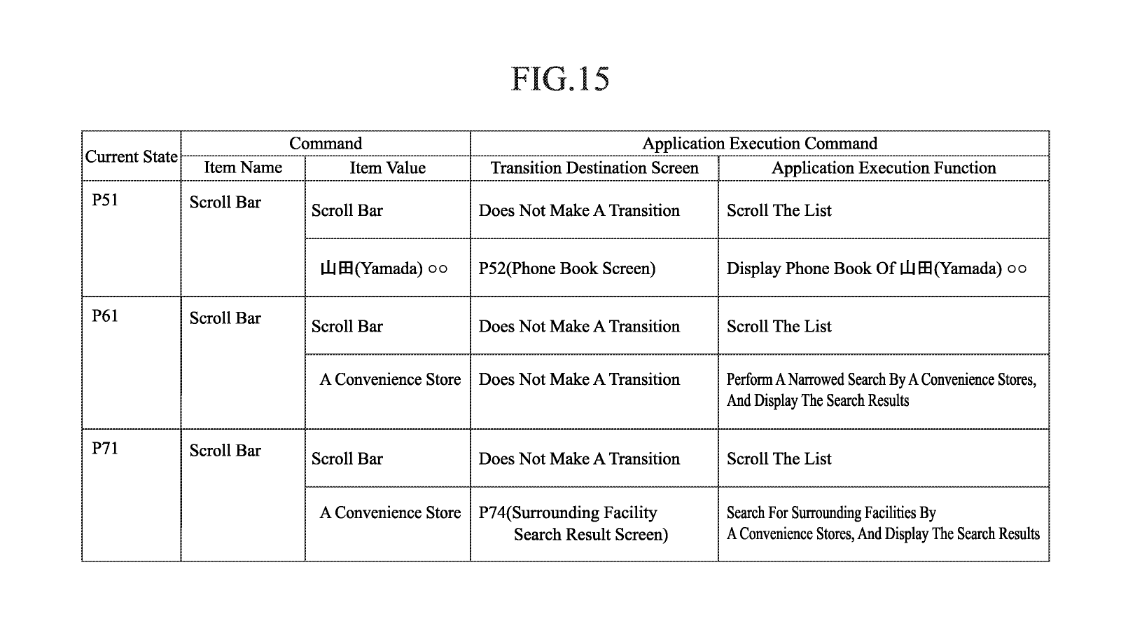

Hereafter, an example of the state transition table which the state transition table storage unit 6 according to this Embodiment 2 has is shown in FIG. 15. A command corresponding to the scroll bar displayed on each screen (P51, P61, and P71) is set to this state transition table, and their item names are “scroll bar.” The item values of the commands include ones to which “scroll bar” being the same as the item names is assigned, and ones to each of which a different name is assigned. A command having an item name and an item value being the same as each other is used at the time of a touch operated input, while a command having an item name and an item value being different from each other is used mainly at the time of a voice operated input.

For an application execution command corresponding to a command (scroll bar, scroll bar), “does not make a transition” is set as a transition destination screen and “scroll list” is set, as an application execution function, according to a touch operation. Therefore, the state transition control unit 5, in step ST240, converts the command (scroll, scroll) inputted thereto from the touch-to-command converting unit 3 into an application execution command for “scrolling the list without making a screen transition.”

The application executing unit 11a which receives the application execution command for “scrolling the list without making a screen transition” from the state transition control unit 5, in next step ST260, scrolls the list in the list screen currently being displayed.

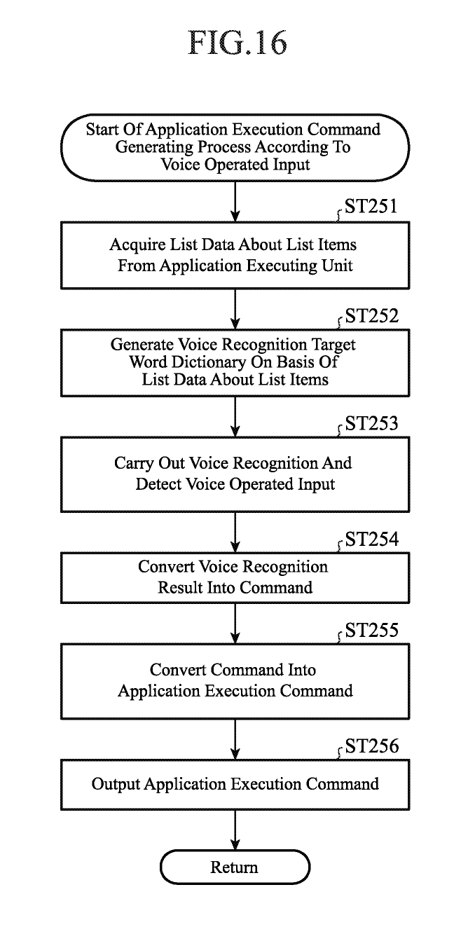

In contrast, when the determination result inputted from the input switching control unit 4a indicates the voice operation mode (“NO” in step ST230), the state transition control unit advances to step ST250 and generates an application execution command according to a voice operation input. Hereafter, a generation method of generating an application execution command according to a voice operated input will be explained by using a flowchart shown in FIG. 16. When, in step ST251, receiving a notification of the result of the determination of a voice operated input from the input switching control unit 4a, the voice recognition target word dictionary generating unit 20 acquires the list data about the list items in the list screen currently being displayed on the touch display from the application executing unit 11a.

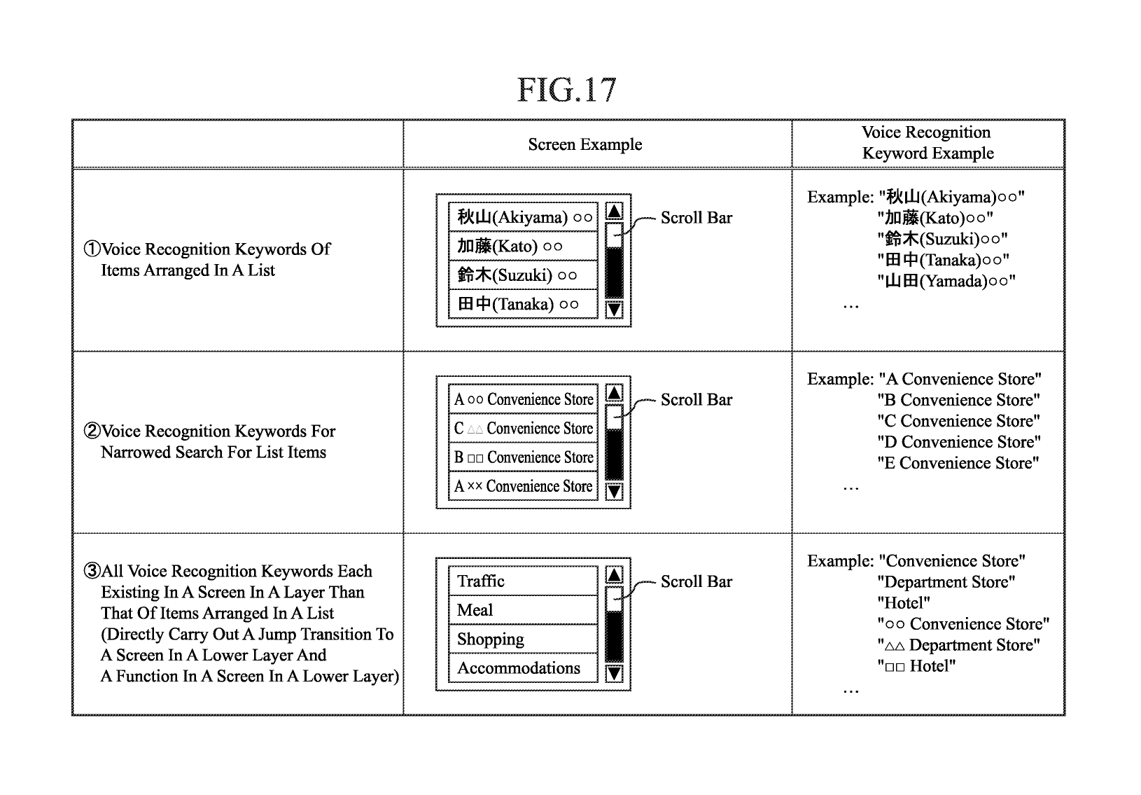

The voice recognition target word dictionary generating unit 20, in next step ST252, generates a voice recognition target word dictionary associated with the acquired list items. FIG. 17 is a diagram for explaining the voice recognition target word dictionary. This voice recognition target word dictionary includes the following three types of voice recognition keywords:

(1) the voice recognition keywords of the items arranged in the list,

(2) voice recognition keywords each used for making a search while narrowing down the list items, and

(3) all voice recognition keywords each existing in a screen in a layer lower than that of the items arranged in the list.

For example, (1) the voice recognition keywords are names arranged in a phone book list screen ( [symbol] (Akiyama)◯◯, [symbol] (Kato)◯◯, [symbol] (Suzuki)◯◯, [symbol] (Tanaka)◯◯, [symbol] (Yamada)◯◯, etc.). For example, (2) voice recognition keywords are convenience store brand names (A convenience store, B convenience store, C convenience store, D convenience store, E convenience store, etc.) arranged in a surrounding facility search result screen showing the result of searching for “convenience stores” among the facilities located in an area surrounding the current position. For example, (3) all voice recognition keywords include genre names (convenience store, department store, etc.) included in a screen in a layer lower than that of a “shopping” item arranged in a surrounding facility genre selection screen 1 and convenience store brand names (◯◯ convenience store etc.) and department store brand names (ΔΔ department store etc.) respectively included in screens in a layer lower than that of the genre names, and genre names (hotel etc.) included in a screen in a layer lower than that of an “accommodations” item and hotel brand names ( [symbol] hotel etc.) included in screens in a layer lower than that of the genre names. In addition, (3) all voice recognition keywords include voice recognition keywords included in a screen in a layer lower than that of “traffic” and in a screen in a layer lower than that of “meal.” As a result, the vehicle-mounted information device can make a jump transition to a screen in a layer lower than that of the screen currently being displayed, and directly carry out a function in a screen in a lower layer.

The voice recognition unit 9a, in next step ST253, carries out a voice recognition process on a sound signal inputted thereto from the microphone by using the voice recognition target word dictionary which the voice recognition target word dictionary generating unit 20 generates to detect a voice operated input, and outputs the voice operated input. For example, when a user touches the scroll bar in the phone book list screen P51 shown in FIG. 14 for a fixed time period (or when the user presses the scroll bar half way, double taps the scroll bar, long presses the scroll bar, for example), a dictionary including name items, such as [symbol] (Akiyama)◯◯, as voice recognition keywords is generated as the voice recognition target word dictionary. Therefore, the voice recognition keywords are narrowed down to the voice recognition keywords associated with the list, and hence an improvement in the voice recognition rate can be expected.

The voice-to-command converting unit 10, in next step ST254, converts the voice recognition result inputted thereto from the voice recognition unit 9a into a command (item value), and outputs this command. The state transition control unit 5, in step ST255, converts the command (item name, item value) which consists of the item name inputted thereto from the input switching control unit 4a and the item value inputted thereto from the voice-to-command converting unit 10 into an application execution command on the basis of the state transition table stored in the state transition table storage unit 6.

Hereafter, an example of converting the command into an application execution command in the case of a voice operated input will be explained. The current state is the phone book list screen P51 shown in FIG. 14. When the user then utters a voice recognition keyword “ [symbol] (Yamada)◯◯” while touching the scroll bar for a fixed time period, the item name inputted from the input switching control unit 4a to the state transition control unit 5 is scroll. Further, the item value inputted from the voice-to-command converting unit 10 to the state transition control unit 5 is [symbol] (Yamada)◯◯. Therefore, the command is (scroll bar, [symbol] (Yamada)◯◯). According to the state transition table shown in FIG. 15, the command (scroll bar, [symbol] [symbol] (Yamada)◯◯) is converted into an application execution command for “making a screen transition to the phone book screen P52, and displaying the phone book of [symbol] (Yamada)◯◯.” As a result, the user is enabled to easily select and determine a list item, such as “ [symbol] (Yamada)◯◯,” which is arranged in a lower portion of the list items, but not displayed on the list screen.

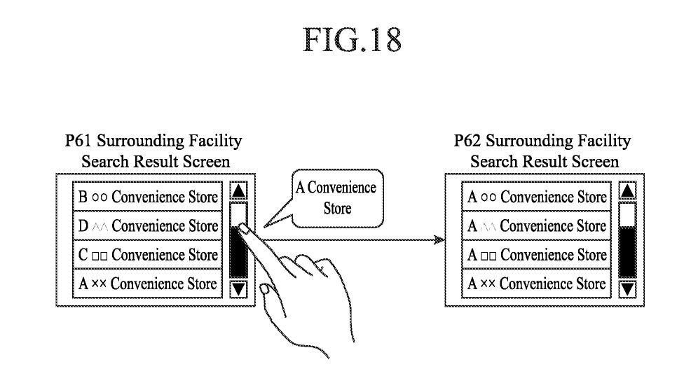

As an alternative, for example, it is assumed that the current state is a surrounding facility search result screen P61 shown in FIG. 18. When the user then utters a voice recognition keyword “A convenience store” while touching the scroll bar for a fixed time period, the command is (scroll bar, A convenience store) because the item value inputted from the voice-to-command converting unit 10 to the state transition control unit 5 is A convenience store. According to the state transition table shown in FIG. 15, the command (scroll bar, A convenience store) is converted into an application execution command for “making a narrowed search by A convenience store and displaying search results without making a screen transition.” As a result, the user is enabled to easily cause the vehicle-mounted information device to make a search while narrowing down the list items.

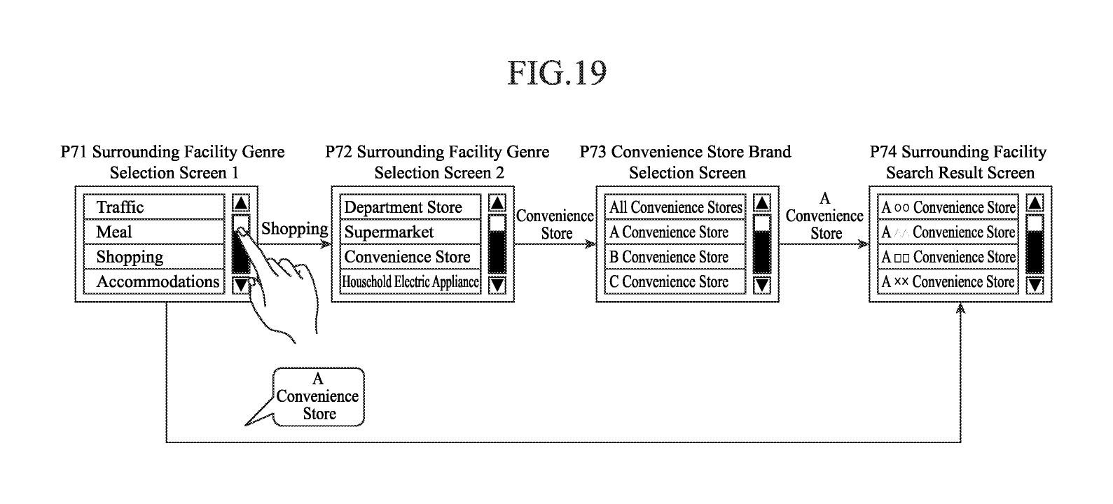

As an alternative, for example, it is assumed that the current state is a surrounding facility genre selection screen 1 P71 shown in FIG. 19. When the user then utters the voice recognition keyword “A convenience store” while touching the scroll bar for a fixed time period, the command is (scroll bar, A convenience store) also in this case because the item value inputted from the voice-to-command converting unit 10 to the state transition control unit 5 is A convenience store. According to the state transition table of FIG. 15, the application execution command differs according to the current state even though the same command (scroll bar, A convenience store) is provided. Therefore, the command (scroll bar, A convenience store) in the case of the surrounding facility genre selection screen 1 P71 is converted into an application execution command for “making a screen transition to a surrounding facility search result screen P74, searching for surrounding facilities by A convenience store, and displaying search results.” As a result, the user is enabled to easily cause the vehicle-mounted information device to make a transition to a screen in a layer lower than that of the list screen currently being displayed and perform an application function in a layer lower than that of the list screen currently being displayed.

The state transition control unit 5, in next step ST256, outputs the application execution command into which the command is converted to the application executing unit 11a.

Going back to the explanation of the flow chart of FIG. 13, the application executing unit 11a, in step ST260, acquires necessary data from the data storage unit 12 according to the application execution command inputted thereto from the state transition control unit 5, and carries out either or both of a screen transition and a function. An output control unit 13, in next step ST270, outputs the results of the screen transition and the function which are carried out by the application executing unit 11a by producing a display, a voice message, etc. Because the operations of the application executing unit 11a and the output control unit 13 are the same as those in accordance with above-mentioned Embodiment 1, the explanation of the operations will be omitted hereafter.

Although the voice recognition target word dictionary generating unit 20 is constructed in such a way as to, in step ST252, generate a voice recognition target word dictionary after a touch on the scroll bar in a list screen is detected in step ST200, as shown in the flow charts of FIGS. 13 and 16, the timing of the generation of the dictionary is not limited to this example. For example, the voice recognition target word dictionary generating unit is constructed in such a way as to generate a voice recognition target word dictionary associated with a list screen at the time of making a transition to the list screen (at the time that the application executing unit 11a generates the list screen or at the time that the output control unit 13 displays the list screen).

Further, in a case in which list items to be displayed on the screen are predetermined, such as in a case of displaying a surrounding facility genre selection screen (P71 to P73 shown in FIG. 19) for the navigation function, a voice recognition target word dictionary used for the list screen can be prepared. When the scroll bar in the list screen is detected or when a transition to the list screen is made, the vehicle-mounted information device should just switch to the voice recognition target word dictionary prepared in advance.

As mentioned above, the vehicle-mounted information device according to Embodiment 2 is constructed in such a way that the vehicle-mounted information device includes: the data storage unit 12 for storing data about list items which are divided into groups and which are arranged hierarchically in each of the groups; the voice recognition dictionary DB 7 for storing voice recognition keywords respectively brought into correspondence with the list items; and the voice recognition target word dictionary generating unit 20 for, when a touch operation is performed on a scroll bar of a list screen in which items in a predetermined layer of each of the groups of the data stored in the data storage unit 12 are arranged, extracting a voice recognition keyword brought into correspondence with each list item arranged in the list screen and a voice recognition keyword brought into correspondence with a list item in a layer lower than that of the list screen from the voice recognition dictionary DB 7 to generate a voice recognition target word dictionary, and the voice-to-command converting unit 10 carries out voice recognition on a user's utterance which is made at substantially the same time when or after the touch operation on the scroll bar area is performed by using the voice recognition target word dictionary which the voice recognition dictionary generating unit 20 generates to acquire a voice recognition keyword brought into correspondence with each list item arranged in the list screen or a voice recognition keyword brought into correspondence with a list item in a layer lower than that of the list screen. Therefore, the user is enabled to, according to the state of a touch operation on the scroll bar of the list screen, switch between a general touch scroll operation and a voice operation associated with the list and perform an input. Further, by simply uttering a target list item while touching the scroll bar, the user is enabled to select and determine the target item from this list screen, narrow the list items in the current list screen down to list items in a lower layer, or cause the vehicle-mounted information device to make a jump transition to a screen in a layer lower than that of the current list screen or perform an application function. Therefore, the number of operation steps and the operation time can be reduced. Further, the user is enabled to perform a voice operation on the list screen intuitively without memorizing predetermined voice recognition keywords, unlike in the case of conventional vehicle-mounted information devices. In addition, the vehicle-mounted information device can narrow down the voice recognition keywords to the ones associated with the list items displayed on the screen, thereby being able to improve the voice recognition rate.

As mentioned above, the voice recognition target word dictionary generating unit 20 can generate the voice recognition target word dictionary not after a touch operation is performed on the scroll bar, but when the list screen is displayed. Further, voice recognition keywords to be extracted are not limited to a voice recognition keyword brought into correspondence with each list item arranged in the list screen and a voice recognition keyword brought into correspondence with a list item in a layer lower than that of the list screen. For example, only a voice recognition keyword brought into correspondence with each list item arranged in the list screen can be extracted, or a voice recognition keyword brought into correspondence with each list item arranged in the list screen and a voice recognition keyword brought into correspondence with a list item in a layer one level lower than that of the list screen. As an alternative, a voice recognition keyword brought into correspondence with each list item arranged in the list screen and voice recognition keywords respectively brought into correspondence with list items in all layers lower than that of the list screen can be extracted.

### Embodiment 3

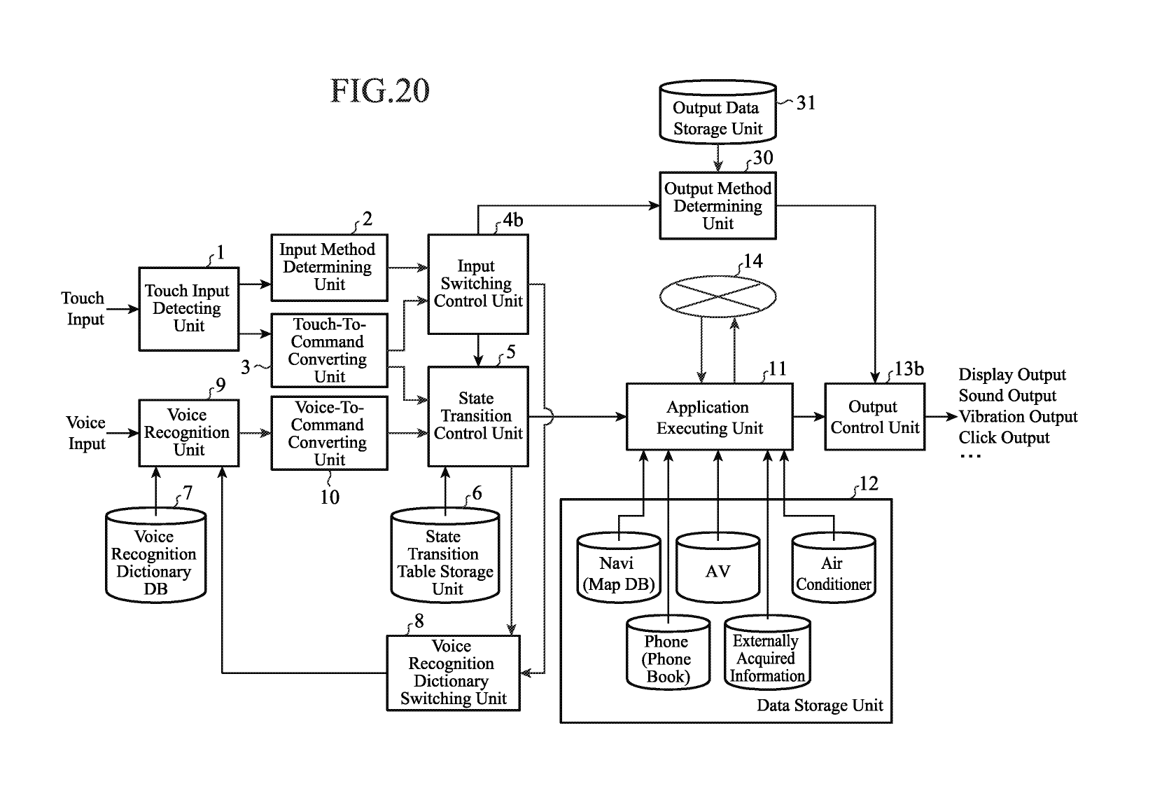

FIG. 20 is a block diagram showing the structure of a vehicle-mounted information device in accordance with this Embodiment 3. This vehicle-mounted information device is newly provided with an output method determining unit 30 and an output data storage unit 31, and notifies whether an operation mode is a touch operation one or a voice operation one to a user. In addition, in FIG. 20, the same components as those shown in FIG. 1 or like components are designated by the same reference numerals as those shown in the figure, and the detailed explanation of the components will be omitted hereafter.

An input switching control unit 4b notifies whether a user desires either one of input operations to a state transition control unit 5 on the basis of the result of determination (whether the operation mode is the touch operation one or the voice operation one) by an input method determining unit 2, and also notifies the result to the output method determining unit 30. The input switching control unit 4b also outputs an item name of a command inputted thereto from a touch-to-command converting unit 3 to the output method determining unit 30 when a voice operated input is determined.

When notified that the operation mode is the touch operation one from the input switching control unit 4b, the output method determining unit 30 determines an output method of notifying a user that the input method is a touch operated input (a button color indicating the touch operation mode, a sound effect, a click feeling and a vibrating method of a touch display, or the like), and acquires output data from the output data storage unit 31 as needed and outputs the output data to an output control unit 13b. In contrast, when notified that the operation mode is the voice operation one from the input switching control unit 4b, the output method determining unit 30 determines an output method of notifying a user that the input method is a voice operated input (a button color indicating the voice operation mode, a sound effect, a click feeling and a vibrating method of the touch display, a voice recognition mark, voice guidance, or the like), and acquires output data corresponding to the item name of this voice operation from the output data storage unit 31 and outputs the output data to the output control unit 13b.

The output data storage unit 31 stores data used for notifying whether an input method is a touch operated input or a voice operated input to a user. For example, the data include data about the sound effect for making it possible for a user to identify whether the operation mode is the touch operation one or the voice operation one, image data about the voice recognition mark for notifying the voice operation mode, and data about the voice guidance for urging a user to utter a voice recognition keyword corresponding to a button (item name) which the user has touched. Although the output data storage unit 31 is disposed separately in the illustrated example, another storage unit can also be used as the output data storage unit. For example, a state transition table storage unit 6 or a data storage unit 12 can store the output data.

When producing a screen display of the results of execution by an application executing unit 11 on the touch display, or when outputting a voice message from a speaker, the output control unit 13b changes the button color, changes the click feeling of the touch display, changes the vibrating method, or outputs the voice guidance on the basis of whether the operation mode is the touch operation one or the voice operation one according to the output method inputted thereto from the input switching control unit 4b. The output method can be one of these different methods or can be a combination of two or more arbitrarily selected from them.

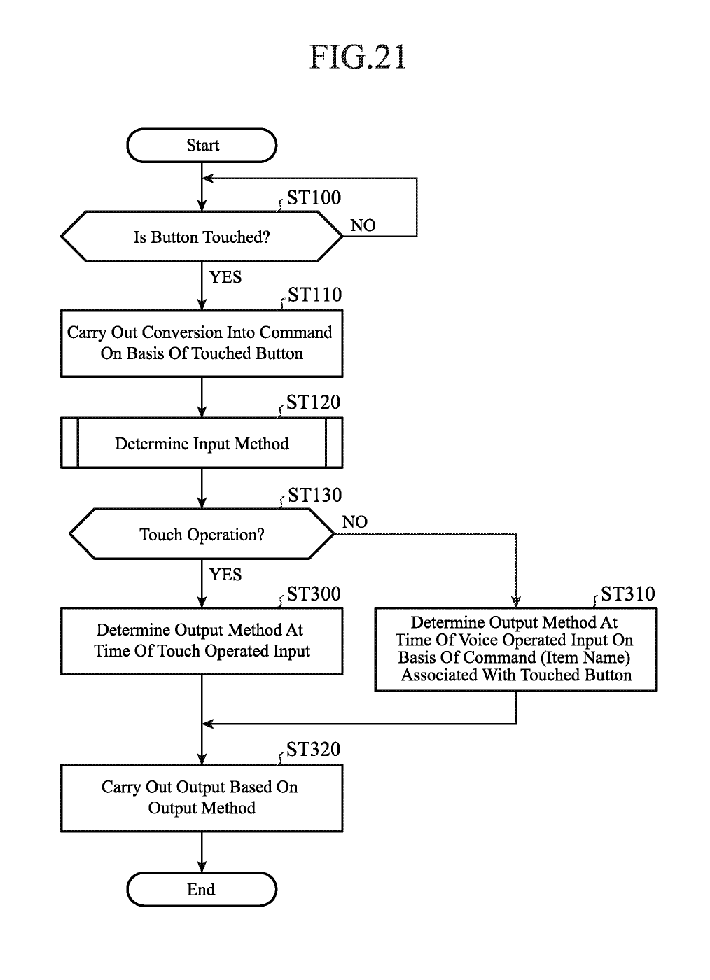

Next, the operation of the vehicle-mounted information device will be explained. FIG. 21 is a flow chart showing an operation of controlling the output method of the vehicle-mounted information device in accordance with Embodiment 3. Because processes in steps ST100 to ST130 of FIG. 21 are the same as those in steps ST100 to ST130 of FIG. 2, the explanation of the processes will be omitted hereafter. When the result of the determination of the input method indicates a touch operation (when “YES” in step ST130), the input switching control unit 4b notifies the output method determining unit 30 to that effect. The output method determining unit 30, in next step ST300, receives the notification that the input method is a touch operated input from the input switching control unit 4b, and determines the output method of outputting the result of the execution of an application. For example, the vehicle-mounted information device changes the color of each button in the screen to a button color for touch operations or changes a sound effect, a click feeling, and a vibration each of which is generated when a user touches the touch display to those for touch operations.

In contrast, when the result of the determination of the input method indicates a voice operation (when “NO” in step ST130), the input switching control unit 4b notifies the output method determining unit 30 that the input method is a voice operated input and of the command (item name). The output method determining unit 30, in next step ST310, receives the notification that the input method is a voice operated input from the input switching control unit 4b, and determines the output method of outputting the result of the execution of the application. For example, the vehicle-mounted information device changes the color of each button in the screen to a button color for voice operations or changes the sound effect, the click feeling, and the vibration each of which is generated when a user touches the touch display to those for voice operations. Further, the output method determining unit 30 acquires voice guidance data on the basis of the item name of the button which has been touched at the time of the determination of the input method from the output data storage unit 31.

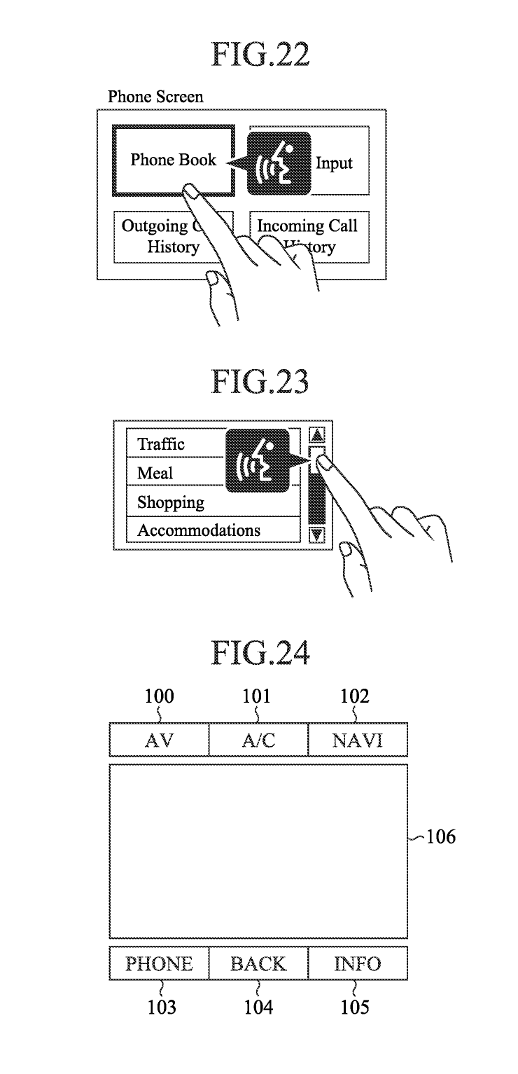

The output control unit 13b, in next step ST320, produces a display or outputs a voice message, a click, a vibration, or the like according to a command from the output method determining unit 30. Hereafter, a concrete example of the output will be explained. FIG. 22 shows a phone screen at a time when it is determined that the input method is a voice operated input. It is assumed that a user touches a “Phone Book” button for a fixed time period while this phone screen is displayed. In this case, the output method determining unit 30 receives the notification that the input method is a voice operated input from the input switching control unit 4b, and also receives an item name (phone book). The output method determining unit 30 then acquires data about the voice recognition mark from the output data storage unit 31, and outputs a command for displaying the voice recognition mark in the vicinity of the “Phone Book” button to the output control unit 13b. The output control unit 13b then generates a screen in which the voice recognition mark is superimposed on the phone screen and arranged in the vicinity of the phone book button in such a way that the voice recognition mark comes out of the “Phone Book” button which the user has touched, and outputs the screen to the touch display. As a result, the vehicle-mounted information device can intelligibly present the user with a notification that the vehicle-mounted information device is in a state in which the vehicle-mounted information device has switched to a voice operated input, and whether the vehicle-mounted information device is in a state in which the user is allowed to perform a voice operation associated with which button. The user is enabled to cause the vehicle-mounted information device to display a phone book screen in a lower layer with a call function by simply uttering “ [symbol] (Yamada)◯◯” in this state.

For example, in the example shown in FIG. 22, the output method determining unit 30 which receives the notification that the input method is a voice operated input acquires data about voice guidance “Who would you like to phone?” stored while being linked to the item name (phone book) from the output data storage unit 31, and outputs the data to the output control unit 13b. The output control unit 13b then outputs this voice guidance data to the speaker. As an alternative, for example, it is assumed that the user touches a button “Search For Surrounding Facilities” for a fixed time period in a navi menu screen P32 shown in FIG. 11A. In this case, the output method determining unit 30 receives the notification that the input method is a voice operated input from the input switching control unit 4b, and also receives an item name (search for surrounding facilities). The output method determining unit 30 then acquires voice guidance data, such as “Which facility are you going to?” or “Please speak a facility name,” which is linked to this item name from the output data storage unit 31, and outputs the voice guidance data to the output control unit 13b. As a result, the vehicle-mounted information device can guide the user to a voice operated input more naturally while inquiring of the user about what the user should utter according to the button touched by using the voice guidance. This voice guidance has easy-to-understand descriptions as compared with voice guidance “Please speak when a beep is heard” which is outputted when an utterance button is pressed, such as voice guidance used when a typical voice operated input is performed.

Although the example of applying the output method determining unit 30 and the output data storage unit 31 to the vehicle-mounted information device in accordance with Embodiment 1 is explained in the above-mentioned explanation, it is needless to say that the output method determining unit 30 and the output data storage unit 31 can be applied to the vehicle-mounted information device in accordance with Embodiment 2. FIG. 23 is an example of a list screen at the time of a voice operated input. In Embodiment 2, the vehicle-mounted information device switches to a voice operated input when a user touches a scroll bar for a fixed time period. In this case, the output method determining unit 30 carries out control in such a way that the voice recognition mark is superimposed and arranged in the vicinity of the scroll bar in the list screen, and notifies the user that the vehicle-mounted information device is in a state in which the vehicle-mounted information device receives a voice operated input.

As mentioned above, the vehicle-mounted information device according to Embodiment 3 is constructed in such a way that the vehicle-mounted information device includes the output method determining unit 30 for receiving an indication of the touch operation mode or the voice operation mode from the input switching control unit 4b to determine the output method of outputting the result of execution which the output unit uses according to the indicated mode, and the output control unit 13b controls the output unit according to the output method which the output method determining unit 30 determines. Therefore, the vehicle-mounted information device can intuitively notify the user about in which operation mode state the vehicle-mounted information device is placed by returning a feedback different according to whether the operation mode is the touch operation one or the voice operation one.

Further, the vehicle-mounted information device according to Embodiment 3 is constructed in such away that the vehicle-mounted information device includes the output data storage unit 31 for storing data about voice guidance for each command (item name), the voice guidance urging a user to utter a voice recognition keyword brought into correspondence with a command (item value), and the output method determining unit 30 acquires data about voice guidance corresponding to a command which the touch-to-command converting unit 3 generates from the output data storage unit 31 and outputs the data to the output control unit 13b when receiving an indication of the voice operation mode from the input switching control unit 4b, and the output control unit 13b causes the output unit to output the data about the voice guidance which the output method determining unit 30 outputs. Therefore, the vehicle-mounted information device can output voice guidance matching a button on which a touch operation is performed when placed in the voice operation mode, and can guide the user so that the user can naturally utter a voice recognition keyword.

Although the applications are explained in above-mentioned Embodiments 1 to 3 by taking the AV function, the phone function, and the navigation function as examples, it is needless to say that the embodiments can be applied to applications for performing functions other than these functions. For example, in the case of FIG. 1, the vehicle-mounted information device can receive an input of a command for operating or stopping a vehicle-mounted air conditioner, a command for increasing or decreasing a preset temperature, or the like, and can control the air conditioner by using data about an air conditioning function stored in the data storage unit 12. Further, a user's favorite URLs can be stored in the data storage unit 12, and the vehicle-mounted information device can receive an input of a command for acquiring data about a URL via the network 14 and displaying the data, and can produce a screen display of the data. In addition, the embodiments can be applied to applications for performing functions other than these functions.

Further, although the vehicle-mounted information device is explained as an example, the embodiments are not limited to the vehicle-mounted information device. The embodiments can be applied to a user interface device of a mobile terminal, such as a PND (Portable/Personal Navigation Device) or a smart phone, which a user can carry onto a vehicle. In addition, the embodiments can be applied not only to a user interface device for vehicles, but also to a user interface device for equipment such as a home appliance.

Further, in a case in which this user interface device is constructed of a computer, an information processing program in which the processes carried out by the touch input detecting unit 1, the input method determining unit 2, the touch-to-command converting unit 3, the input switching control unit 4, the state transition control unit 5, the state transition table storage unit 6, the voice recognition dictionary DB 7, the voice recognition dictionary switching unit 8, the voice recognition unit 9, the voice-to-command converting unit 10, the application executing unit 11, the data storage unit 12, the output control unit 13, the voice recognition target word dictionary generating unit 20, the output method determining unit 30, and the output data storage unit 31 are described can be stored in a memory of the computer, and a CPU of the computer can be made to execute the information processing program stored in the memory.

### Embodiment 4

Although the vehicle-mounted information device according to any one of above-mentioned Embodiments 1 to 3 is constructed in such a way as to switch between the touch operation mode (execution of a button function) and the voice operation mode (start of voice recognition associated with a button) according to the state (short press, long press, or the like) of a touch operation on a button (and a list, a scroll bar, etc.) displayed on the touch display, the vehicle-mounted information device can switch between the touch operation mode and the voice operation mode not only according to the state of a touch operation on a button displayed on the touch display, but also according to the state of a touch operation on an input device, such as a mechanical hard button. Therefore, in this Embodiment 4 and in Embodiments 5 to 10 which will be mentioned below, an information device that switches between operation modes according to the state of a touch operation on an input device, such as a hard button, will be explained.

Because a vehicle-mounted information device in accordance with this Embodiment 4 has the same structure as the vehicle-mounted information device shown in FIG. 1, 12, or 20 from a graphical viewpoint, the vehicle-mounted information device in accordance with this Embodiment 4 will be explained hereafter by using FIGS. 1, 12, and 20. Although the vehicle-mounted information device according to any one of above-mentioned Embodiments 1 to 3 uses a touch display as an input device, one of the following examples (1) to (6) is used as an example of the input device hereafter.

(1) An example of combining hard buttons and a touch display

(2) An example of combining hard buttons and a display

(3) An example of using only hard buttons respectively corresponding to display items on a display

(4) An example of combining a display and a hard device for cursor operation, such as a joystick

(5) An example of combining a display and a touchpad

(6) An example of using only hard buttons

Hard buttons are mechanical physical buttons, and include rubber buttons disposed on a remote controller (referred to as a remote control from here on) and sheet keys used for slim mobile phones. The details of a hard device for cursor operation will be mentioned below.

In the case of a hard button, a touch input detecting unit 1 of the vehicle-mounted information device detects how the hard button is pressed by a user, and an input method determining unit 2 determines whether an input method is either one of two operation modes. For example, in the case of a hard button without a tactile sensor, the input method determining unit can determine the input method by determining whether the hard button is short or long pressed or by determining whether the hard button is pressed once or twice. In the case of a hard button with a tactile sensor, the input method determining unit can determine the input method by determining whether the user has touched or pressed the hard button. In the case of a hard button that makes it possible to detect a half-way press thereof (e.g., a shutter release button of a camera), the input method determining unit can determine the input method by determining whether the hard button is pressed half way or full way. By thus enabling a user to properly use two types of touch operations for one hard button, the vehicle-mounted information device can determine whether the user is trying to perform an input by performing which one of a touch operation and a voice operation on the hard button.

Hereafter, a concrete example will be explained.

(1) The Example of Combining Hard Buttons and a Touch Display

FIG. 24 is a diagram showing an example of the structure of the hard buttons 100 to 105 and the touch display 106 which the vehicle-mounted information device includes (or which are connected to the vehicle-mounted information device). In this example, the hard buttons 100 to 105 are disposed around the touch display 106, and the item name of a function executable by an application executing unit 11 and existing in a higher layer is associated with each of the hard buttons 100 to 105. In this example, when one of the hard buttons 100 to 105 is short pressed, the input method determining unit determines that the operation mode is the touch operation one, whereas when one of the hard buttons 100 to 105 is long pressed, the input method determining unit determines that the operation mode is the voice operation one.

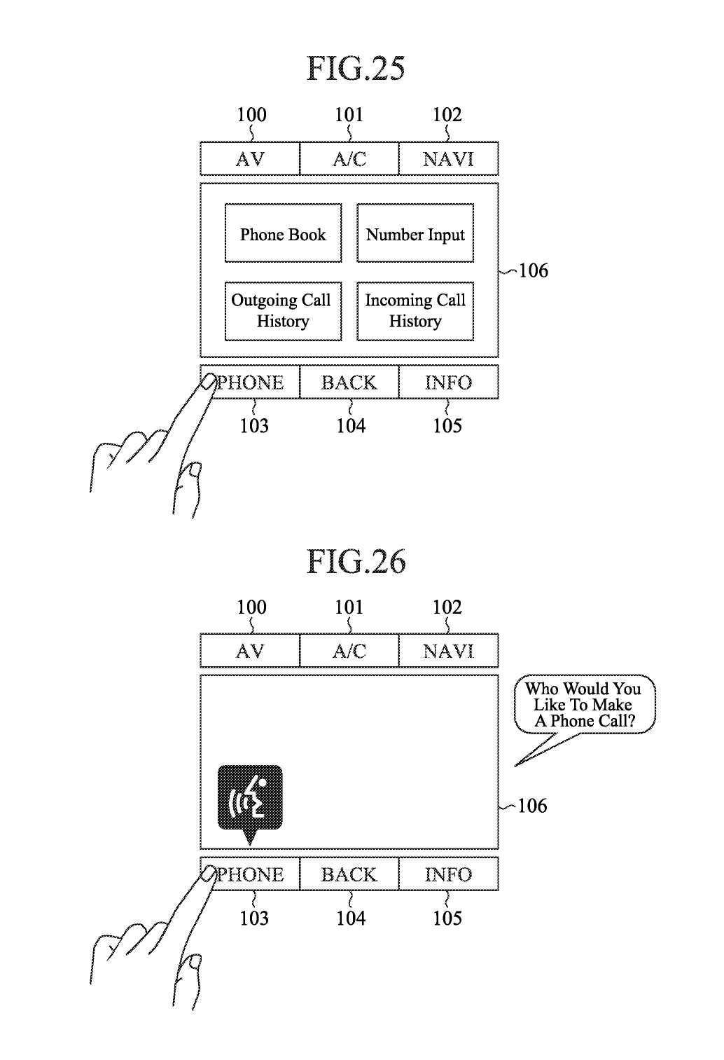

As shown in FIG. 25, when the “PHONE” hard button 103 is short pressed, the touch input detecting unit 1 detects this short press and outputs a touch signal. A touch-to-command converting unit 3 converts the touch signal into a command (PHONE, PHONE). Further, the input method determining unit 2 determines that the input method is the touch operation mode on the basis of the touch signal, and a state transition control unit 5 which receives this determination converts the command (PHONE, PHONE) into an application execution command and outputs the application execution command to an application executing unit 11. The application executing unit 11 displays a PHONE menu on the touch display 106 according to the application execution command. A “Phone Book” button, a “Number Input” button, etc. are displayed on the PHONE menu screen, and functions existing in a layer one level lower than that of the PHONE menu, such as a phone book and a number input, are associated with the buttons respectively. A user operates these buttons by using the touch display 106.

In contrast, as shown in FIG. 26, when the “PHONE” hard button 103 is long pressed, the input method determining unit 2 determines that the input method is the voice operation mode on the basis of the touch signal, and the vehicle-mounted information device outputs the item name (PHONE) of the command from an input switching control unit 4 to a voice recognition dictionary switching unit 8 to switch to a voice recognition dictionary associated with PHONE. A voice recognition unit 9 then carries out a voice recognition process by using the voice recognition dictionary associated with PHONE, and detects the user's voice operated input operation of uttering after performing the touch operation on the hard button 103. A voice-to-command converting unit 10 converts the result of the voice recognition by the voice recognition unit 9 into a command (item value) and outputs this command to the state transition control unit 5, and the application executing unit 11 performs a search for the phone number matching the item value.

The vehicle-mounted information device can be constructed, as shown in FIG. 20, in such a way as to output a sound effect, a display (e.g., a display of a voice recognition mark as shown in FIG. 26) or the like indicating that the operation mode is switched to the voice operation mode. Further, the vehicle-mounted information device can provide voice guidance for urging the user to utter (e.g., a voice saying “Who would you like to phone?”), or display a document for urging the user to utter.

As mentioned above, the vehicle-mounted information device according to Embodiment 4 is constructed in such a way as to include: the touch input detecting unit 1 for detecting a touch operation on the basis of the output signal of each of the hard buttons 100 to 105; the touch-to-command converting unit 3 for generating a command (item name, item value) including an item name for performing a process corresponding to one of the hard buttons 100 to 105 on which a touch operation is performed on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the touch display 106, for outputting the result of the execution by the application executing unit 11. Therefore, because the vehicle-mounted information device determines whether the operation mode is the touch operation one or the voice operation one according to the state of a touch operation on a hard button, the vehicle-mounted information device enables a user to operate one hard button to switch between a general touch operation and a voice operation associated with the hard button and perform an input. Further, the vehicle-mounted information device provides the same advantages as those provided by above-mentioned Embodiments 1 to 3.

### Embodiment 5

Because a vehicle-mounted information device in accordance with this Embodiment 5 has the same structure as the vehicle-mounted information device shown in FIG. 1, 12, or 20 from a graphical viewpoint, an explanation will be made hereafter by using FIGS. 1, 12, and 20.

(2) An Example of a Combination of Hard Buttons and a Display

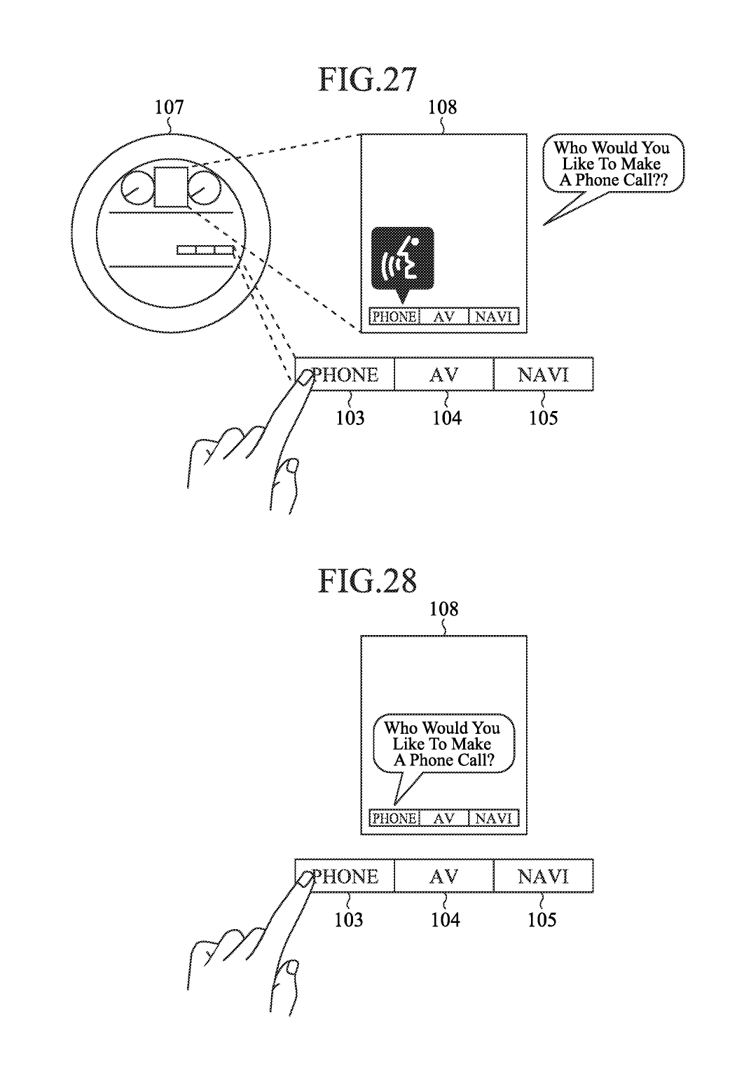

FIG. 27 shows an example of the structure of the hard buttons 103 to 105 and the display 108 which the vehicle-mounted information device includes (or which are connected to the vehicle-mounted information device), and it is assumed hereafter that these display 108 and hard buttons 103 to 105 are mounted in the vicinity of the steering wheel 107 of a vehicle. The item names of the hard buttons 103 to 105 are displayed on the display 108. The display 108 and the hard buttons 103 to 105 can be placed anywhere. In this example, when one of the hard buttons 103 to 105 is short pressed, the vehicle-mounted information device determines that an operation mode is a touch operation one, whereas when one of the hard buttons is long pressed, the vehicle-mounted information device determines that the operation mode is a voice operation one.

When the “PHONE” hard button 103 is short pressed, a touch input detecting unit 1 detects this short press and outputs a touch signal. A touch-to-command converting unit 3 converts the touch signal into a command (PHONE, PHONE). Further, an input method determining unit 2 determines that an input method is the touch operation mode on the basis of the touch signal, and a state transition control unit 5 which receives this determination converts the command (PHONE, PHONE) into an application execution command and outputs this application execution command to an application executing unit 11. The application executing unit 11 displays a PHONE menu (e.g., a PHONE menu screen shown in FIG. 25) on the display 108 according to the application execution command. Any operation method of operating the PHONE menu screen can be used. For example, a user should just operate an input device, such as a not-shown joystick or a not-shown rotating dial.

In contrast, when the “PHONE” hard button 103 is long pressed, the input method determining unit 2 determines that the input method is the voice operation mode on the basis of the touch signal, and the vehicle-mounted information device outputs the item name (PHONE) of the command from an input switching control unit 4 to a voice recognition dictionary switching unit 8 to switch to a voice recognition dictionary associated with PHONE. A voice recognition unit 9 then carries out a voice recognition process by using the voice recognition dictionary associated with PHONE, and detects a user's voice operated input operation of uttering after performing the touch operation on the hard button 103. A voice-to-command converting unit 10 converts the result of the voice recognition by the voice recognition unit 9 into a command (item value) and outputs this command to the state transition control unit 5, and the application executing unit 11 performs a search for the phone number matching the item value.

The vehicle-mounted information device can be constructed, as shown in FIG. 20, in such a way as to output a sound effect, a display (e.g., a display of a voice recognition mark as shown in FIG. 27) or the like indicating that the operation mode is switched to the voice operation mode, or output voice guidance for urging the user to utter (e.g., a voice saying “Who would you like to phone?”). As an alternative, the vehicle-mounted information device can display a document, as shown in FIG. 28, for urging the user to utter on the display 108.

As mentioned above, the vehicle-mounted information device according to Embodiment 5 is constructed in such a way as to include: the touch input detecting unit 1 for detecting a touch operation on the basis of the output signal of each of the hard buttons 103 to 105; the touch-to-command converting unit 3 for generating a command (item name, item value) including an item name for performing a process corresponding to one of the hard buttons 103 to 105 on which a touch operation is performed on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the display 108, for outputting the result of the execution by the application executing unit 11. Therefore, because the vehicle-mounted information device determines whether the operation mode is the touch operation one or the voice operation one according to the state of a touch operation on a hard button, the vehicle-mounted information device enables a user to operate one hard button to switch between a general touch operation and a voice operation associated with the hard button and perform an input. Further, the vehicle-mounted information device provides the same advantages as those provided by above-mentioned Embodiments 1 to 3.

### Embodiment 6

Because a vehicle-mounted information device in accordance with this Embodiment 6 has the same structure as the vehicle-mounted information device shown in FIG. 1, 12, or 20 from a graphical viewpoint, an explanation will be made hereafter by using FIGS. 1, 12, and 20.

(3) An Example of Using Only Hard Buttons Respectively Corresponding to Display Items on a Display

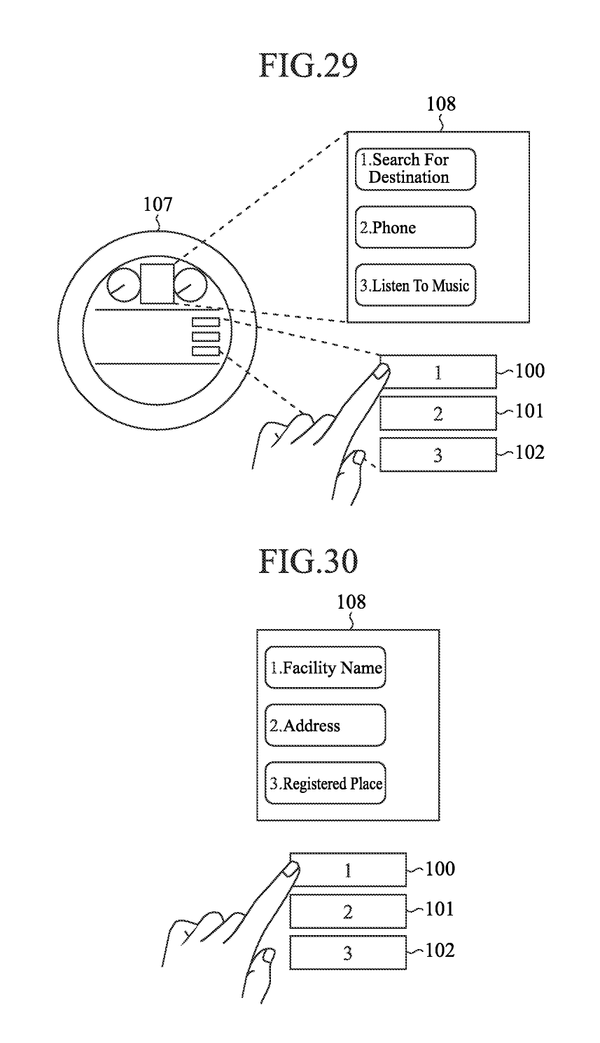

FIG. 29 shows an example of the structure of the hard buttons 100 to 102 and the display 108 which the vehicle-mounted information device includes (or which are connected to the vehicle-mounted information device), and it is assumed hereafter that these display 108 and hard buttons 100 to 102 are mounted in the vicinity of the steering wheel 107 of a vehicle. In this example, when one of the hard buttons 100 to 102 is short pressed, the vehicle-mounted information device determines that an operation mode is a touch operation one whereas when one of the hard buttons is long pressed, the vehicle-mounted information device determines that the operation mode is a voice operation one.

Although a specific function is brought into correspondence with each of the hard buttons 100 to 105 in above-mentioned Embodiments 4 and 5, the function of each of the hard buttons 100 to 102 can be varied in this Embodiment 6, like that of each button on the touch display according to any one of above-mentioned Embodiments 1 to 3. In the example shown in FIG. 29, a function of “searching for a destination”, which is performed in synchronization with the press of the “1” hard button 100, a function of “making a phone call”, which is performed in synchronization with the press of the “2” hard button 101, and a function of enabling a user to “listen to music”, which is performed in synchronization with the press of the “3” hard button 102 are displayed on the screen.

When the “Search For Destination” hard button 100 is short pressed in the example shown in FIG. 29, a touch input detecting unit 1 detects this short press and outputs a touch signal including information about the position of the hard button short pressed. A touch-to-command converting unit 3 generates a command (search for destination, search for destination) on the basis of the information about the position of the hard button. Further, an input method determining unit 2 determines that an input method is the touch operation mode on the basis of the touch signal, and a state transition control unit 5 which receives this determination converts the command (search for destination, search for destination) into an application execution command, and outputs this application execution command to an application executing unit 11. The application executing unit 11 displays a destination setting screen as shown in FIG. 30 on the display 108 according to the application execution command. A function of searching for a “facility name” which is performed in synchronization with the press of the “1” hard button 100, a function of searching for an “address” which is performed in synchronization with the press of the “2” hard button 101, and a function of searching for a “registered place” which is performed in synchronization with the press of the “3” hard button 102 are included in the destination setting screen.

In contrast, when the “Search For Destination” hard button 100 is long pressed in the example shown in FIG. 29, the input method determining unit 2 determines that the input method is the voice operation mode on the basis of the touch signal, and the vehicle-mounted information device outputs the item name (search for destination) of the command from an input switching control unit 4 to a voice recognition dictionary switching unit 8 to switch to a voice recognition dictionary associated with the designation search. A voice recognition unit 9 then carries out a voice recognition process by using the voice recognition dictionary associated with the designation search, and detects a user's voice operated input operation of uttering after performing the touch operation on the hard button 100. A voice-to-command converting unit 10 converts the result of the voice recognition by the voice recognition unit 9 into a command (item value) and outputs this command to the state transition control unit 5, and the application executing unit 11 performs a search with the item value being set as a destination.

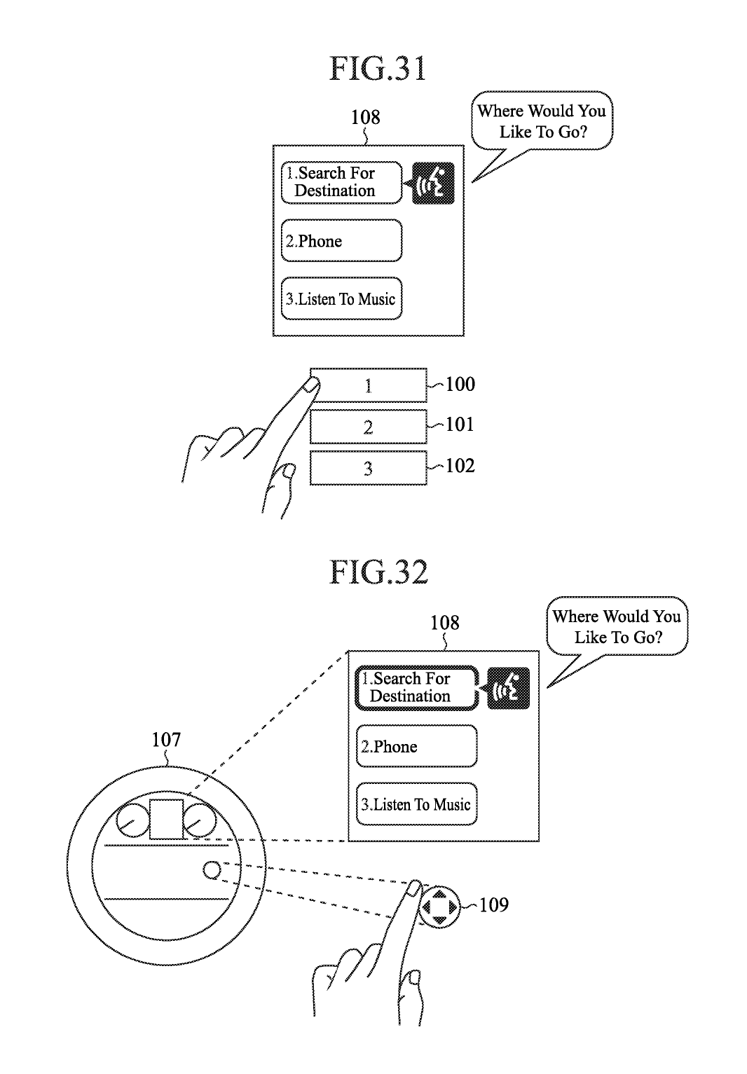

The vehicle-mounted information device can be constructed, as shown in FIG. 20, in such a way as to output a sound effect, a display (e.g., a display of a voice recognition mark as shown in FIG. 31) or the like indicating that the operation mode is switched to the voice operation mode. As an alternative, the vehicle-mounted information device can output voice guidance for urging the user to utter (e.g., a voice saying “Where would you like to go?”) or display a document for urging the user to utter.

As mentioned above, the vehicle-mounted information device according to Embodiment 6 is constructed in such a way as to include: the touch input detecting unit 1 for detecting a touch operation on the basis of the output signal of each of the hard buttons 100 to 102; the touch-to-command converting unit 3 for generating a command (item name, item value) including an item name for performing a process (either or both of a transition destination screen and an application execution function) corresponding to one of the hard buttons 100 to 102 on which a touch operation is performed on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the display 108, for outputting the result of the execution by the application executing unit 11. Therefore, because the vehicle-mounted information device determines whether the operation mode is the touch operation one or the voice operation one according to the state of a touch operation on a hard button corresponding to an item displayed on the display, the vehicle-mounted information device enables a user to operate one hard button to switch between a general touch operation and a voice operation associated with the hard button and perform an input. Further, although the hard buttons and the functions are fixed in above-mentioned Embodiments 4 and 5, the user is enabled to switch between the touch operation mode and the voice operation mode on various screens to perform an input because the correspondence between the hard buttons and the functions can be varied in this Embodiment 6. In addition, the user is enabled to perform a voice input in the voice operation mode even in a stage in any layer to which the vehicle-mounted information device has descended from a layer.

### Embodiment 7

Because a vehicle-mounted information device in accordance with this Embodiment 7 has the same structure as the vehicle-mounted information device shown in FIG. 1, 12, or 20 from a graphical viewpoint, an explanation will be made hereafter by using FIGS. 1, 12, and 20.

(4) An Example of a Combination of a Display and a Hard Device for Cursor Operation, Such as a Joystick

FIG. 32 shows an example of the structure of the display 108 and the joystick 109 which the vehicle-mounted information device includes (or which are connected to the vehicle-mounted information device), and it is assumed hereafter that these display 108 and joystick 109 are mounted in the vicinity of the steering wheel 107 of a vehicle. The display 108 and the joystick 109 can be placed anywhere. Further, although the joystick 109 is illustrated as an example of the hard device for cursor operation, another input device, such as a rotating dial or an up/down selector, can be used. In this example, when the joystick 109 is short pressed, the vehicle-mounted information device determines that an operation mode is a touch operation one whereas when the joystick 109 is long pressed, the vehicle-mounted information device determines that the operation mode is a voice operation one.

A user operates the joystick 109 and then short presses this joystick in a state in which the user puts a cursor on “1. Search For Destination” and selects this item. A touch input detecting unit 1 detects the short press of the joystick 109, and outputs a touch signal including information about the position of the cursor short pressed. A touch-to-command converting unit 3 generates a command (search for destination, search for destination) on the basis of the information about the position of the cursor. Further, an input method determining unit 2 determines that an input method is the touch operation mode on the basis of the touch signal, and a state transition control unit 5 which receives this determination outputs the command (search for destination, search for destination) to an application executing unit 11. The application executing unit 11 displays a destination setting screen (e.g., a destination setting screen shown in FIG. 30) on the display 108 according to the application execution command.

In contrast, when the joystick 109 is long pressed in a state in which the cursor is put on “1. Search For Destination” and this item is selected, the input method determining unit 2 determines that the input method is the voice operation mode on the basis of the touch signal, and the vehicle-mounted information device outputs the item name (search for destination) of the command from an input switching control unit 4 to a voice recognition dictionary switching unit 8 to switch to a voice recognition dictionary associated with the destination search. A voice recognition unit 9 then carries out a voice recognition process by using the voice recognition dictionary associated with the destination search, and detects a user's voice operated input operation of uttering after performing the touch operation on the joystick 109. A voice-to-command converting unit 10 converts the result of the voice recognition by the voice recognition unit 9 into a command (item value) and outputs this command to the state transition control unit 5, and the application executing unit 11 performs a search with the item value being set as a destination.

The vehicle-mounted information device can be constructed, as shown in FIG. 20, in such a way as to output a sound effect, a display (e.g., a display of a voice recognition mark as shown in FIG. 32) or the like indicating that the operation mode is switched to the voice operation mode. As an alternative, the vehicle-mounted information device can output voice guidance for urging the user to utter (e.g., a voice saying “Where would you like to go?”).

As mentioned above, the vehicle-mounted information device according to Embodiment 7 is constructed in such a way as to include: the touch input detecting unit 1 for detecting a touch operation on the basis of the output signal of the joystick 109; the touch-to-command converting unit 3 for generating a command (item name, item value) including an item name for performing a process being selected by the joystick 109 (either or both of a transition destination screen and an application execution function) on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the display 108, for outputting the result of the execution by the application executing unit 11. Therefore, because the vehicle-mounted information device determines whether the operation mode is the touch operation one or the voice operation one according to the state of a touch operation on an input device, such as a rotating dial, for selecting an item displayed on the display, the vehicle-mounted information device enables a user to operate one hard button to switch between a general touch operation and a voice operation associated with the hard button and perform an input. Further, although the hard buttons and the functions are fixed in above-mentioned Embodiments 4 and 5, the user is enabled to switch between the touch operation mode and the voice operation mode on various screens to perform an input because the correspondence between the hard buttons and the functions can be varied in this Embodiment 7. In addition, the user is enabled to perform a voice input in the voice operation mode even in a stage in any layer to which the vehicle-mounted information device has descended from a layer.

### Embodiment 8

Because a vehicle-mounted information device in accordance with this Embodiment 8 has the same structure as the vehicle-mounted information device shown in FIG. 1, 12, or 20 from a graphical viewpoint, an explanation will be made hereafter by using FIGS. 1, 12, and 20.

(5) An Example of a Combination of a Display and a Touchpad

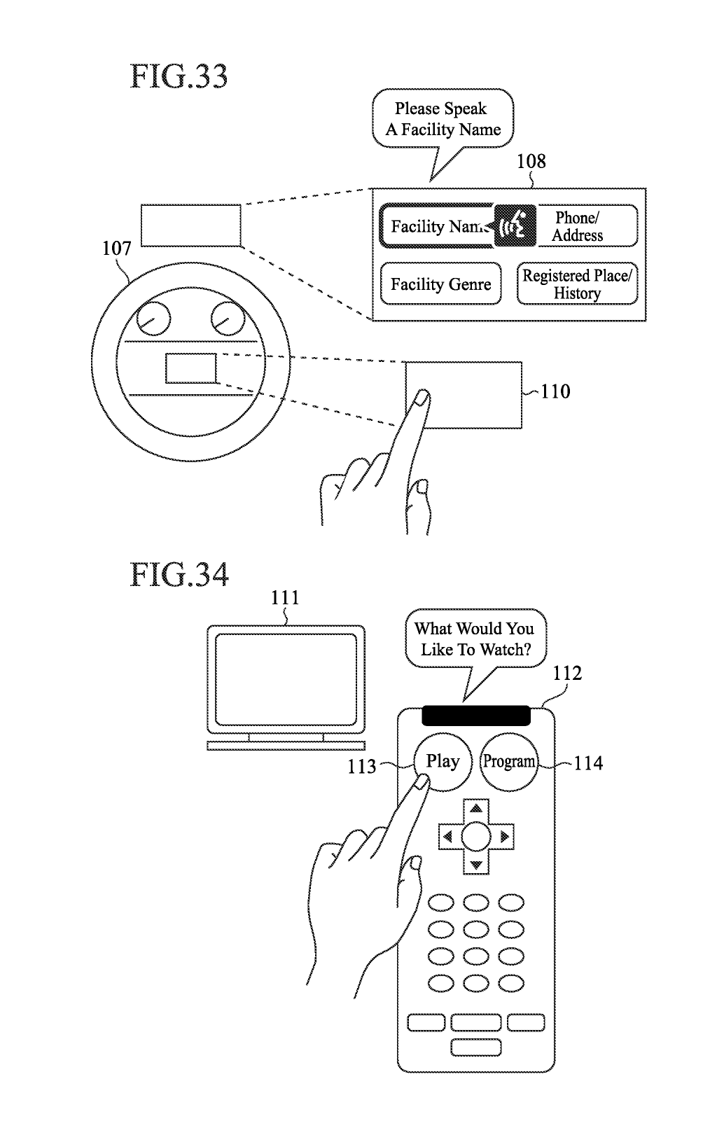

FIG. 33 shows an example of the structure of the display 108 and the touchpad 110 which the vehicle-mounted information device includes (or which are connected to the vehicle-mounted information device), and it is assumed hereafter that these display 108 and touchpad 110 are mounted in the vicinity of the steering wheel 107 of a vehicle. The display 108 and the touchpad 110 can be placed anywhere. In a case in which the touchpad 110 can detect the pressure of a press thereof, the vehicle-mounted information device determines an input method by determining either whether the touchpad is touched or pressed or whether the touchpad is pressed half way or full way. Even in a case in which the touchpad cannot detect the pressure of a press thereof, the vehicle-mounted information device can determine the input method according to a variation in the touch operation, such as a finger drag, a tap, or a long press. In this example, when the touchpad is strongly pressed, the vehicle-mounted information device determines that an operation mode is a touch operation one whereas when the touchpad is long pressed, the vehicle-mounted information device determines that the operation mode is a voice operation one.

A user drags his or her finger on the touchpad 110 to put a cursor on “Facility Name” and then strongly presses this cursor. A touch input detecting unit 1 detects the strong press of the touchpad 110 and outputs a touch signal including information about the position of the cursor strongly pressed. A touch-to-command converting unit 3 generates a command (facility name, facility name) on the basis of the information about the position of the cursor. Further, an input method determining unit 2 determines that the input method is the touch operation mode on the basis of the touch signal, and a state transition control unit 5 which receives this determination converts the command (facility name, facility name) into an application execution command, and outputs this application execution command to an application executing unit 11. The application executing unit 11 displays a facility name input screen on the display 108 according to the application execution command.

In contrast, when the touchpad 110 is long pressed in a state in which the cursor is put on “Facility Name,” the input method determining unit 2 determines that the input method is the voice operation mode on the basis of the touch signal, and the vehicle-mounted information device outputs the item name (facility name) of the command from an input switching control unit 4 to a voice recognition dictionary switching unit 8 to switch to a voice recognition dictionary associated with the facility name search. A voice recognition unit 9 then carries out a voice recognition process by using the voice recognition dictionary associated with the facility name search, and detects a user's voice operated input operation of uttering after performing the touch operation on the touchpad 110. A voice-to-command converting unit 10 converts the result of the voice recognition by the voice recognition unit 9 into a command (item value) and outputs this command to the state transition control unit 5, and the application executing unit 11 searches for a facility name matching the item value.

The vehicle-mounted information device can be constructed, as shown in FIG. 20, in such a way as to output a sound effect, a display (e.g., a display of a voice recognition mark as shown in FIG. 33) or the like indicating that the operation mode is switched to the voice operation mode. As an alternative, the vehicle-mounted information device can output voice guidance for urging the user to utter (e.g., a voice saying “Please speak a facility name”) or display a document for urging the user to utter.

As mentioned above, the vehicle-mounted information device according to Embodiment 8 is constructed in such a way as to include: the touch input detecting unit 1 for detecting a touch operation on the basis of the output signal of the touchpad 110; the touch-to-command converting unit 3 for generating a command (item name, item value) including an item name for performing a process being selected by the touchpad 110 (either or both of a transition destination screen and an application execution function) on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the display 108, for outputting the result of the execution by the application executing unit 11. Therefore, because the vehicle-mounted information device determines whether the operation mode is the touch operation one or the voice operation one according to the state of a touch operation on the touchpad for selecting an item displayed on the display, the vehicle-mounted information device enables a user to operate one hard button to switch between a general touch operation and a voice operation associated with the hard button and perform an input. Further, although the hard buttons and the functions are fixed in above-mentioned Embodiments 4 and 5, the user is enabled to switch between the touch operation mode and the voice operation mode on various screens to perform an input because the correspondence between the hard buttons and the functions can be varied in this Embodiment 8. In addition, the user is enabled to perform a voice input in the voice operation mode even in a stage in any layer to which the vehicle-mounted information device has descended from a layer.

### Embodiment 9

In above-mentioned Embodiments 4 to 8, the example of applying the information device shown in FIG. 1, 12, or 20 to the vehicle-mounted information device is shown. In contrast, in this Embodiment 9, an example of applying the information device to a user interface device, such as a home appliance, will be explained.

(6) An Example of Using Only Hard Buttons

FIG. 34 is a diagram showing an example of the structure of a TV 111 equipped with a recording function, and a remote control 112 for operating the TV. In this Embodiment 9, the information device shown in FIG. 1, 12, or 20 is applied to a user interface device between the TV 111 and the remote control 112. In this example, the user interface device determines that an operation mode is a touch operation one when one of a “Play” hard button 113 and a “Program” hard button 114 of the remote control 112 is short pressed, whereas the user interface device determines that the operation mode is a voice operation one when one of the hard buttons is long pressed. The determination of an input method is substantially the same as that shown in any one of above-mentioned Embodiments 4 to 8, the explanation of the determination of the input method will be omitted hereafter.

When a user short presses the “Play” hard button 113 of the remote control 112 in the example shown in FIG. 34, the remote control 112 switches the input to the touch operation mode, and outputs an application execution command (for displaying a play list of recorded programs) corresponding to a command (play, play) to the TV 111. The TV 111 displays the play list of recorded programs on a display according to this application execution command.

In contrast, when a user utters “sky wars” while long pressing the “Play” hard button 113 of the remote control 112, the remote control 112 switches the input to the voice operation mode and carries out a voice recognition process by using a voice recognition dictionary associated with the item name (play) of the command (including words, such as program names included in the play list, for example), and outputs an application execution command (for playing the program specified by the command item value) corresponding to the command (play, sky wars) to the TV 111. The TV 111 selects “sky wars” from the recorded programs, and plays and displays the program on the display according to this application execution command.

The user interface device which is applied to the TV 111 and the remote control 112 can be constructed, as shown in FIG. 20, in such a way as to output a sound effect or the like indicating that the operation mode is switched to the voice operation mode. As an alternative, the user interface device can output voice guidance for urging the user to utter (e.g., a voice saying “What recorded program would you like to watch?” as shown in FIG. 34, or “Please speak a program which you would like to watch”). As an alternative, the user interface device can notify the TV 111 that the operation mode is switched to the voice operation mode from the remote control 112, and can output a display indicating that the operation mode is switched to the voice operation mode (e.g., a display of a voice recognition mark as shown in FIG. 33) and a document, such as “Please speak a program which you would like to watch,” to the display of the TV 111.

Further, when a user short presses the “Program” hard button 114 of the remote control 112, the remote control 112 switches the input to the touch operation mode, and outputs an application execution command (for displaying a list of programs programmed to be recorded) corresponding to a command (program, program) to TV 111. The TV 111 displays the list of programs programmed to be recorded on the display according to this application execution command.

In contrast, when a user utters “sky wars” while long pressing the “Program” hard button 114 of the remote control 112, the remote control 112 switches the input to voice operation mode, and carries out a voice recognition process by using a voice recognition dictionary associated with the item name (program) of the command (including words like the program names included in the list of programs programmed to be recorded, for example) and outputs an application execution command (for programming to record the program specified by the command item value) corresponding to the command (program, sky wars) to the TV 111. The TV 111 programs to record the program according to this application execution command. The utterance is not limited to a program name, such as “sky wars,” and should just be information necessary for programming, such as “Channel 2 from 8:00 p.m.”

The user interface device which is applied to the TV 111 and the remote control 112 can be constructed, as shown in FIG. 20, in such a way as to output a sound effect or the like indicating that the operation mode is switched to the voice operation mode. As an alternative, the user interface device can output voice guidance for urging the user to utter (e.g., a voice saying “What program would you like to program to record?” or “Please speak a program which you would like to program to record”). As an alternative, the user interface device can notify the TV 111 that the operation mode is switched to the voice operation mode from the remote control 112, and can output a display indicating that the operation mode is switched to the voice operation mode (e.g., a display of a voice recognition mark as shown in FIG. 33) and a document, such as “Please speak a program which you would like to program to record,” to the display of the TV 111. In addition, after completing programming to record a program, the user interface device can output voice guidance or a display of “Programmed to record sky wars” or the like.

Accordingly, even if a user utters the same words in the voice operation mode, the user interface device can change its operation according to a hard button operated by the user.

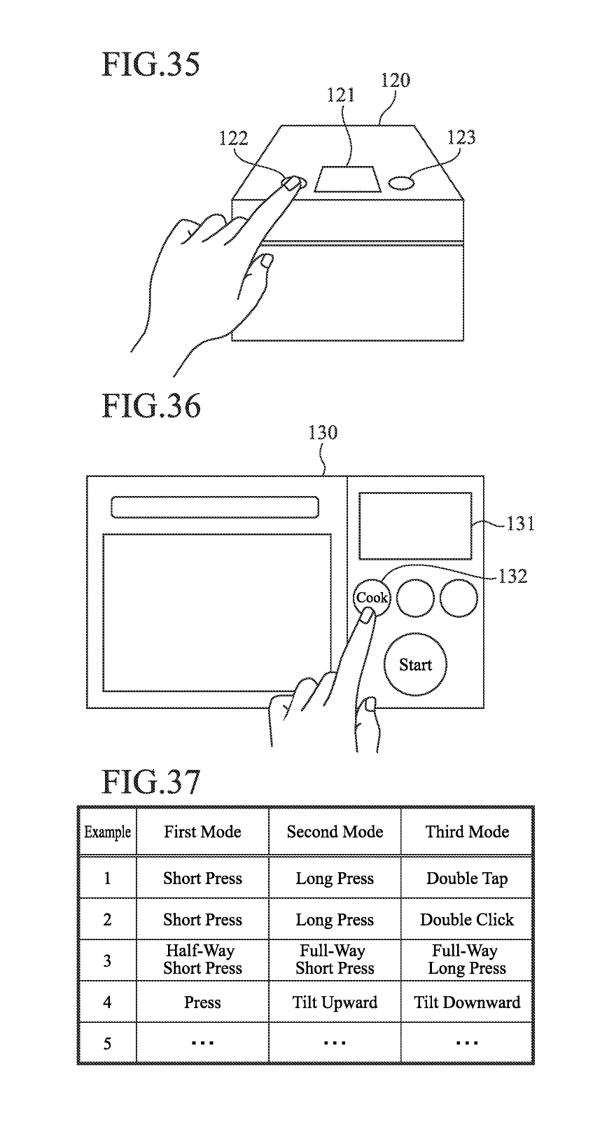

Next, an example of another home appliance will be explained. FIG. 35 is a diagram showing an example of the structure of a rice cooker 120. When a user short presses a “Program” hard button 122 in the example shown in FIG. 35, the rice cooker 120 switches the input to the touch operation mode, and causes the user to program to start cooking by using a screen display on a display 121 and a “Setting” hard button 123 according to an application execution command (for performing a rice cooking programming operation) corresponding to a command (program, program).

In contrast, when the user long presses the “Program” hard button 122, the rice cooker 120 switches the input to the voice operation mode, and carries out a voice recognition process by using a voice recognition dictionary associated with the item name (program) of the command and programs to start cooking according to an application execution command using the user's utterance (e.g., ◯◯:◯◯) as the item value of the command.

The user interface device which is applied to the rice cooker 120 can be constructed, as shown in FIG. 20, in such a way as to output a sound effect or the like indicating that the operation mode is switched to the voice operation mode. As an alternative, the user interface device can output voice guidance for urging the user to utter (e.g., a voice saying “At what time would you like to program to start cooking?”). In addition, after completing programming to start cooking, the user interface device can output voice guidance or a display of “Programmed to start cooking at ◯◯:◯◯” or the like.

As a result, the user does not have to program to start rice cooking on a small-size screen and with a small number of buttons, and can easily program the rice cooker to start rice cooking. Further, even a visually-impaired user is enabled to program the rice cooker.

FIG. 36 is a diagram showing an example of the structure of a microwave oven 130. When a user short presses a “Cook” hard button 132 in the example shown in FIG. 36, the microwave oven 130 switches the input to the touch operation mode and displays a cooking selection menu screen on a display 131 according to an application execution command (for displaying a cooking selection menu screen) corresponding to a command (cook, cook).

In contrast, when the user long presses the “Cook” hard button 132, the microwave oven 130 switches the input to the voice operation mode, and carries out a voice recognition process by using a voice recognition dictionary associated with the item name (cook) of the command and sets the power and the time of the microwave oven 130 to their respective values suitable for chawanmushi (steamed egg custard) according to an application execution command in which the user's utterance is set as the command item value (e.g., chawanmushi).

In another example, the user is enabled to set the power and the time of the microwave oven to their respective values suitable for a menu uttered by the user by uttering “hot sake”, “milk”, or the like while pressing a “Warm” hard button or uttering “dried horse mackerel” or the like while pressing a “Grill” hard button.

The user interface device which is applied to the microwave oven 130 can be constructed, as shown in FIG. 20, in such a way as to output a sound effect or the like indicating that the operation mode is switched to the voice operation mode, or output voice guidance for urging the user to utter (e.g., a voice saying “What would you like to cook?”). As an alternative, the user interface device can output a display indicating that the operation mode is switched to the voice operation mode (e.g., a display of a voice recognition mark as shown in FIG. 33) and a document, such as “What would you like to cook?”, to the display 131. In addition, after the user utters “chawanmushi (steamed egg custard)”, the user interface device can output voice guidance or a display of “Chawanmushi will be cooked,” and can output voice guidance or a display of “Please press the start button” after completing preparations for cooking.

As a result, the user does not have to follow deep layers on a small-size screen by using small-size buttons to search for a cooking menu, and can easily make settings for cooking. Further, the user does not have to search through the operation manual for a cooking menu and to check to see and set the power and the time of the microwave oven.

As mentioned above, the user interface device, such as a home appliance, according to Embodiment 9 is constructed in such a way as to include: the touch input detecting unit 1 for detecting a touch operation on the basis of the output signal of a hard button; the touch-to-command converting unit 3 for generating a command (item name, item value) including an item name for performing a process corresponding to the hard button on which the touch operation is performed (either or both of a transition destination screen and an application execution function) on the basis of the result of the detection by the touch input detecting unit 1; the voice recognition unit 9 for carrying out voice recognition on a user's utterance which is made at substantially the same time when or after the touch operation is performed by using a voice recognition dictionary comprised of voice recognition keywords each brought into correspondence with a process; the voice-to-command converting unit 10 for carrying out conversion into a command (item value) for performing a process corresponding to the result of the voice recognition; the input method determining unit 2 for determining whether the state of the touch operation shows either the touch operation mode or the voice operation mode on the basis of the result of the detection by the touch input detecting unit 1; the input switching control unit 4 for switching between the touch operation mode and the voice operation mode according to the result of the determination by the input method determining unit 2; the state transition control unit 5 for acquiring the command (item name, item value) from the touch-to-command converting unit 3 and converting the command into an application execution command when receiving an indication of the touch operation mode from the input switching control unit 4, and for acquiring the item name from the input switching control unit 4 and the item value from the voice-to-command converting unit 10 and converting the item name and value into an application execution command when receiving an indication of the voice operation mode from the input switching control unit 4; the application executing unit 11 for carrying out the process according to the application execution command; and the output control unit 13 for controlling the output unit, such as the display, for outputting the result of the execution by the application executing unit 11. Therefore, because the user interface device determines whether the operation mode is the touch operation one or the voice operation one according to the state of a touch operation on a hard button, the user interface device enables a user to operate one hard button to switch between a general touch operation and a voice operation associated with the hard button and perform an input. Further, the same advantages as those provided by above-mentioned Embodiments 1 to 3 are provided.

Although the examples of applying the information device (or the user interface device) to the vehicle-mounted information device, the remote control 112, the rice cooker 120, and the microwave oven 130 respectively are explained in above-mentioned Embodiments 1 to 9, the present invention is not limited to these pieces of equipment and can be applied to guide plates disposed in elevator halls, digital direction boards disposed in huge shopping malls, parking space position guide plates disposed in huge parking lots, ticket machines disposed in railroad stations, etc.

For example, in a large office building, it is difficult for the user to know on what floor his or her destination is and which one of the elevators he or she should take. To solve this problem, a guide plate equipped with an input device, such as a touch display or hard buttons, is mounted in a front side area of every elevator hall so as to enable the user to utter his or her destination while long pressing the input device, so that the user can be notified of what floor he or she should go by using which one of the elevators (voice operation mode). Further, the user is enabled to short press the input device so as to display a menu screen, and also operate the screen to search for his or her destination (touch operation mode).

Further, for example, in a huge shopping mall, it is difficult for the user to know where his or her desired store is located and where goods he or she wants to purchase are placed in the store. To solve this problem, digital direction boards each equipped with an input device are disposed in the huge shopping mall so as to enable the user to utter the name of his or her desired store, the names of goods he or she wants to purchase, and so on while long pressing the input device, so that the location of the store can be provided and displayed (voice operation mode). Further, the user is enabled to short press the input device so as to cause the input device to display a menu screen, and also operate the screen to find out what kinds of stores there are and what kinds of goods there are (touch operation mode).

Further, for example, in a huge parking lot or in a huge multi-level car parking tower, it is difficult for the user to know where the user has parked his or her vehicle. To solve this problem, a parking space position guide plate equipped with an input device disposed in an entrance of the huge parking lot so as to enable the user to utter the license plate number of his or her vehicle while long pressing the input device, so that the user can be notified of the position where he or she has parked his or her vehicle (voice operation mode). Further, the user is enabled to short press the input device so as to input the license plate number (touch operation mode)

Further, for example, in a general railroad station yard, the user usually has to perform a troublesome operation of looking at a railroad map displayed above a ticket machine, and pressing a fare button of the ticket machine to purchase a ticket after checking the fee to his or her destination station. To solve this problem, ticket machines each equipped with an input device is disposed so as to enable the user to utter the name of his or her destination station while long pressing a button displayed as “destination” on the ticket machine, so that the fee can be displayed and the user can purchase a ticket without performing any other operation (voice operation mode). Further, the user is enabled to short press a “Destination” button so as to cause the input device to display a screen for searching for the name of his or her destination station or display general fare buttons to also enable the user to purchase a ticket (touch operation mode). This “Destination” button can be displayed on a touch display or can be a hard button.

### Embodiment 10

Although switching between the two modes including the touch operation mode and the voice operation mode is carried out according to the state of a touch operation on one input device, such as a touch display or hard buttons, in above-mentioned Embodiments 1 to 9, switching among three or more modes can be alternatively carried out. More specifically, switching among n types of modes is carried out according to which one of n types of touch operations is performed on one input device.

In this Embodiment 10, an information device that switches among three modes by using one button or one input device will be explained. As examples of switching among the modes, there are an example of switching among a touch operation mode as a first mode, a voice operation mode 1 as a second mode, and a voice operation mode 2 as a third mode, and an example of switching among a touch operation mode 1 as the first mode, a touch operation mode 2 as the second mode, and a voice operation mode as the third mode.

As the input device, a touch display, a touchpad, a hard button, an easy selector, or the like can be used, for example. The easy selector is an input device that enables a user to perform one of the following three operations: press, tilt upward (or rightward), or tilt downward (or leftward) a lever thereof.

As shown in FIG. 37, touch operations are predetermined for the first through third modes respectively. For example, in a case in which the input device is a touch display and in a case in which the input device is a touchpad, the information device determines an input method by determining whether the input device is short pressed, long pressed, or double tapped, as shown in example 1, to determine whether the user desires either one of the first through third modes. In a case in which the input device is a hard button, the information device can determine the input method by determining whether the input device is short pressed, long pressed, or double clicked, as shown in example 2, or determining whether the input device is short pressed half way, short pressed full way, or long pressed full way (or half way), as shown in example 3. In a case in which the input device is an easy selector, the information device determines the input method by determining whether the input device is pressed, tilted upward, or tilted downward, as shown in example 4.

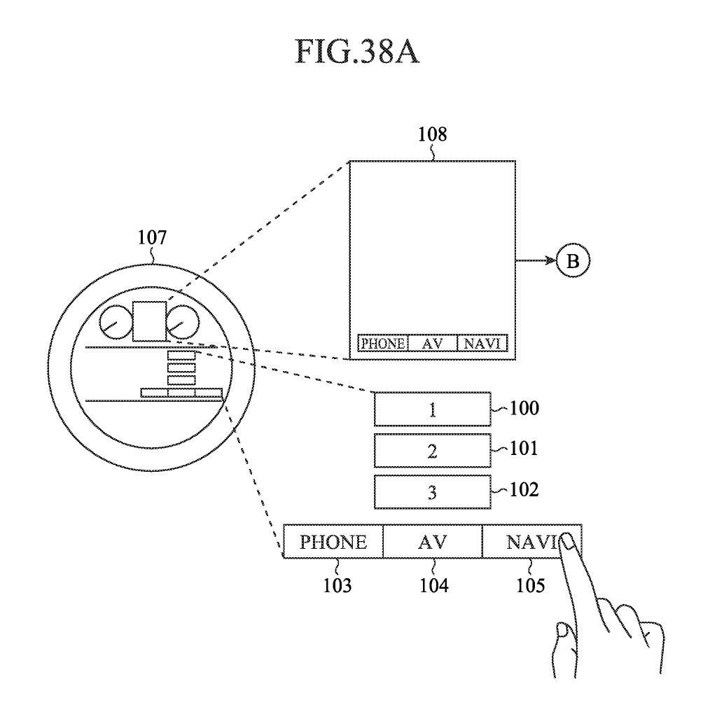

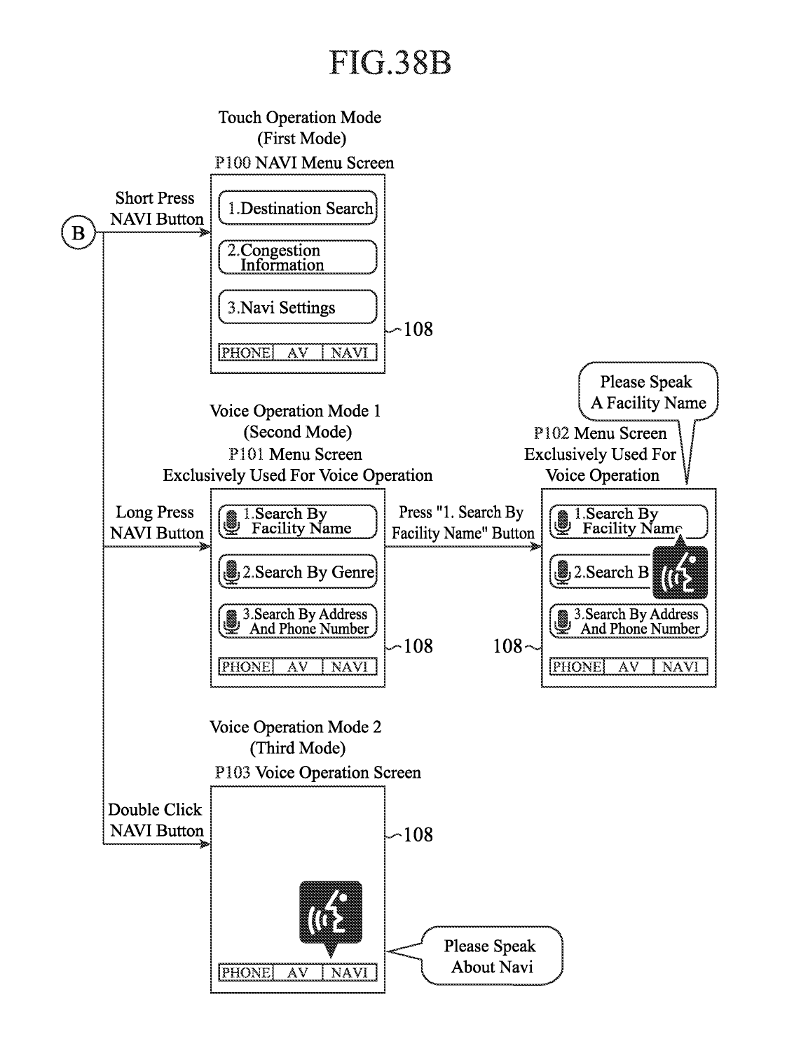

FIG. 38A is a diagram showing an example of the structure of hard buttons 100 to 105 and a display 108 which the vehicle-mounted information device includes (or which are connected to the vehicle-mounted information device). In FIG. 38, the same components as those shown in FIGS. 27 to 31 or like components are designated by the same reference numerals, and the explanation of the components will be omitted hereafter. Further, an example of transitions of screens displayed on the display 108 shown in FIG. 38A is shown in FIG. 38B. In this example, the hard buttons 100 to 105 are used as the input device. Further, when one of the hard buttons 100 to 105 is short pressed, the vehicle-mounted information device determines that the operation mode is the touch operation one, when one of the hard buttons 100 to 105 is long pressed, the vehicle-mounted information device determines that the operation mode is the voice operation mode 1, and when one of the hard buttons 100 to 105 is double clicked, the vehicle-mounted information device determines that the operation mode is the voice operation mode 2. Further, a function to be performed in synchronization with the press of each of the hard buttons 100 to 102 varies from one transition screen to another, while a function is fixed for each of the other hard buttons 103 to 105.

In this Embodiment 10, an input method determining unit 2 determines whether the operation mode is the touch operation mode, the voice operation mode 1, or the voice operation mode 2 on the basis of a touch signal, and notifies the operation mode to a state transition control unit 5 via an input switching control unit 4. A state transition table storage unit 6 stores a state transition table in which a correspondence among the operation modes, commands (item name, item value), and application execution commands is defined. The state transition control unit 5 converts a combination of the result of the determination of the operation mode and a command notified from a touch-to-command converting unit 3 or a voice-to-command converting unit 10 into an application execution command on the basis of the state transition table stored in the state transition table storage unit 6.

More specifically, even the same command item name results in the conversion into an application execution command having descriptions different according to whether the operation mode is the voice operation mode 1 or the voice operation mode 2. For example, even when the command has the same command item name (NAVI) both in the case of the voice operation mode 1 and in the case of the voice operation mode 2, the state transition control unit converts the command into an application execution command for producing a screen display of detailed items of a NAVI function and then accepting an utterance about a detailed item in the case of the voice operation mode 1, whereas the state transition control unit converts the command into an application execution command for accepting an utterance about the entire NAVI function in the case of the voice operation mode 2.

Next, a concrete example of the touch operation mode, the voice operation mode 1, and the voice operation mode 2 will be explained. When the “NAVI” hard button 105 is short pressed in the example shown in FIG. 38A, the touch input detecting unit 1 detects this short press, and the touch-to-command converting unit 3 generates a command (NAVI, NAVI). Further, the input method determining unit 2 determines that the operation mode is the touch operation one, and the state transition control unit 5 which receives this determination converts the command (NAVI, NAVI) into an application execution command and outputs this application execution command to an application executing unit 11. The application executing unit 11 displays a NAVI menu screen P100 on the display 108 according to the application execution command. In this NAVI menu screen P100, a “1. destination search” function which is performed in synchronization with the press of the “1” hard button 100, a “2. congestion information” display function which is performed in synchronization with the press of the “2” hard button 101, and a “3. navi setting” function which is performed in synchronization with the press of the “3” hard button 102 are included.

In contrast, when the “NAVI” hard button 105 is long pressed in the example shown in FIG. 38A, the touch input detecting unit 1 detects this long press, and the touch-to-command converting unit 3 generates a command (NAVI, NAVI). Further, the input method determining unit 2 determines that the operation mode is the voice operation mode 1 and notifies the state transition control unit 5 of the command item name (NAVI) and that the operation mode is the voice operation mode 1 via the input switching control unit 4, and the state transition control unit 5 carries out conversion into an application execution command for displaying a NAVI menu screen P101 exclusively used for voice operation after determining that the operation mode is the voice operation mode 1. The application executing unit 11 displays the menu screen P101 exclusively used for voice operation on the display 108 according to this application execution command. In this menu screen P101 exclusively used for voice operation, a “1. search by facility name” function which is carried out in synchronization with the press of the “1” hard button 100, “2. search by genre” function which is carried out in synchronization with the press of the “2” hard button 101, and “3. search by address and phone number” function which is carried out in synchronization with the press of the “3” hard button 102 are displayed as voice recognition functions for three detailed items.

When the “1” hard button 100 is pressed in the menu screen P101 exclusively used for voice operation, the touch input detecting unit 1 detects this press and the touch-to-command converting unit 3 outputs a command (search by facility name). A voice recognition dictionary switching unit 8 then switches to a voice recognition dictionary associated with the item name (search by facility name) of the command, and a voice recognition unit 9 carries out a voice recognition process on the user's utterance by using this voice recognition dictionary to detect the user's voice operated input operation of uttering after pressing the hard button 100. The voice-to-command converting unit 10 converts the result of the voice recognition by the voice recognition unit 9 into a command (item value), and outputs this command to the state transition control unit 5, and the application executing unit 11 searches for a facility name matching the item value.

At this time, the vehicle-mounted information device can make a screen transition from the menu screen P101 exclusively used for voice operation to a menu screen P102 exclusively used for voice operation, and output a sound effect, a display (a display a voice recognition mark or the like) or the like indicating that the operation mode is switched to the voice operation mode. As an alternative, the vehicle-mounted information device can output voice guidance for urging the user to utter (e.g., a voice saying “Please speak a facility name”), or display a document for urging the user to utter.

A user who becomes acclimated to operating the information device may feel that it is tedious to cause the vehicle-mounted information device to produce a screen display of detailed items in a layer lower than that of the NAVI function and perform an operation every time when operating the vehicle-mounted information device, like in the case of the voice operation mode 1. Further, it can be expected that the user gets on with learning about texts which he or she can utter as a voice operated input by repeatedly performing an operation in the voice operation mode 1. Therefore, in the voice recognition mode 2, the vehicle-mounted information device directly starts a voice recognition process regarding the entire NAVI function to enable the user to start a voice operation immediately.

When the “NAVI” hard button 105 is double clicked in the example shown in FIG. 38A, the touch input detecting unit 1 detects this double click and the touch-to-command converting unit 3 generates a command (NAVI, NAVI). The input method determining unit 2 determines that the operation mode is the voice operation mode 2 and notifies the state transition control unit 5 of the command item name (NAVI) and that the operation mode is the voice operation mode 2 via the input switching control unit 4. At the time of the voice operation mode 2, the state transition control unit 5 stands by until the item value of the command is inputted thereto from the voice-to-command converting unit 10. Further, when the item name (NAVI) of the command is inputted to the state transition control unit 5 via the input switching control unit 4, the voice recognition dictionary switching unit 8 switches to a voice recognition dictionary associated with NAVI and the voice recognition unit carries out a voice recognition process on the user's utterance by using this voice recognition dictionary. The voice-to-command converting unit 10 converts the result of the voice recognition by the voice recognition unit 9 into a command (item value), and outputs this command to the state transition control unit 5, and the state transition control unit 5 converts the command into an application execution command corresponding to the item value of the NAVI function and causes the application executing unit 11 to execute the application execution command.

At this time, the vehicle-mounted information device can make a screen transition from the screen of the display 108 shown in FIG. 38A to a voice operation screen P103 shown in FIG. 38B, and output a sound effect, a display (a display of a voice recognition mark or the like) or the like indicating that the operation mode is switched to the voice operation mode. As an alternative, the vehicle-mounted information device can output voice guidance for urging the user to utter (e.g., a voice saying “Please speak about navi”), or display a document for urging the user to utter.

Because concrete function items operative in performing voice recognition are displayed as shown in the menu screen P101 exclusively used for voice operation in the voice operation mode 1 by disposing the two voice operation modes, the vehicle-mounted information device can suggest a text which can be uttered as a voice operated input to the user. As a result, the vehicle-mounted information device can prevent the user from unconsciously limiting a text which he or she can utter and from uttering a word which is not included in the voice recognition dictionary. In addition, because a text which can be uttered is displayed on the screen, uneasy about not knowing what to say which the user feels can also be reduced. Further, because the vehicle-mounted information device can induce the user to utter by, for example, providing voice guidance having concrete descriptions (“speak about a facility name” or the like), the vehicle-mounted information device makes it easy for the user to perform a voice operation.

Because the user is enabled to directly cause the vehicle-mounted information device to start voice recognition by double clicking the “NAVI” hard button 105 in the other voice operation mode 2, the user is enabled to start a voice operation immediately. Therefore, a user who has become acclimated to performing a voice operation and learned about texts which he or she can utter is enabled to complete an operation in a smaller number of operation steps and in a shorter operation time. In addition, a user who knows voice recognition keywords other than the detailed function items displayed in the menu screen P101 exclusively used for voice operation in the voice operation mode 1 is enabled to cause the vehicle-mounted information device to perform, in the voice operation mode 2, a larger number of functions than those for voice operation in the voice operation mode 1.

Thus, the vehicle-mounted information device enables the user to switch among the three operation modes in total including the general touch operation mode and the two voice operation modes (e.g., a simple mode and an expert mode) by using one input device to perform an operation thereon. Although an explanation is omitted, the vehicle-mounted information device alternatively enables the user to switch among the three operation modes in total including two touch operation modes and one voice operation mode by using one input device.

As mentioned above, the vehicle-mounted information device according to Embodiment 4 is constructed in such a way as to, on the basis of an output signal from an input device on which the user is enabled to perform one of n types of touch operations, switch among n types of functions according to the state of a touch operation on the input device. Therefore, the user is enabled to switch among the n types of operation modes by using one input device to perform an operation.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

As mentioned above, because the user interface device in accordance with the present invention reduces the number of operation steps and the operation time by combining a touch panel operation and a voice operation, the user interface device is suitable for use as a user interface device such as a vehicle-mounted user interface device.

### EXPLANATIONS OF REFERENCE NUMERALS

1 and 1a touch input detecting unit, 2 input method determining unit, 3 touch-to-command converting unit, 4, 4a, and 4b input switching control unit, 5 state transition control unit, 6 state transition table storage unit, 7 voice recognition dictionary DB, 8 voice recognition dictionary switching unit, 9 and 9a voice recognition unit, 10 voice-to-command conversion, 11 and 11a application executing unit, 12 data storage unit, 13 and 13b output control unit, 14 network, 20 voice recognition target word dictionary generating unit, 30 output method determining unit, 31 output data storage unit, 100 to 105, 113, 114, 122, 123, and 132 hard button, 106 touch display, 107 steering wheel, 108, 121, and 131 display, 109 joystick, 110 touchpad, 111 TV, 112 remote control, 120 rice cooker, 130 microwave oven.

1-13. (canceled)

14. A user interface device comprising:
an input detector that detects which button, among a plurality of buttons in an operation interface with which a plurality of process groups into which a plurality of processes are grouped are brought into correspondence respectively, is selected; and
a voice-to-command converter that converts a result of voice recognition of a voice associated with the selected button detected by said input detector into a first command for performing a process in a process group brought into correspondence with said selected button.

15. The user interface device according to claim 14, wherein said user interface device includes: a voice recognition dictionary database that stores voice recognition dictionaries each of which is comprised of voice recognition keywords brought into correspondence with said plurality of processes respectively; and a voice recognition dictionary switcher that switches to a voice recognition dictionary included in said voice recognition dictionary database and including a voice recognition keyword brought into correspondence with the process associated with said selected button; and a voice recognizer that carries out voice recognition on the voice associated with said selected button by using the voice recognition dictionary to which said voice recognition dictionary switcher switches.

16. The user interface device according to claim 14, wherein said user interface device includes: a data storage that stores data about items which are divided into groups and which are arranged hierarchically in each of said groups; a voice recognition dictionary database for storing voice recognition keywords respectively brought into correspondence with said items; a voice recognition target word dictionary generator that, when a selection is performed on a scroll bar area of a list screen in which items in a predetermined layer of each of the groups of the data stored in said data storage are arranged, extracts a voice recognition keyword brought into correspondence with at least one of the items arranged in said list screen and an item in a layer lower than that of said list screen from said voice recognition dictionary database to generate a voice recognition target word dictionary; and a voice recognizer that carries out voice recognition on the voice associated with said selected button by using the voice recognition target word dictionary which said voice recognition dictionary generator generates.

17. The user interface device according to claim 14, wherein said user interface device includes: a touch-to-command converter that, when one process in said process group is brought into correspondence with said button, generates a second command for performing the process corresponding to said button according to a touch operation on said button; an input method determinator that determines whether a voice operation mode for performing the process corresponding to the first command which said voice-to-command converter generates or a touch operation mode for performing the process corresponding to the second command which said touch-to-command converter generates is selected according to a state of a user's touch operation when selecting said button; an input switching controller that switches between the voice operation mode and the touch operation mode on a basis of a result of the determination by said input method determinator.

18. The user interface device according to claim 17, wherein said user interface device includes: a process performer that, when receiving an indication of the voice operation mode from said input switching controller, acquires said first command from the voice-to-command converter and performs the process corresponding to said first command, and, when receiving an indication of the touch operation mode from said input switching controller, acquires said second command from the touch-to-command converter and performs the process corresponding to said second command; and an output controller that controls an outputter that outputs a result of the performance by said process performer.

19. The user interface device according to claim 18, wherein said user interface device includes an output method determinator that receives an indication of the touch operation mode or the voice operation mode from said input switching controller to determine an output method of outputting the result of the performance which said outputter uses according to said indicated mode, and said output controller controls said outputter according to the output method which said output method determinator determines.

20. The user interface device according to claim 19, wherein said user interface device includes an output data storage that stores data about voice guidance for each second command, said voice guidance urging a user to utter a voice recognition keyword brought into correspondence with a process included in a process group associated with a process corresponding to said second command and categorized into a layer lower than that of said process, and wherein said output method determinator acquires data about voice guidance corresponding to the second command which said touch-to-command converter generates from said output data storage and outputs said data to said output controller when receiving an indication of the voice operation mode from said input switching controller, and said output controller causes said outputter to output the data about the voice guidance which said output method determinator outputs.

21. The user interface device according to claim 14, wherein said operational interface is a touch panel.

22. The user interface device according to claim 14, wherein said operational interface is a hard button.

23. The user interface device according to claim 14, wherein said operational interface is a cursor operation hard device for enabling a user to select a process item by operating a cursor displayed on a display.

24. The user interface device according to claim 14, wherein said operational interface is a touchpad.

25. An information processing method comprising:
an input detecting step of detecting which button, among a plurality of buttons in an operation interface with which a plurality of process groups into which a plurality of processes are grouped are brought into correspondence respectively, is selected; and
a voice-to-command converting step of converting a result of voice recognition of a voice associated with the selected button detected in said input detecting step into a first command for performing a process in a process group brought into correspondence with said selected button.
